(19) United States
(12) Patent Application Publication
(10) Pub. No.: US 2022/0217924 A1
(43) Pub. Date: Jul. 14, 2022

(54) FOLDING DEVICE, CONTAINERIZATION DEVICE PROVIDED WITH THE FOLDING DEVICE, AND STORAGE TROLLEY DEVICE PROVIDED WITH THE CONTAINERIZATION DEVICE

(71) Applicants: SAKATO SANGYO CO., LTD., Gunma (JP); SALAI INTERNATIONAL JAPAN CO., LTD., Nagano (JP)

(72) Inventors: Junichi SAKATO, Gunma (JP); Kota OBUCHI, Gunma (JP)

(21) Appl. No.: 17/613,069

(22) PCT Filed: Oct. 19, 2020
(86) PCT No.: PCT/JP2020/039306

§ 371 Date: Nov. 21, 2021

(30) Foreign Application Priority Data
Oct. 17, 2019 (JP) 2019-189815
Nov. 21, 2019 (JP) 2019-210917
Feb. 3, 2020 (JP) 2020-016668

(51) Int. Cl. A01G 18/22; A01G 18/30; A01G 18/66; B65B 5/10; B65B 7/08

(52) U.S. Cl. CPC A01G 18/22; A01G 18/30; B65B 7/08; B65B 5/10; A01G 18/66

(57) ABSTRACT

A folding device having a simple structure and capable of efficiently folding an unfilled portion of a bagged culture medium block is provided. The folding device has a bag body, which has at least a bottom portion and a bag mouth, and has a filled portion in the bag body, in which a predetermined amount of culture medium is filled, and the unfilled portion, which is from an upper surface of the filled portion to the bag mouth. The folding device includes an opening mechanism for blowing air from a side of the bag mouth into the bag body to keep the bag mouth open; a folding mechanism having one or more folding jigs for pushing the unfilled portion of the bag body from inside or outside; and a tilting mechanism for tilting the unfilled portion toward the direction approaching to the filled portion.

### TECHNICAL FIELD

The present invention relates to a folding device for folding the bag mouth side of a bagged culture medium block used for mushroom cultivation and relates to a containerization device provided with the folding device for storing the folded bagged culture medium block in a container. In particular, the present invention relates to a folding device that has a simpler structure and can fold more bagged culture medium blocks faster than the conventional folding devices and store them in a container, and relates to a containerization device provided with the folding device.

### BACKGROUND ART

In recent years, regarding mushrooms such as shiitake mushrooms, maitake mushrooms, shimeji mushrooms and nameko mushrooms, there has been a shift from natural collection to artificial cultivation. Among these artificial cultivations, shiitake mushrooms have been cultivated by planting fungi of shiitake mushrooms in logs that were cut to a predetermined length from trees such as Quercus serrata, Quercus crispula and Quercus acutissima. However, since this log cultivation is mainly performed outdoors and thus affected by the weather conditions at that time and pests and harmful bacteria, it is difficult to secure a stable harvest. Therefore, in recent years, there has been a shift to mushroom bed cultivation in which air-conditioned environment suitable for indoor cultivation of shiitake mushrooms is used to cultivate mushrooms.

Common shiitake mushroom bed cultivation is carried out through a series of processes shown in FIG. 68. In this mushroom bed cultivation 1, first, a plurality of mushroom cultivation bags and a preparation culture medium mixed with nutrients are prepared in advance, and then processes are performed, which consist of a bagging process 1A in which a predetermined amount of this culture medium is filled in the cultivation bag, a bag folding process 1B in which the unfilled portion of the bagged culture medium (hereinafter, also referred to as the bagged culture medium block) is folded, a containerization process 1C in which the folded bagged culture medium block is stored in a container of a predetermined size, a sterilization process 1D in which the bagged culture medium block is carried into a sterilization pot to be sterilized, a bag mouth opening process 1E, an inoculation process 1F for inoculating fungi of shiitake mushrooms, a bag mouth sealing process 1G, a fungi cultivating process 1H for cultivating the fungi over a predetermined period while adjusting temperature and humidity, a mushroom occurring/growing process 1I in which the mushroom bed is taken from the cultivation bag, and shiitake mushrooms are occurred and grown while adjusting temperature and humidity and culturing the mushroom bed, and a harvesting process 1J in which the cultivated shiitake mushrooms are harvested.

Until now, these processes were mostly performed manually, but in recent years, some processes have been automatically mechanized, and the mechanical devices have been introduced in patent literatures.

For example, a folding device for packaging bags is described in the patent literature 1. As shown in FIGS. 69A and 69B, the folding device 4 is provided with shaping means 4A for transporting in an upright state a packaging bag filled with filling materials in a filled portion thereof through a folding allowance in which the tip thereof is open upward, folding allowance closing means 4B for pushing the folding allowance of the packaging bag from both the left and right sides with respect to the transport direction of the shaping means to close the folding allowance along the transport direction, adhesive application means 4C for applying the adhesive to the left side or the right side of the outer circumferences of the filled portion or the unfilled portion of the packaging bag, and folding means 4D for pushing down the folding allowance of the packaging bag so as to fold back the folding allowance downward toward the direction of the portions at which the adhesive is applied to adhere the folding allowance to the outer periphery of the filled portion of the packaging bag, and the folding means 4D includes pushing means 4E for pushing the folding allowance from the adhesive application side, folding-back means 4F for, after pushing down the folding allowance to the adhesive application side, pushing the folding allowance downward so as to fold back the tip of the folding allowance, and pressing means 4G for pressing the tip of the folding allowance folded by the folding-back means against the adhesive to adhere to the outer periphery of the filled portion of the packaging bag.

According to this folding device, the folding allowance of the packaging bag can be automatically folded and closed, can prevent foreign matters from entering from the bag mouth and can improve productivity.

Further, a folding device for packaging bags is also described in the patent literature 2. This device is an improvement of the device of the patent literature 1, and uses a brush as a folding member of the folding means.

Furthermore, an invention, in which a bagged culture medium block is carried and stored in a container, is described in the patent literature 3. According to the spawn cultivation method and the mushroom bed block loading device in mushroom cultivation described in the patent literature 3, four inoculated mushroom bed blocks are placed with ventilation intervals therebetween in a container in which the top surface thereof is open. Then, the container is transported to a shelving device by a roller conveyor, and the transported container is sequentially loaded by the shelving device to a rack pallet having a shelf of multiple stages capable of placing the containers in the vertical direction at a predetermined vertical interval. Then, the rack pallets loaded with the containers are transported to the cultivation chamber, and the rack pallets are placed side by side in the cultivation chamber, and the mushroom spawn is cultivated with the mushroom bed block loaded on the rack pallets.

### CITATION LIST

### Patent Literature

[Patent Literature 1] JP5-294302 A
[Patent Literature 2] JP6-144413 A
[Patent Literature 3] JP9-028182 A

### SUMMARY OF INVENTION

Regarding the bagged culture medium before sterilization, that is, the bagged culture medium block before sterilization by the sterilizer, a series of operations are performed such as the shaping of the bagged culture medium, the folding of the unfilled portion of the bagged culture medium, and the transporting of the folded bagged culture medium block into a container.

On the other hand, in some existing mushroom cultivation factories using the mushroom bed, a bagged culture medium shaping device has been introduced. However, in such a factory, if an existing device is discarded and a fully automatic device is introduced, the past capital investment is wasted and a new large amount of capital investment is needed. Such an investment is difficult to be made. Therefore, as a measure for this problem, there is a demand for an automatic bag folding device and an automatic containerization device that can be connected to the existing device that can be used as it is. However, such an automatic bag folding device and an automatic containerization device that can be connected to the existing device have not yet been developed and commercialized.

Further, since the bag folding devices in the patent literatures 1 and 2 are configured to use the adhesive to adhere the folding allowance, the adhesive and its adhering means are required. As a result, the device becomes complicated. Further, once the folding allowance is adhered, it is difficult to open the bag when opening the bag mouth in the inoculation process (device) of the next process, and there is a risk of bag tearing, and there is a limit to further improve the productivity of the bagged culture medium block. That is, the number of the bagged culture medium blocks produced per unit time is about 400 at present, but in the future, the production of the 800 to 1000 of the bagged culture medium blocks per unit time is required. Due to the above-described limitation, such a demand cannot be met.

On the other hand, in some existing mushroom cultivation factories using the mushroom bed, a bagged culture medium shaping device has been introduced. However, in such a factory, if an existing device is discarded and a fully automatic device is introduced, the past capital investment is wasted and a new large amount of capital investment is needed. Such an investment is difficult to be made. Therefore, as a measure for this problem, there is a demand for an automatic bag folding device and an automatic containerization device that can be connected to the existing device that can be used as it is. However, such an automatic bag folding device and an automatic containerization device that can be connected to the existing device have not yet been developed and commercialized.

An object of the present invention is to provide a folding device having a simple structure and capable of efficiently folding the unfilled portion of the bagged culture medium block. Further, another object of the present invention is to provide a containerization device having a simple structure and provided with a folding device capable of efficiently storing a folded bagged culture medium block in a container. Furthermore, another object of the present invention is to provide a storage trolley device having a simple structure and capable of efficiently storing a container in a trolley provided with a plurality of container storage portions.

The above object of the present invention can be achieved by the following configuration. That is, the folding device of one embodiment of the present invention is characterized by being a folding device for folding an unfilled portion of a bagged culture medium block having a bag body, which has at least a bottom portion and a bag mouth, and having a filled portion in the bag body, in which a predetermined amount of culture medium is filled, and the unfilled portion, which is from an upper surface of the filled portion to the bag mouth, wherein the folding device comprises: an opening mechanism for blowing air from a side of the bag mouth into the bag body to keep the bag mouth open; a folding mechanism having one or more folding jigs for pushing the unfilled portion of the bag body from inside or outside; and a tilting mechanism for tilting the unfilled portion toward the direction approaching to the filled portion.

Further, a containerization device of one embodiment of the present invention includes the folding device according to one embodiment of the present invention, and is characterized in that the containerization device transports a plurality of the bagged culture medium blocks folded by the folding device and stores the bagged culture medium blocks in a container.

Furthermore, a storage trolley device of one embodiment of the present invention includes the containerization device according to one embodiment of the present invention, and is characterized in that the storage trolley device includes an elevating mechanism, which is for raising and lowering a container in which the bagged culture medium block is stored, and a storage mechanism, which is for storing the container in a trolley having a plurality of container storage portions.

The folding device of the embodiment has a simple structure and is capable of efficiently folding the unfilled portion of the bagged culture medium block. Further, the containerization device of the embodiment has a simple structure and is capable of efficiently storing a folded bagged culture medium block in a container. Furthermore, the storage trolley device of the embodiment has a simple structure and is capable of efficiently storing a container in a trolley provided with a plurality of container storage portions.

### BRIEF DESCRIPTION OF DRAWINGS

FIG. 1 is a plan view illustrating each device of manufacturing devices for a bagged culture medium block including a folding device and a containerization device according to the embodiment 1 of the present invention.

FIG. 2 is a side view seen from the II side of FIG. 1.

FIG. 3 is a side view seen from the III side of FIG. 1.

FIG. 4A is a perspective view illustrating a state in which a bag mouth of the bagged culture medium block is open.

FIG. 4B is a perspective view illustrating a state in which an unfilled portion of the bagged culture medium block is folded.

FIG. 4C is a perspective view illustrating a state in which the unfilled portion of the bagged culture medium block is folded-in.

FIG. 5 is a side view illustrating a block forming device of manufacturing devices for the bagged culture medium block.

FIG. 6A is a side view illustrating first feeding means.

FIG. 6B is another side view illustrating first feeding means.

FIG. 6C is a side view illustrating opening means.

FIG. 6D is a side view illustrating opening means.

FIG. 7A is a front view illustrating a process of folding means.

FIG. 7B is a side view illustrating a process of folding means.

FIG. 7C is a front view illustrating a process of folding means.

FIG. 7D is a side view illustrating a process of folding means.

FIG. 7E is a front view illustrating a process of folding means.

FIG. 7F is a side view illustrating a process of folding means.

FIG. 7G is a front view illustrating a process of folding means.

FIG. 7H is a side view illustrating a process of folding means.

FIG. 8A is a front view illustrating a process of the folding means following that of FIGS. 7A-7H.

FIG. 8B is a side view illustrating a process of the folding means following that of FIGS. 7A-7H.

FIG. 8C is a front view illustrating a process of the folding means following that of FIGS. 7A-7H.

FIG. 8D is a side view illustrating a process of the folding means following that of FIGS. 7A-7H.

FIG. 8E is a front view illustrating a process of the folding means following that of FIGS. 7A-7H.

FIG. 8F is a side view illustrating a process of the folding means following that of FIGS. 7A-7H.

FIG. 8G is a front view illustrating a process of the folding means following that of FIGS. 7A-7H.

FIG. 8H is a side view illustrating a process of the folding means following that of FIGS. 7A-7H.

FIG. 9A is a plan view illustrating the operation of a container carrying device.

FIG. 9B is a front view illustrating the operation of a container carrying device.

FIG. 9C is a plan view illustrating the operation of a container carrying device.

FIG. 9D is a front view illustrating the operation of a container carrying device.

FIG. 9E is a plan view illustrating the operation of a container carrying device.

FIG. 9F is a front view illustrating the operation of a container carrying device.

FIG. 10A is a plan view illustrating a process of second feeding means.

FIG. 10B is a front view illustrating a process of second feeding means.

FIG. 10C is a plan view illustrating a process of second feeding means.

FIG. 10D is a front view illustrating a process of second feeding means.

FIG. 11A is a plan view illustrating a process of the second feeding means following the process of FIGS. 10A-10D.

FIG. 11B is a front view illustrating a process of the second feeding means following the process of FIGS. 10A-10D.

FIG. 11C is a plan view illustrating a process of the second feeding means following the process of FIGS. 10A-10D.

FIG. 11D is a front view illustrating a process of the second feeding means following the process of FIGS. 10A-10D.

FIG. 12A is a plan view illustrating a process of the second feeding means following the process of FIGS. 11A-11D.

FIG. 12B is a front view illustrating a process of the second feeding means following the process of FIGS. 11A-11D.

FIG. 12C is a plan view illustrating a process of the second feeding means following the process of FIGS. 11A-11D.

FIG. 12D is a front view illustrating a process of the second feeding means following the process of FIGS. 11A-11D.

FIG. 13A is a plan view illustrating folding-in means.

FIG. 13B is a view seen from the XIIIB side of FIG. 13A.

FIG. 13C is a plan view illustrating folding-in means.

FIG. 13D is a view seen from the XIIIB side of FIG. 13A.

FIG. 13E is a plan view illustrating folding-in means.

FIG. 13F is a view seen from the XIIIB side of FIG. 13A.

FIG. 14A is a plan view illustrating a process of the folding-in means and the container carrying device.

FIG. 14B is a view seen from the direction corresponding to that of FIG. 13B.

FIG. 14C is a plan view illustrating a process of the folding-in means and the container carrying device.

FIG. 14D is a view seen from the direction corresponding to that of FIG. 13B.

FIG. 14E is a plan view illustrating a process of the folding-in means and the container carrying device.

FIG. 14F is a view seen from the direction corresponding to that of FIG. 13B.

FIG. 15A is a plan view illustrating the process of the folding-in means and the container carrying device following the process of FIGS. 14A-14F.

FIG. 15B is a view seen from the direction corresponding to that of FIG. 13B.

FIG. 15C is a plan view illustrating the process of the folding-in means and the container carrying device following the process of FIGS. 14A-14F.

FIG. 15D is a view seen from the direction corresponding to that of FIG. 13B.

FIGS. 16A, 16B, 16C, 16D, 16E, 16F, 16G, and 16H are views illustrating an application example of a pushing mechanism in the embodiment 1 and corresponding to FIGS. 7A, 7B, 7C, 7D, 7E, 7F, 7G and 7H, respectively.

FIGS. 17A, 17B, 17C, 17D, 17E, 17F, 17G and 17H are views illustrating an application example of a pressing mechanism in the embodiment 1 and corresponding to FIGS. 8A, 8B, 8C, 8D, 8E, 8F, 8G and 8H, respectively.

FIGS. 18A, 18B and 18C are perspective views illustrating the I-shaped folding of the bagged culture medium block.

FIGS. 18D, 18E and 18F are front views illustrating an example of the I-shaped folding and corresponding to FIGS. 7C, 7E and 7G, respectively.

FIG. 19 is a plan view illustrating another example of each device of manufacturing devices for the bagged culture medium block including the folding device and the containerization device according to the embodiment 1 of the present invention.

FIG. 20A is a front view illustrating another example of a support member of the embodiment 1.

FIG. 20B is a cross-sectional view taken along the line XXB-XXB of FIG. 20A.

FIG. 20C is a front view illustrating still another example.

FIG. 20D is a cross-sectional view taken along the line XXD-XXD of FIG. 20C.

FIG. 20E is a front view illustrating still another example.

FIG. 20F is a cross-sectional view taken along the line XXF-XXF of FIG. 20E.

FIG. 21A is a perspective view illustrating a state in which the bag mouth of a bagged culture medium block in the modification example 1 is open.

FIG. 21B is a perspective view illustrating a state in which the unfilled portion of the bagged culture medium block is folded.

FIG. 21C is a perspective view illustrating a state in which the unfilled portion of the bagged culture medium block is folded-in.

FIG. 22 is a plan view illustrating each device of manufacturing devices for the bagged culture medium block including a folding device and a containerization device according to the modification example 1.

FIG. 23 is a side view seen from the XXIII side of FIG. 22.

FIG. 24A is a plan view illustrating the movement of the bagged culture medium block from the folding device to the container carrying device in the modified example 1.

FIG. 24B is a side view illustrating the movement of the bagged culture medium block from the folding device to the container carrying device in the modified example 1.

FIG. 25A is a plan view illustrating the movement of the bagged culture medium block from the folding device to the container carrying device following the movement of FIGS. 24A-B in the modified example 1.

FIG. 25B is a side view illustrating the movement of the bagged culture medium block from the folding device to the container carrying device following the movement of FIGS. 24A-24B in the modified example 1.

FIG. 26A is a plan view illustrating the movement of the bagged culture medium block from the folding device to the container carrying device following the movement of FIGS. 25A-25B in the modified example 1.

FIG. 26B is a side view illustrating the movement of the bagged culture medium block from the folding device to the container carrying device following the movement of FIGS. 25A-25B in the modified example 1.

FIG. 27A is a plan view illustrating the movement of the bagged culture medium block from the folding device to the container carrying device following the movement of FIGS. 26A-26B in the modified example 1.

FIG. 27B is a side view illustrating the movement of the bagged culture medium block from the folding device to the container carrying device following the movement of FIGS. 26A-26B in the modified example 1.

FIG. 28A is a plan view illustrating the movement of the bagged culture medium block from the folding device to the container carrying device following the movement of FIGS. 27A-27B in the modified example 1.

FIG. 28B is a side view illustrating the movement of the bagged culture medium block from the folding device to the container carrying device following the movement of FIGS. 27A-27B in the modified example 1.

FIG. 29A is a plan view illustrating the movement of the bagged culture medium block from the folding device to the container carrying device following the movement of FIGS. 28A-28B in the modified example 1.

FIG. 29B is a side view illustrating the movement of the bagged culture medium block from the folding device to the container carrying device following the movement of FIGS. 28A-28B in the modified example 1.

FIG. 30A is a plan view illustrating the movement of the bagged culture medium block to a container in the container carrying device in the modified example 1.

FIG. 30B is a side view illustrating the movement of the bagged culture medium block to a container in the container carrying device in the modified example 1.

FIG. 30C is a plan view following FIG. 30A, illustrating the movement of the bagged culture medium block to a container in the container carrying device in the modified example 1.

FIG. 30D is a side view following FIG. 30B, illustrating the movement of the bagged culture medium block to a container in the container carrying device in the modified example 1.

FIG. 31A is a plan view illustrating the movement of the bagged culture medium block to the container in the container carrying device in the modified example 1.

FIG. 31B is a plan view following FIG. 31A, illustrating the movement of the bagged culture medium block to the container in the container carrying device in the modified example 1.

FIG. 31C is a plan view following FIG. 31B, illustrating the movement of the bagged culture medium block to the container in the container carrying device in the modified example 1.

FIG. 31D is a side view of FIG. 31C, illustrating the movement of the bagged culture medium block to the container in the container carrying device in the modified example 1.

FIG. 32A is a plan view illustrating the movement of the container in the container carrying device in the modified example 1.

FIG. 32B is a side view illustrating the movement of the container in the container carrying device in the modified example 1.

FIG. 33 is a plan view of the folding device according to the modification example 2.

FIG. 34 is a side view of the folding device according to the modification example 2 seen from one direction.

FIGS. 35A, 35C, 35E and 35G are views seen from the A side of FIG. 33, illustrating processes of folding means according to the modification example 2.

FIGS. 35B, 35D, 35F and 35H are views seen from the B side of FIG. 33, illustrating processes of folding means according to the modification example 2.

FIGS. 36A, 36C, 36E and 36G are views seen from the A side of FIG. 33, illustrating processes of the folding means according to the modification example 2 following the processes of FIGS. 35A-H.

FIGS. 36B, 36D, 36F and 36H are views seen from the B side of FIG. 33, illustrating processes of the folding means according to the modification example 2 following the processes of FIGS. 35A-H.

FIGS. 37A, 37C and 37E are plan views for explaining the operation of a container carrying device in the modification example 3.

FIGS. 37B, 37D and 37F are front views for explaining the operation of a container carrying device in the modification example 3.

FIGS. 38A and 38C are plan views for explaining processes of carrying a bagged culture medium block in the container carrying device in the modification example 3.

FIGS. 38B and 38D are front views for explaining processes of carrying a bagged culture medium block in the container carrying device in the modification example 3.

FIGS. 39A and 39C are plan views for explaining processes of carrying the bagged culture medium block in the container carrying device in the modification example 3 following the processes of FIGS. 38A-38D.

FIGS. 39B and 39D are front views for explaining processes of carrying the bagged culture medium block in the container carrying device in the modification example 3 following the processes of FIGS. 38A-38D.

FIGS. 40A and 40C are plan views for explaining processes of carrying the bagged culture medium block in the container carrying device in the modification example 3 following the processes of FIGS. 39A-39D.

FIGS. 40B and 40D are front views for explaining processes of carrying the bagged culture medium block in the container carrying device in the modification example 3 following the processes of FIGS. 39A-39D.

FIGS. 41A and 41C are plan views for explaining processes of carrying the bagged culture medium block in the container carrying device in the modification example 3 following the processes of FIGS. 40A-40D.

FIGS. 41B and 41D are front views for explaining processes of carrying the bagged culture medium block in the container carrying device in the modification example 3 following the processes of FIGS. 40A-40D.

FIG. 42 is a side view illustrating another example of a tilting mechanism of the folding device according to the embodiment 1 and corresponding to FIG. 2.

FIGS. 43A, 43C, 43E and 43G are views seen from the traveling direction of transporting means (from the A side of FIG. 33), illustrating processes of the folding means according to the embodiment 2.

FIGS. 43B, 43D, 43F and 43H are views seen from the direction orthogonal to the traveling direction of the transporting means (from the B side of FIG. 33), illustrating processes of the folding means according to the embodiment 2.

FIGS. 44A, 44C, 44E and 44G are views seen from the traveling direction of the transporting means (from the A side of FIG. 33), illustrating processes following the processes of FIGS. 43A-H.

FIGS. 44B, 44D, 44F and 44H are views seen from the direction orthogonal to the traveling direction of the transporting means (from the B side of FIG. 33), illustrating processes following the processes of FIGS. 43A-43H.

FIGS. 45A, 45C, 45E and 45G are views seen from the direction orthogonal to the traveling direction of transporting means (from the longitudinal side of a bagged culture medium block), illustrating processes of folding means according to the embodiment 3.

FIGS. 45B, 45D, 45F and 45H are views seen from the traveling direction of the transporting means (from the short side of the bagged culture medium block), illustrating processes of folding means according to the embodiment 3.

FIGS. 46A, 46C, 46E and 46G are views seen from the direction orthogonal to the traveling direction of the transporting means (from the longitudinal side of the bagged culture medium block), illustrating processes following the processes of FIGS. 45A-H.

FIGS. 46B, 46D, 46F and 46H are views seen from the traveling direction of the transporting means (from the short side of the bagged culture medium block), illustrating processes following the processes of FIGS. 45A-45H.

FIG. 47 are views illustrating processes of the folding means according to the embodiment 4.

FIG. 48 are explanatory views according to the embodiment 5.

FIG. 49 is a layout view of a shelf insertion device according to the embodiment 8.

FIG. 50 is a perspective view of the shelf insertion device according to the embodiment 8.

FIG. 51 is an explanatory view for transfer positions on a lower stage in the shelf insertion device according to the embodiment 8.

FIG. 52 is a layout view of the shelf insertion device according to the modified example 1 of the embodiment 8.

FIG. 53 is a layout view of the shelf insertion device according to the modified example 2 of the embodiment 8.

FIG. 54 is the first perspective view of the shelf insertion device according to the embodiment 9.

FIG. 55 is the second perspective view of the shelf insertion device according to the embodiment 9.

FIG. 56 is the third perspective view of the shelf insertion device according to the embodiment 9.

FIG. 57 is the fourth perspective view of the shelf insertion device according to the embodiment 9.

FIG. 58 is the fifth perspective view of the shelf insertion device according to the embodiment 9.

FIG. 59 is the sixth perspective view of the shelf insertion device according to the embodiment 9.

FIG. 60A is an explanatory view for a fixed claw of a transfer device.

FIG. 60B is an explanatory view for a movable claw of the transfer device.

FIG. 61 are explanatory views of a container filling machine according to the embodiment 10.

FIG. 62 is a perspective view of the container carrying device provided in a containerization device according to the embodiment 11.

FIG. 63A is a view illustrating a state in which the unfilled portion is folded by the folding device.

FIG. 63B is a view illustrating a state in which an underlay member is pulled out of the folding device side to the upper region of the container.

FIG. 63C is a view illustrating a state in which culture medium clamping means is lowered to a position where the bagged culture medium block sent out from the folding device onto the underlay member can be clamped by the culture medium clamping means.

FIG. 64A is a view illustrating a state in which the bagged culture medium block is clamped by the culture medium clamping means.

FIG. 64B is a view illustrating a state in which the bagged culture medium block is stored in the container by the culture medium clamping means.

FIG. 64C is a view illustrating a state in which the empty container is pulled out onto a rotating member of a rotating mechanism.

FIG. 65 is a schematic view illustrating the overall configuration of transport means according to the embodiment 12.

FIG. 66 is a perspective view of the periphery of a culture medium direction changing section illustrated in FIG. 65.

FIG. 67 is a side view seen from the LXVII side of FIG. 65.

FIG. 68 is a process block diagram showing general cultivation processes of shiitake mushroom bed cultivation.

FIG. 69A is a perspective view illustrating a conventional folding-in device.

FIG. 69B is a partial side view illustrating a conventional folding-in device.

### DESCRIPTION OF EMBODIMENTS

Hereinafter, a folding device for a bagged culture medium block and a containerization device provided with the folding device according to an embodiment of the present invention will be described with reference to the drawings. However, the embodiments described below only exemplify a folding device for a bagged culture medium block and a containerization device provided with the folding device for embodying the technical concept of the present invention. Thus, the present invention is not limited to these embodiments, and can be equally applied to other embodiments included in claims.

### Embodiment 1

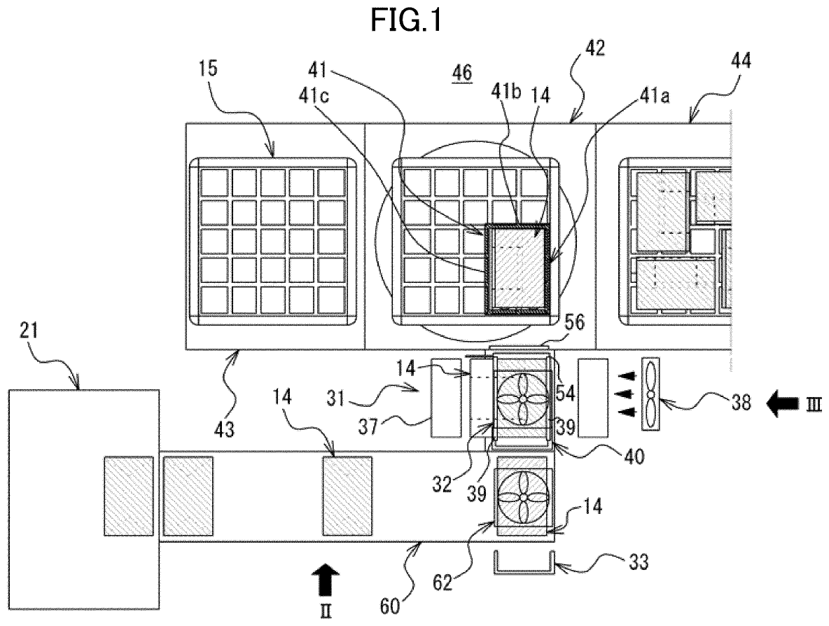

With reference to FIGS. 1 to 15, a folding device 31 for folding an unfilled portion on the bag mouth side of the bagged culture medium block according to the embodiment 1 of the present invention (hereinafter, may be simply referred to as a folding device 31), and a containerization device 46 provided with the folding device 31 (hereinafter, may be simply referred to as a containerization device 46) will be described. As shown in FIGS. 1 to 3, the folding device 31 is a device for folding an unfilled portion 11h on the opened bag mouth 11f side of a bag body 11, which is a mushroom cultivation bag made of plastic film filled with a predetermined amount of culture medium 12, in a manufacturing process of a bagged culture medium block 14 for cultivating mushrooms. Further, the containerization device 46 is a device having a container carrying device 42 and for storing the bagged culture medium block 14, which is folded by the folding device 31, in a container 15.

The folding device 31 and the containerization device 46 provided with the folding device 31 are devices provided in a series of operation processes for manufacturing the bagged culture medium block 14. In a manufacturing process of the bagged culture medium block 14, for example, there are provided a block forming device 21, which is for performing a block forming process of filling the bag body 11 with the culture medium 12 to form the bagged culture medium block 14, the folding device 31, which is for performing a folding process of folding the unfilled portion 11h on the bag mouth 11f side of the bag body 11 of the bagged culture medium block 14, and the containerization device 46, which has the container carrying device 42 for performing a container carrying process of carrying the folded bagged culture medium block 14 into the container 15 of a predetermined size (see FIGS. 1 to 3).

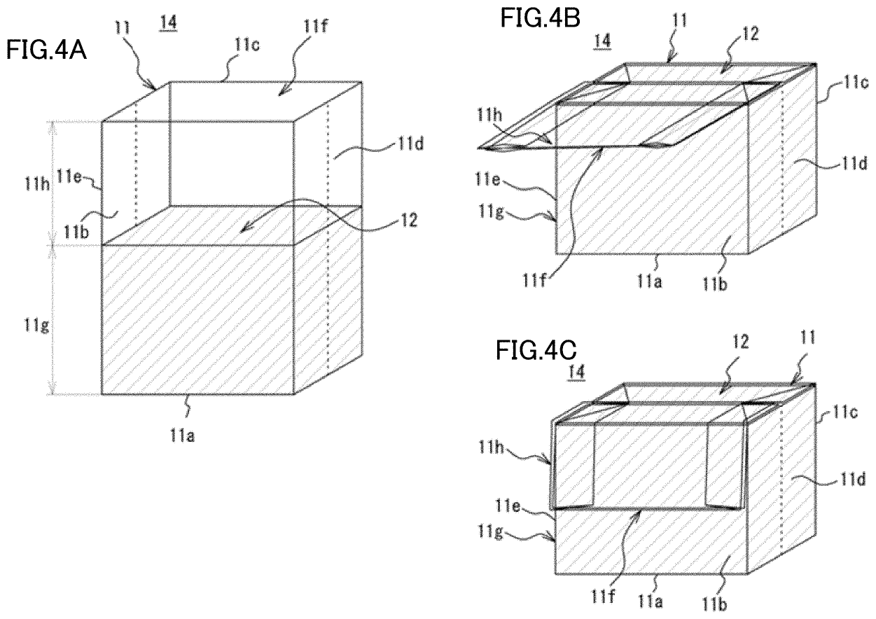

Here, the bagged culture medium block 14 that is folded by the folding device 31 according to the embodiment 1 will be described with reference to FIG. 4. The bagged culture medium block 14 is composed of the bag body 11 and the culture medium 12 filled in the bag body 11. In FIG. 4A, the bag mouth 11f is opened in a state where the culture medium 12 is filled in the bag body 11, and the bagged culture medium block 14 is shown in the unfolded state.

As shown in FIG. 4A, the bag body 11 has a rectangular parallelepiped shape and has a rectangular bottom surface 11a, which has a predetermined length and width, and wide side surfaces 11b and 11c with a predetermined height from the longitudinal side of the bottom surface 11a, and narrow side surfaces 11d and 11e with a predetermined height from the short side of the bottom surface 11a. Here, the upper portion facing the bottom surface 11a is open, and this open portion is a bag mouth 11f, through which the culture medium 12 as described later is filled.

As a material of the bag body 11, a synthetic resin film such as polyethylene, polypropylene, polyester, or a biodegradable film or a photocatalytic film is used, and the thickness thereof is, for example, 10 to 100 μm. In the embodiment 1, a synthetic resin film (plastic film) is used for the bag body 11 so that the bag body 11 is lightweight, easy to handle and can be produced at low cost.

Further, since the bottom surface of the bag body 11 of the embodiment 1 has a rectangular shape, the side surfaces of the bag body 11 are composed of the wide side surfaces 11b and 11c and the narrow side surfaces 11d and 11e. creases are formed in the longitudinal direction at the substantially center of the narrow side surfaces 11d and 11e, thus, the bag body 11 is a so-called gusset bag.

Further, the bag body 11 is divided into a filled portion 11g filled with the culture medium 12 and the empty unfilled portion 11h above the filled portion 11g. That is, when the culture medium 12 described later is filled, the filled portion 11g has a predetermined height from the bottom surface 11a to the upper surface of the culture medium 12, and the unfilled portion 11h has a height from the top of the filled portion 11g, which is the upper surface of the culture medium 12, to the bag mouth 11f.

The culture medium 12 filled in the bag body 11 is formed of, for example, a mixed material containing sawdust, rice bran, bran and the like as main components, and a nutritional supplement and water mixed in a predetermined ratio. The culture medium 12 is filled in a bag body 11 to form a certain shape. Here, the weight when the culture medium 12 is filled in the bag body 11 of the embodiment 1 is, for example, about 2.5 kg to 2.8 kg.

The size of the bag body 11 is not limited to the above dimensions, the bottom surface 11a may be square or circular, and the lengths of the filled portion 11g and the unfilled portion 11h may be changed depending on the amount of the culture medium 12, and accordingly the weight may be increased or decreased.

Further, first, in the folding device 31 of the embodiment 1, the bag mouth 11f of the bagged culture medium block 14 is open as shown in FIG. 4A. Then, as shown in FIG. 4B, the bag mouth 11f of the bag body 11 is closed, and the boundary between the filled portion 11g and the unfilled portion 11h is folded along the upper surface of the filled portion 11g.

Further, in the folding device 31, the bagged culture medium block 14 in the state shown in FIG. 4B is further folded to be in the state shown in FIG. 4C. That is to say, as shown in FIG. 4C, in the bagged culture medium block 14, the bag mouth 11f of the bag body 11 is closed, and the boundary between the filled portion 11g and the unfilled portion 11h is bent along the upper surface of the filled portion 11g, and the block shape is formed by bending the unfilled portion 11h again along the side surface of the filled portion 11g so that the bag mouth 11f side faces downward. The bagged culture medium block 14 will be packed in the container 15 by the container carrying device 42 described later in a blocked shape in which the unfilled portion 11h of the bag body 11 of the bagged culture medium block 14 is folded.

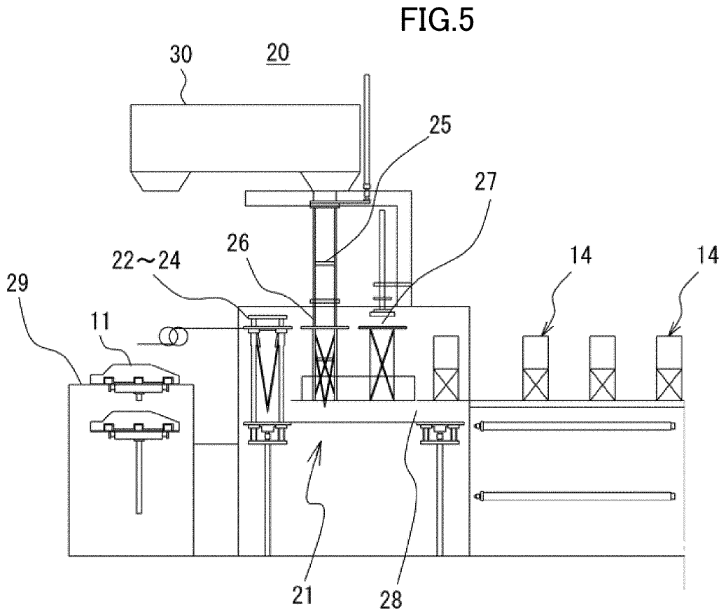

Next, the folding device 31 will be described mainly with reference to FIGS. 5 to 15. As described above, the folding device 31 according to the embodiment 1 of the present invention is for folding the unfilled portion 11h of the bag body that is filled with the culture medium by the block forming device 21 in the manufacturing process of the bagged culture medium block 14. Then, after the bagged culture medium block 14, in which the unfilled portion 11h is folded, is folded-in by folding-in means 41 described later, the bagged culture medium block 14 is stored in the container 15 by the container carrying device 42, or a predetermined number of the bagged culture medium block 14 is stored in the container 15 in the predetermined direction by human hands.

Here, since the folding device 31 of the embodiment 1 is a device provided in a series of operation processes for manufacturing the bagged culture medium block 14, the manufacturing process of the bagged culture medium block 14 will be described. The manufacturing process of the bagged culture medium block 14 is provided with, as described above, the block forming device 21, which is for forming the bagged culture medium block 14 in which the bag mouth 11f of the bag body 11 is open, the folding device 31 for folding the unfilled portion 11h so as to prevent foreign matters from entering the open bag mouth 11f, and the container carrying device 42 for carrying the folded bagged culture medium block 14 into the container 15 having a predetermined size.

First, an example of the block forming device 21 will be described with reference to FIG. 5. In the block forming device 21, there are provided bag setting means 22, in which a plurality of bag bodies 11 prepared in advance are set, bag mounting means 23, in which the bag body 11 is picked up one by one from the bag setting means 22 and mounted at a predetermined position with the bag mouth 11f being open, bag shaping means 24, in which the mounted bag is expanded and shaped into a hollow shape, filling means 26, in which the bag body 11 is filled with a predetermined amount of the culture medium 12 measured by measuring means 25, shaping means 27, in which the filled bagged culture medium block 14 is shaped into a predetermined shape, and delivery means 28, in which the shaped bagged culture medium block 14 is sent out to the next device. The bagged culture medium block 14 with the open bag mouth 11f is formed via these means (see FIG. 4A).

In an automatic bag supply device 29 adjacent to the block forming device 21, a bundle of bag bodies 11 is stored, and the bundle is arranged so that the orientation thereof can be automatically rotated by 180 degrees at a predetermined cycle. The bag body 11 is picked up from the automatic bag supply device 29 and moved to the block forming device 21, and then, the bag setting means 22 is first operated.

In the bag setting means 22, only one bag is taken out from the top of the bundle of the bag body 11. The bag setting by the bag setting means 22 is performed by sucking the bag body 11 with negative pressure by using, for example, one suction cup member that is connected to a vacuum pump or a ring blower.

Then, after the bag body 11 is lifted upward by the one suction cup member, another suction cup member, which is connected to the vacuum pump or the ring blower, is brought into contact with the bag body 11 so as to face the one suction cup member with the bag body 11 being therebetween. Then, the bag body 11 is moved to the bag mounting means 23 in a state where the bag mouth 11f side of the bag body 11 is clamped by the one suction cup member and the other suction cup member.

In the bag mounting means 23, the bag mouth 11f of the bag body 11 is opened by opening the distance between one suction cup member and the other suction cup member. Next, for example, an inner frame is inserted inside the bag mouth 11f of the bag body 11, and at the same time, an outer frame is abutted from the outside of the bag mouth 11f, and the bag mouth 11f of the bag body 11 is held to be clamped by the inner frame and the outer frame so that the bag mouth 11f of the bag body 11 is opened and held in a predetermined substantially rectangular shape.

Next, the bag shaping means 24 in the block forming device 21 is operated. In the bag shaping means 24, for example, in a state where a substantially rectangular frame member is arranged under the bag body 11, four rod-shaped bag shaping members are inserted toward the inside of the bag body 11 from the four corners of the bag mouth 11f of the bag body 11 opened in a rectangular shape. When the shaping of the bag body 11 is completed, the bag shaping members are taken out from the inside of the bag body 11. When the above process with the bag shaping means 24 is completed, the filling means 26 for filling the culture medium 12 is operated while the bag mouth 11f is held and clamped by the inner frame and the outer frame.

In the filling means 26, a hopper 30 for supplying the culture medium 12 is provided above the bag body 11. The hopper 30 stores the culture medium 12 prepared in advance, and in the measuring means 25 for measuring the predetermined amount of the culture medium, the predetermined amount of the culture medium 12 to be supplied into one bag is taken out one by one.

Then, in the filling means 26, the predetermined amount of the culture medium 12 filled from the measuring means 25 is supplied into the bag body 11, and subsequently in the shaping means 27, the culture medium 12 supplied into the bag body 11 is shaped. In the shaping means 27, first, a substantially rectangular frame-shaped lower frame member is brought into contact with the bag body 11 from the outside of the lower portion of the bag body 11, in which the culture medium 12 is stored, a compression shaping plate is inserted from the bag mouth 11f side of the bag body 11, and the compression shaping plate is pressed toward the lower frame member to compress the culture medium 12 to shape the culture medium into the predetermined rectangular shape (substantially rectangular parallelepiped shape).

When the compression shaping of the culture medium is completed and the compression shaping plate is taken out from the bag, the shaping of the bagged culture medium block 14 is completed, and the culture medium block 14 is sent to transporting means 60 such as a belt conveyor by the delivery means 28 to be transported to the next folding device 31. The bagged culture medium block 14 discharged from the block forming device 21 is in a state in which the bag mouth 11f is not closed and the unfilled portion 11h is not folded (see FIG. 4A).

Further, in the embodiment 1, the orientation of the bagged culture medium block 14 transported from the block forming device 21 by the transporting means is that, for example, the short sides of the bagged culture medium block 14, which are the narrow side surfaces 11d and 11e with the gusset folding lines, are along the transport direction of the transporting means 60, and the wide side surfaces 11b and 11c without the gusset folding lines of the bagged culture medium block 14 are directed to the upstream side and the downstream side in the transport direction (see FIGS. 1 to 3).

Next, the folding device 31 will be described mainly with reference to FIGS. 1 to 3 and 6 to 15. The folding device 31 has first feeding means 33, which is for feeding the bagged culture medium block 14 transported by the transporting means 60 from the transporting means 60 to the folding means, folding means 34, which has an opening mechanism 32 for keeping the bag mouth 11f of the fed bagged culture medium block 14 open and which is for folding the unfilled portion 11h of the bagged culture medium block 14, second feeding means 40, in which the bagged culture medium block 14 with the unfilled portion 11h folded by the folding means 34 is fed to the container 15 in the container carrying device 42, and the folding-in means 41 in which the folded unfilled portion 11h of the bagged culture medium block 14 fed from the second feeding means 40 is folded-in on the container 15 in the container carrying device 42.

The folding device 31 of the embodiment 1 is provided in a direction substantially orthogonal to the transport direction of the transporting means 60, in which the bagged culture medium block 14 is transported from the block forming device 21, and the bagged culture medium block 14 is moved in a direction substantially orthogonal to the transport direction of the transporting means 60 (see FIGS. 1 to 3).

Therefore, when the bagged culture medium block 14 is moved, the short sides of the bagged culture medium block 14, which is the narrow side surfaces 11d and 11e with the gusset folding lines, face the upstream side and the downstream side. In addition, the bagged culture medium block 14 is moved in the direction along the wide side surfaces 11b and 11c without the gusset folding lines.

As shown in FIGS. 1 to 3, 6A and 6B, the bagged culture medium block 14 is fed by the first feeding means 33 to the folding means 34, in which the folding is performed, from the end of the transporting means 60. In the embodiment 1, the first feeding means 33 is operated to push the bagged culture medium block 14 in the direction from the transporting means 60 to the folding means 34 with, for example, an arm-shaped feeding member 33a. Here, in the embodiment 1, the first feeding means 33 pushes the narrow side surface side with the gusset folding line of the bagged culture medium block 14. The first feeding means 33 is not limited to the feeding member 33a, and may be a belt conveyor or the like. Further, on the opposite side of the first feeding means 33 in the folding means 34, a regulating member 54 formed in, for example, a rod shape or a plate shape is provided to regulate the feeding movement of the bagged culture medium block 14. The regulating member 54 allows the bagged culture medium block 14 fed by the first feeding means 33 to be positioned at a predetermined position at which the folding by the folding means 34 is performed. When the bagged culture medium block 14 is moved by the second feeding means 40 described later, the regulating member 54 is moved to a place away from the moving direction of the bagged culture medium block 14. Therefore, the regulating member 54 is provided so as to be repeatedly movable.

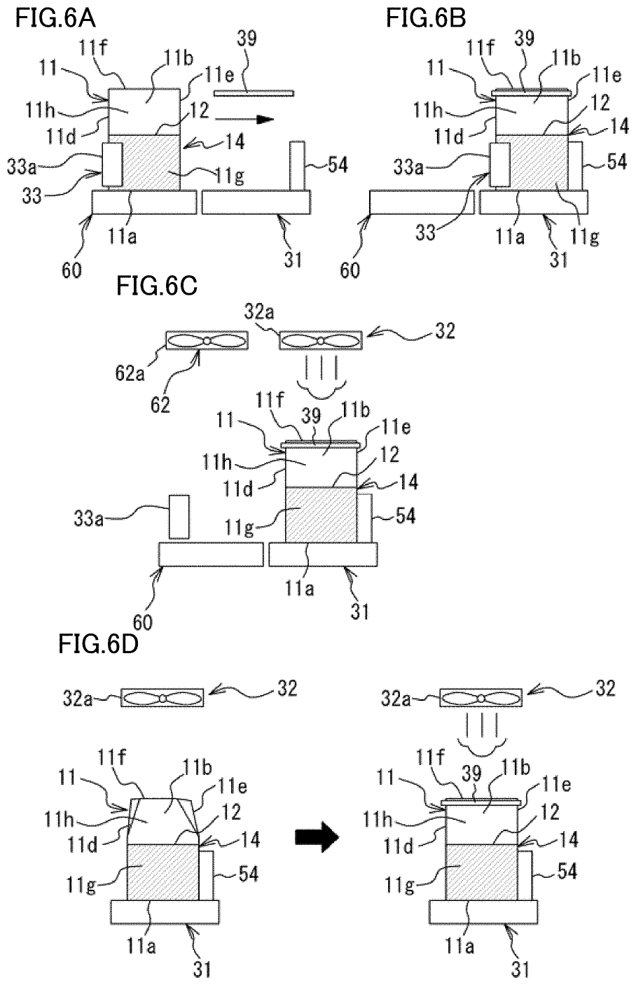

Next, the folding means 34 will be described. In the folding means 34, the bagged culture medium block 14 is transported thereinto in a state where the unfilled portion 11h of the bag body 11 of the bagged culture medium block 14 is upwardly opened and the bag mouth 11f is open (see FIGS. 1 to 3). First, in the folding means 34, as shown in FIGS. 1 to 3, 6C and 6D, the opening of the bag mouth 11f is performed by the opening mechanism 32 for ensuring that the bag mouth 11f of the bagged culture medium block 14 is open. That is, if the bag mouth 11f is not sufficiently opened or a part of the bag mouth 11f is closed (see the left side of FIG. 6D), it is difficult to fold the bag mouth 11f by the folding means 34. Therefore, by providing the opening mechanism 32, the bag mouth 11f is surely kept open (see the right side of FIG. 6D).

As shown in FIGS. 6C and 6D, in the opening mechanism 32, air is blown by, for example, a blower 32a or the like from above the bagged culture medium block 14 that was fed by the first feeding means 33 and is positioned by the regulating member 54 in the first feeding means 33, that is, from the bag mouth 11f side to keep the bag mouth 11f open. Here, it is preferable that the air blown from the blower 32a is evenly sent to the entire opened bag mouth 11f. On the other hand, if the air is blown vigorously only to a part of the bag mouth, the bag mouth may be closed or deformed, and the bag mouth 11f may not be sufficiently opened.

In the embodiment 1, the opening mechanism 32 is operated at the time when the folding means 34 is operated, but the present invention is not limited to this configuration, and as shown in FIGS. 1, 3 and 6C, in the phase before the bagged culture medium block 14 is fed from the transporting means 60 to the folding means 34, another opening means 62 may be provided in addition to the opening mechanism 32 in the folding means 34. The other opening means 62 is operated with the blower 62a similar to the opening mechanism 32 operated in the folding means 34. Here, it is preferable that the wind power of the blower 62a of the other opening means 62 is substantially same as or slightly weaker than that of the blower 32a of the opening mechanism 32. By providing the other opening means 62, the bag mouth 11f of the bagged culture medium block 14 can be opened more reliably in the folding means 34. The other opening means 62 may be provided on the transporting means 60.

Further, as shown in FIGS. 1 to 3 and 7 to 8, in the folding means 34 of the embodiment 1, there is provided an opening assist member 39 for assisting the opening of the bag mouth 11f of the bagged culture medium block 14 by the opening mechanism 32. The opening assist member 39 is provided at a position close to or in contact with both sides of the unfilled portion 11h of the bagged culture medium block 14 so as to be along the direction in which the bagged culture medium block 14 is transported. The opening assist member 39 is formed of a rod-shaped body or a plate-shaped body having a predetermined width. The opening assist member 39 may have an inclined shape in which the predetermined width widens toward the upstream side in the transport direction of the bagged culture medium block 14 so that the unfilled portion 11h of the bagged culture medium block 14 can easily enter the opening assist member 39. Further, this inclination may be provided on the downstream side of the opening assist member 39.

By providing the opening assist member 39, the opening mechanism 32 blows air from the bag mouth 11f side to open the unfilled portion 11h expandedly. Here, when the bag mouth 11f of the bagged culture medium block 14 is blown by the opening mechanism 32, the bag mouth 11f expands in an elliptical shape close to a substantially circular shape. On the other hand, by providing the opening assist member 39, the opening assist member 39 is brought into contact with the expanded unfilled portion 11h at the bag mouth 11f of the bagged culture medium block 14. As a result, the expansion of the bag mouth 11f and the unfilled portion 11h is partially restricted, and the expanded shape of the bag mouth 11f becomes an elliptical shape so that the long axis side is longer than that in the case where the opening assist member 39 is not provided. Therefore, when a supporting member 35a of a supporting mechanism 35 described later is inserted, contact of the supporting member 35a with the narrow side surfaces 11d and 11e of the bagged culture medium block 14 is suppressed, the supporting member 35a can be easily inserted from the bag mouth 11f.

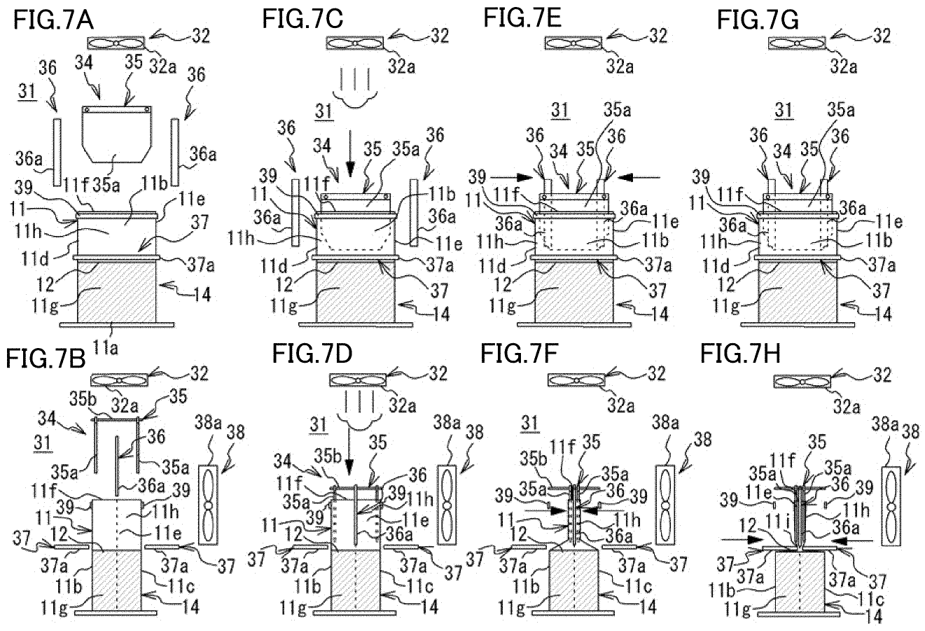

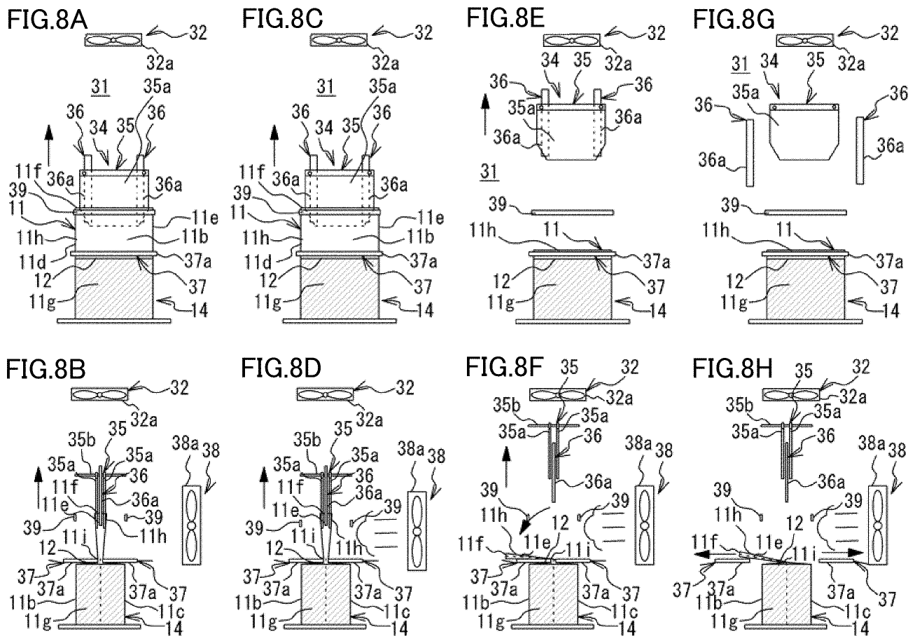

Next, the unfilled portion 11h of the bagged culture medium block 14 in which the bag mouth 11f side is opened by the opening mechanism 32 is folded by the folding means 34. As shown mainly in FIGS. 7 and 8, the folding means 34 is composed of the above-described opening mechanism 32 and opening assist member 39, the supporting mechanism 35, which is to be inserted into the unfilled portion 11h from the bag mouth 11f of the bagged culture medium block 14 and supports the bag mouth 11f so that the bag mouth 11f is open, a pushing mechanism 36, which pushes the narrow side surfaces 11d and 11e with the creases of the bagged culture medium block 14 in a state where the bag mouth 11f of the bagged culture medium block 14 is supported by the supporting mechanism 35, a pressing mechanism 37, which presses the boundary between the filled portion 11g and the unfilled portion 11h to narrow the unfilled portion 11h to form a neck portion 11i in a state where the narrow side surfaces 11d and 11e of the bagged culture medium block 14 are pushed by the pushing mechanism 36 and the unfilled portion 11h is narrowed, and a tilting mechanism 38, which tilts down the unfilled portion 11h of the bagged culture medium block 14 pressed by the pressing mechanism 37.

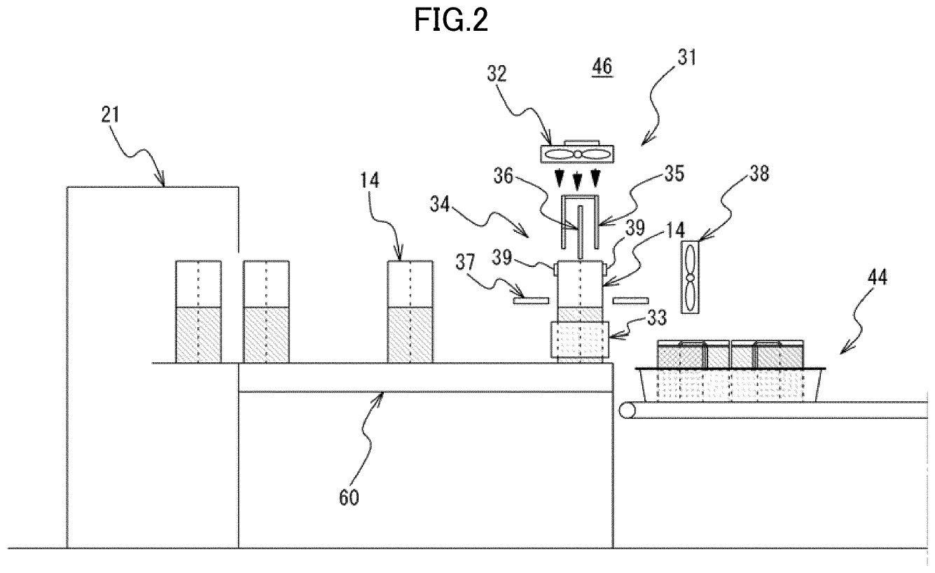

As shown in FIGS. 2, 3, 7A and 7B, the supporting mechanism 35 is composed of the supporting members 35a, which are to be inserted into the unfilled portion 11h from the opened bag mouth 11f of the bagged culture medium block 14 and are a pair of plates of a predetermined size. In the embodiment 1, these supporting members 35a are not along the short side surfaces 11d and 11e with the ceases of the bagged culture medium block 14, but along the longitudinal side surfaces 11b and 11c. The respective supporting members 35a are arranged so as to face each other. That is, each supporting member 35a is arranged in the orientation along the feeding direction of the bagged culture medium block 14. The supporting member 35a of the supporting mechanism 35 is configured to be able to be moved up and down.

Further, each supporting member 35a is connected to each other via, for example, a beam member 35b or the like, and is configured so that they can be repeatedly moved at the same time in a direction in which they approach each other and a direction in which they are separated from each other. Further, the supporting member 35a may be composed of a plurality of plate-shaped pieces or rod-shaped bodies instead of a single plate-shaped body. In a case where the supporting member 35a is composed of a plurality of plate-shaped pieces, rod-shaped bodies or the like, they are provided at least on the four corner sides of the bag mouth 11f of the bagged culture medium block 14. The supporting member may be inclined or curved on the tip side, that is, the side that is first inserted into the bag mouth 11f, so that the supporting member can be easily inserted from the bag mouth 11f of the bagged culture medium block 14.

As shown in FIGS. 2, 3, 7A and 7B, the pushing mechanism 36 is composed of a pair of plate-shaped pushing members 36a that face each other with the bagged culture medium block 14 being therebetween, and the pushing members 36a are arranged on the side of the short side surfaces 11d and 11e with the creases of the bagged culture medium block 14 and configured to be repeatedly moved in the direction of pushing the bagged culture medium block 14 and in the direction away from the bagged culture medium block 14. The pushing members 36a are arranged on the upstream side and the downstream side of the bagged culture medium block 14 in the transport direction with the bagged culture medium block 14 being therebetween. The pushing member is not limited to a plate shape, but may be a rod shape.

As shown in FIGS. 1, 2, 7A and 7B, the pressing mechanism 37 is composed of a pair of plate-shaped pressing members 37a. The pressing members 37a are moved at a height close to the upper surface of the culture medium 12 of the bagged culture medium block 14 from the sides of the longitudinal side surfaces 11b and 11c of the bagged culture medium block 14 to the substantially central portion. Then, the pressing members 37a press the culture medium 12 side of the unfilled portion 11h of the bagged culture medium block 14 to constrict the culture medium 12 side of the unfilled portion 11h so that the neck portion 11i is formed. The neck portion 11i functions as an axis when the unfilled portion 11h is tilted by the tilting mechanism 38 described later (see FIG. 8B). Further, in the embodiment 1, each pressing member 37a is substantially parallel to the surface on which the bagged culture medium block 14 is arranged in the folding means 34, that is, the pressing member 37a is arranged substantially parallel to the upper surface of the culture medium 12 of the filled portion 11g of the bagged culture medium block 14. The pressing members 37a of the pressing mechanism 37 are configured to be repeatedly moved from the side of the longitudinal side surfaces 11b and 11c of the bagged culture medium block 14 to the substantially central portion.

The pressing members 37a of the pressing mechanism 37 are arranged so as to face each other in a direction substantially orthogonal to the transport direction of the bagged culture medium block 14. Here, the pressing member 37a is not limited to a plate shape, but may be a rod shape.

Next, as shown in FIGS. 1, 2 and 7B, the tilting mechanism 38 tilts the unfilled portion 11h of the bagged culture medium block 14 along the upper surface of the culture medium 12. This operation is performed by, for example, mechanically pushing down the unfilled portion 11h using a rod-shaped body or a plate or pushing down the unfilled portion 11h using wind pressure by blowing air. In the embodiment 1, the airflow generated by a blower or the like is applied to the unfilled portion 11h, that is, this operation is performed by wind pressure (see FIG. 8F). The tilting mechanism 38 is provided at a position along the transport direction of the bagged culture medium block 14, that is, along the longitudinal side surfaces 11b and 11c of the bagged culture medium block 14.

Further, the tilting mechanism 38 is not limited to the wind pressure of a blower or the like, and for example, an arm member such as a rod-shaped body, a square-shaped body, or a plate-shaped body may be repeatedly moved in a direction of tilting and a direction away from the bagged culture medium block 14 to be brought into contact with the unfilled portion 11h of the bagged culture medium block 14 to tilt down the unfilled portion 11h.

Next, in the second feeding means 40, as shown in FIGS. 1, 3, 10 to 12, the folded bagged culture medium block 14 is fed from the folding means 34 onto the container in which the folding-in means 41 will be operated. In the second feeding means 40, the bagged culture medium block 14 is pushed by, for example, an arm-shaped feeding member 40a to be moved from the folding means 34 in the direction toward the container carrying device 42 in which the container 15 is arranged. Here, the second feeding means 40 pushes the narrow side surfaces 11d and 11e with the gusset folding lines of the bagged culture medium block 14 similar to the first feeding means 33. When the second feeding means 40 is operated, the regulating member 54 is moved to a position away from the moving direction of the bagged culture medium block 14, and after the bagged culture medium block 14 is fed by the second feeding means 40, the regulating member 54 is moved again. Further, the regulating member 54 may be moved together with the second feeding means 40.

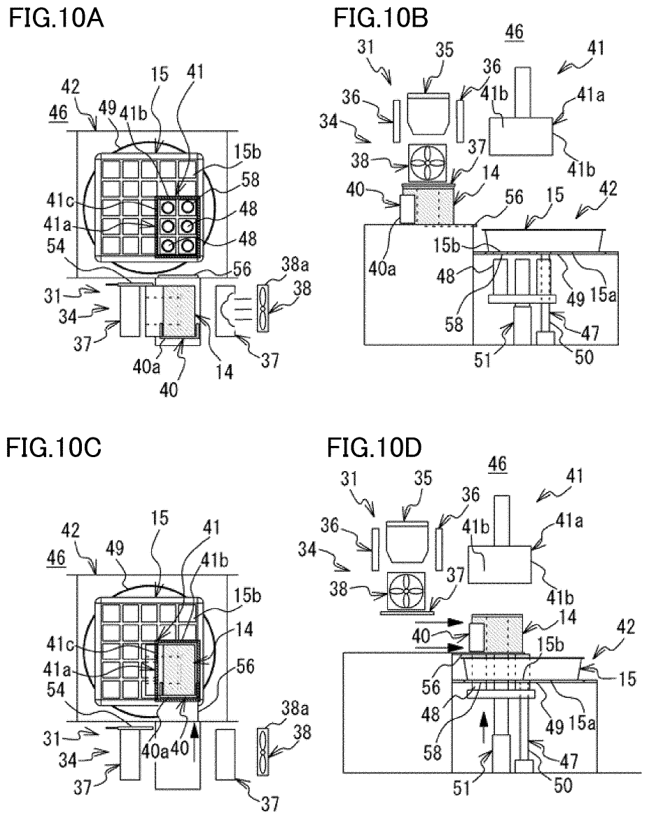

Further, in the folding device 31, there is provided an underlay member 56 having a predetermined thickness and a predetermined area for which the bagged culture medium block 14 is placed, which is taken in and out from the folding means 34 side to the container carrying device 42 side when the bagged culture medium block 14 is fed by the second feeding means 40. For example, the underlay member 56 is stored in the folding device 31. The underlay member 56 is sent out together with the movement of the bagged culture medium block 14 by the second feeding means 40, and is placed above a rod-shaped body 48 of a elevating mechanism 51 of the container carrying device 42, which will be described later, so that the bagged culture medium block 14 is moved onto the sent out underlay member 56 by the second feeding means 40 (see FIGS. 10C and 10D). Further, when the underlay member 56 is stored in the container 15 (described later), the underlay member 56 is pulled back and is stored in the folding device 31. Therefore, the underlay member 56 is provided so as to be repeatedly movable in the moving direction of the bagged culture medium block 14 and in the opposite direction thereof. Although a state where a part of the underlay member 56 is protruding is shown in FIGS. 1, 3, 10 and the like, all portion of the underlay member 56 may be stored inside the folding device 31.

Further, in a case where the folding device 34 and the container carrying device 42 are away from each other, there may be provided with a transport path for connecting them, and the underlay member 56 may be sent in and out from the transport path side to the container carrying device 42 side. Here, the underlay member may be stored inside the mechanism provided with the transport path.

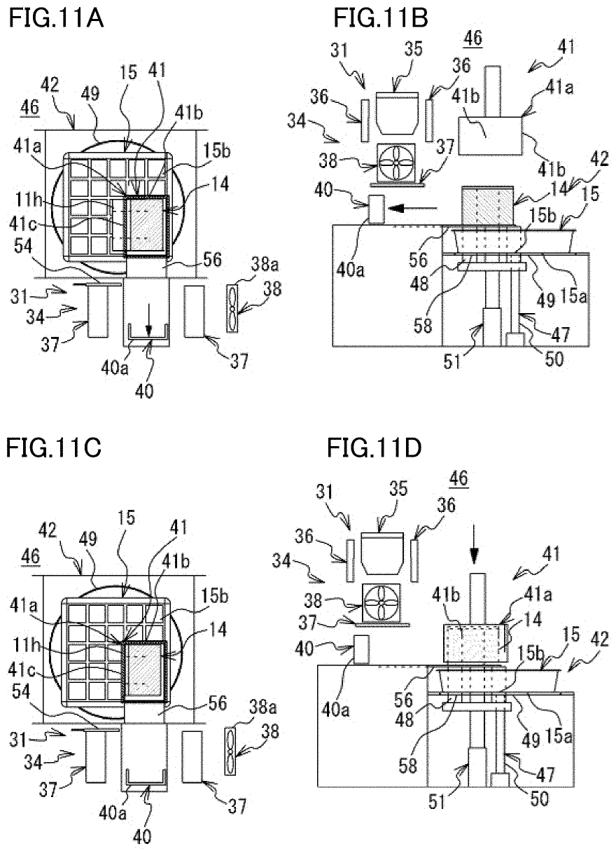

Further, when the underlay member 56 is pulled back, the bagged culture medium block 14 can be kept in place by the folding-in means 41 described later, so that the bagged culture medium block 14 is placed on top of the rod-shaped body 48 of the elevating mechanism 51 provided in the container carrying device 42 arranged below (see FIGS. 11A and 11B). When the bagged culture medium block 14 is fed to the folding means 34, the second feeding means 40 is moved and is at a position away from the moving direction of the bagged culture medium block 14, and after the bagged culture medium block 14 is arranged in the folding means 34, the second feeding means 40 is arranged at a position where the second feeding means 40 pushes the bagged culture medium block 14. The second feeding means 40 may be a belt conveyor or the like.

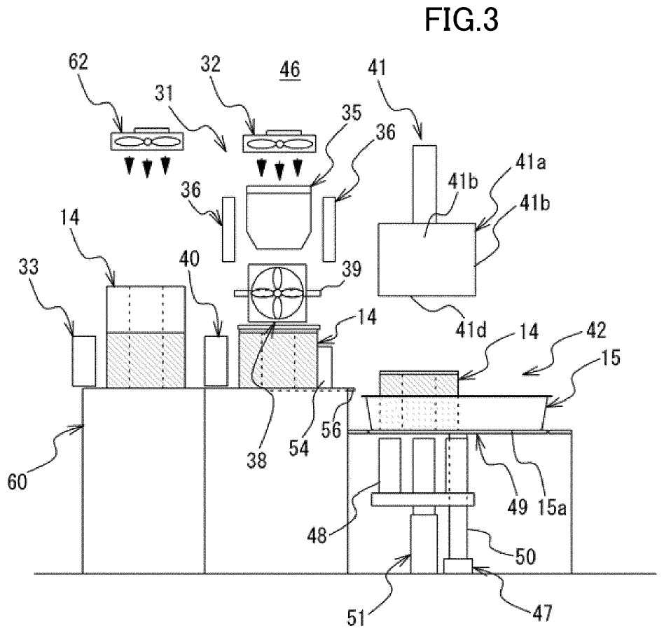

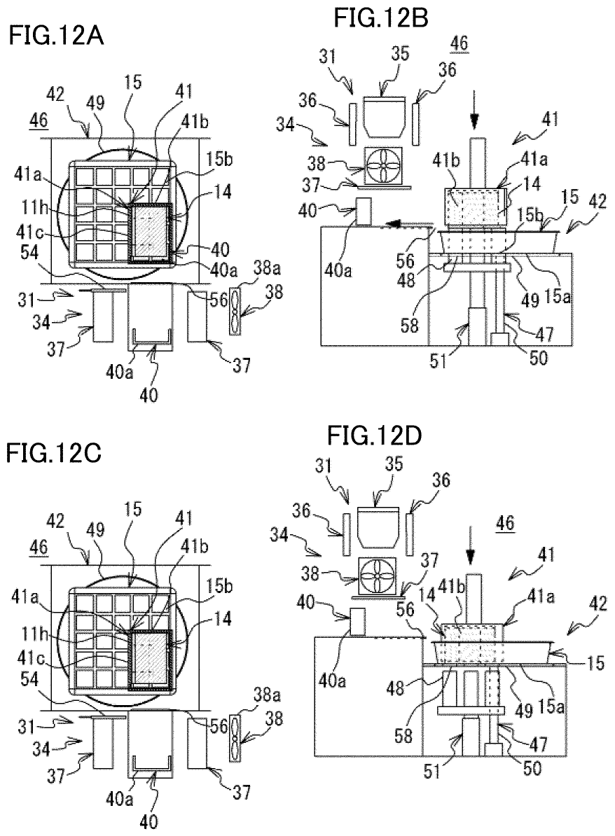

As shown mainly in FIGS. 1 and 3, the folding-in means 41 further folds-in the unfilled portion 11h of the bagged culture medium block 14 folded by the folding means 34 so as to shape the bagged culture medium block 14 into a state of being carried into the container 15 (see FIGS. 4C and 12). Further, as shown in FIGS. 1, 3, 9, 12 and 13, the folding-in means 41 includes a tubular folding-in member 41a having plate-shaped side walls 41b1, 41b2, 41b3 and 41c, which surround each of the wide side surfaces 11b and 11c of the bagged culture medium block 14 and narrow side surfaces 11d and 11e of the bagged culture medium block 14, and the tubular folding-in member 41a has a bottom portion on the bagged culture medium block 14 side and an upper portion facing the bottom portion are open. The folding-in member 41a has a shape corresponding to the bagged culture medium block 14 to be carried into the container 15.

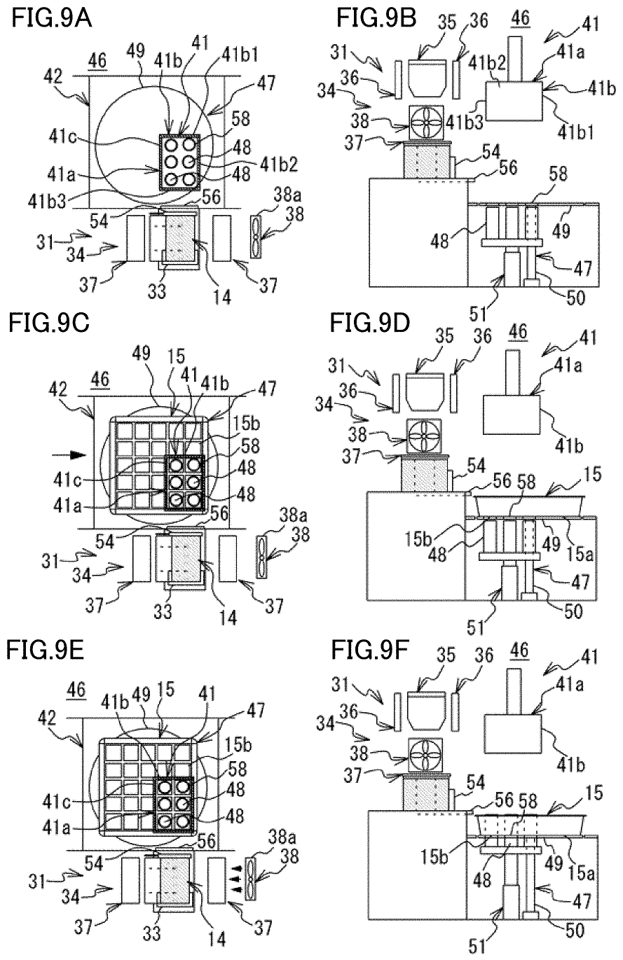

As will be described later, the folding-in member 41a has the side walls 41b1, 41b2, 41b3 and 41c constituting the folding-in member 41a, and is formed of a tubular body having a size through which the bagged culture medium block 14 can be inserted. Further, among the side walls 41b1, 41b2, 41b3 and 41c, the folding-in side wall 41c is for folding-in the unfilled portion 11h of the bagged culture medium block 14. Specifically, among the side walls of the folding-in member 41a, the long side wall which is arranged on the side where the unfilled portion 11h of the bagged culture medium block 14 is folded is the folding-in side wall 41c (see FIG. 9A, FIG. 9B). The folding-in member 41a is formed of a tubular body, but the corners may not be closed, and the side walls of the four plate-shaped bodies may be arranged so as to face each other in pairs. Further, the side walls of the folding-in member 41a other than the folding-in side wall 41c are shown as the side walls 41b1, 41b2 and 41b3, and are sometimes collectively referred to as 41b below.

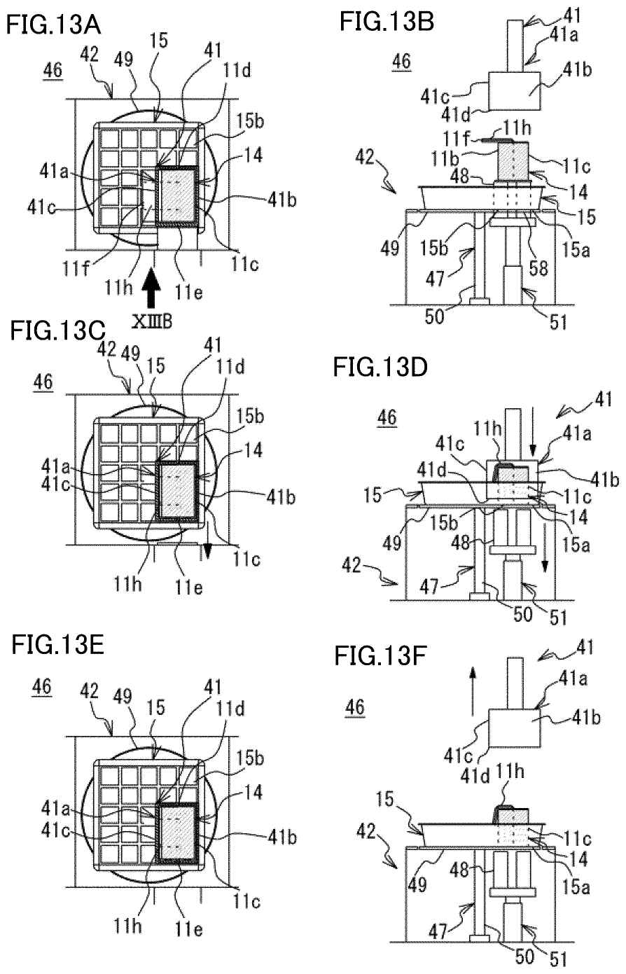

Then, the unfilled portion 11h of the bagged culture medium block 14 is folded-in by a bottom portion 41d of the folding-in side wall 41c located at a lower portion of the folding-in member 41a, that is, on the side of the arranged on the bagged culture medium block 14 side (see FIG. 13).

The folding-in means 41 is configured to be able to move the folding-in member 41a upward and downward. After the folding-in member 41a is brought into contact with the unfilled portion 11h folded substantially parallel to the upper surface of the culture medium 12 of the bagged culture medium block 14 arranged on the container 15, the folding-in member 41a is further moved down along the side surface of the bagged culture medium block 14 to fold-in the unfilled portion 11h. Here, the movement of the folding-in member 41a is linked with the operation of the container carrying device 42, which will be described in detail later.

Next, the operation of the folding device 31 in the embodiment 1 will be described mainly with reference to FIGS. 7 to 13. First, as described above, the bagged culture medium block 14 transported by the transporting means 60 is fed by the first feeding means 33 from above the transporting means 60 to the folding means 34 (see FIGS. 6A and 6B). Here, the bagged culture medium block 14 is moved until it is brought into contact with the regulating member 54 provided on the side opposite to the first feeding means 22d of the folding means 34, and by being brought into contact with the regulating member 54, the positioning of the bagged culture medium block 14 in the folding means 34 is performed.

Here, as shown in FIGS. 7A and 7B, the opening mechanism 32, the opening assist member 39, the supporting mechanism 35, the pushing mechanism 36 and the pressing mechanism 37 of the folding means 34 are arranged in the position at which the bagged culture medium block 14 is fed by the first feeding means 33.

Then, as shown in FIGS. 7C and 7D, in the folding means 34, the blower 32a as the opening mechanism 32 first blows air toward the bag mouth 11f of the bagged culture medium block 14 from above the bag mouth 11f to keep the bag mouth 11f of the bagged culture medium block 14 open (see FIGS. 6C and 6D). Regarding the bagged culture medium block 14, by providing the other opening means 62 for blowing air before the bagged culture medium block 14 is moved to the folding means 34, the bag mouth 11f is more easily opened. Further, by providing the opening assist member 39, due to the blower 32a of the opening mechanism 32, the bag mouth 11f of the bagged culture medium block 14 is expanded into an elliptical shape having a long axis.

Further, together with the operation of the opening mechanism 32, each supporting member 35a of the supporting mechanism 35 and the pushing members 36a of the pushing mechanism 36 are moved downward from above the bag mouth 11f of the bagged culture medium block 14, and among them, each supporting member 35a is inserted into the unfilled portion 11h from the opened bag mouth 11f of the bagged culture medium block 14. Each supporting member 35a is arranged along the longitudinal side surfaces 11b and 11c of the bagged culture medium block 14. Here, since each supporting member 35a is inserted into the unfilled portion 11h of the bagged culture medium block 14 while the blower 32a of the opening mechanism 32 blows air to keep the bag mouth 11f open, each supporting member 35a can be easily inserted. Further, by providing the opening assist member 39, the bag mouth 11f of the bagged culture medium block 14 is expanded into an elliptical shape having a long axis, so that the supporting member 35a can be easily inserted.

Next, after each supporting member 35a is inserted into the unfilled portion 11h, each pushing member 36a of the pushing mechanism 36 is moved toward the bagged culture medium block 14 as shown in FIGS. 7E and 7F. In the pushing mechanism 36, each of the pair of the pushing members 36a is moved from the short side surfaces 11d and 11e of the bagged culture medium block 14 so as to push the short side surfaces 11d and 11e of the unfilled portion 11h of the bagged culture medium block 14. Then, each of the short side surfaces 11d and 11e of the unfilled portion 11h of the bagged culture medium block 14 is pushed by each pushing member 36a so that the short side surfaces 11d and 11e are pushed along the creases, and each of the longitudinal side surfaces 11b and 11c of the bagged culture medium block 14 is moved toward the center side to close the bag mouth 11f.

Here, each supporting member 35a of the supporting mechanism 35 is moved to the center side in accordance with the movement of the longitudinal side surfaces 11b and 11c, and, as shown in FIG. 7F, each supporting member 35a is collected in the central portion together with the unfilled portion 11h of the bagged culture medium block 14. When the unfilled portion 11h of the bagged culture medium block 14 is collected on the centrer side, the boundary between the unfilled portion 11h and the filled portion 11g, that is, the unfilled portion 11h on the upper surface side of the culture medium 12, is not flat, that is, not substantially parallel to the upper surface of the culture medium 12, and for example, the central portion may be in a convex shape or distorted (see FIG. 7F).

After each supporting member 35a of the supporting mechanism 35 and each pushing member 36a of the pushing mechanism 36 are collected together with the unfilled portion 11h in the central portion and the opposing supporting members 35a are in close proximity to each other, as shown in FIGS. 7G and 7H, the pressing mechanism 37 presses the upper surface side of the culture medium 12 of the unfilled portion 11h of the bagged culture medium block 14 and the neck portion 11i is provided, which functions as an axis when the unfilled portion 11h is tilted. In the pressing mechanism 37, the pair of the pressing members 37a are moved from the longitudinal side surfaces 11b and 11c of the bagged culture medium block 14 toward the center on the upper surface side of the culture medium 12 of the filled portion 11g, and clamp the unfilled portion 11h. Here, the upper surface side of the culture medium 12 of the unfilled portion 11h of the bagged culture medium block 14 is prepared to be substantially flat. In the embodiment 1, plate-shaped pressing members are used, but the present invention is not limited to this configuration, and a rod-shaped bodies along the longitudinal direction of the bagged culture medium block 14 may be used.

Next, as shown in FIGS. 8A and 8B, each supporting member 35a of the supporting mechanism 35 and each pushing member 36a are moved upward. Here, the pushing members 36a of the pushing mechanism 36 maintain the state in which the pushing member 36a pushes the bagged culture medium block 14.

After that, as shown in FIGS. 8C and 8D, each supporting member 35a of the supporting mechanism 35 and each pushing member 36a are moved upward. Here, a blower 38a of the tilting mechanism 38 blows air before each supporting member 35a of the supporting mechanism 35 and each pushing member 36a are pulled out from the unfilled portion 11h of the bagged culture medium block 14. Further, also in a case where a mechanical arm member such as in a rod-shaped body, a square-shaped body, or a plate-shaped body is used as a tilting mechanism, each supporting member 35a of the supporting mechanism 35 and each pushing member 36a are moved upward, but before they are pulled out from the unfilled portion 11h of the bagged culture medium block 14, the mechanical arm member is moved to the unfilled portion 11h side of the bagged culture medium block 14.

Then, as shown in FIGS. 8E and 8F, the unfilled portion 11h is pressed by the wind pressure from the side of the longitudinal side surface 11b of the bagged culture medium block 14 due to the air blown by the blower 38a of the tilting mechanism 38, and the unfilled portion 11h is rotated around the neck portion 11i that is pressed by the pressing member 37a and tilted down. Here, the tilting mechanism 38 is operated in a state where each supporting member 35a is inserted in the unfilled portion 11h of the bagged culture medium block 14, so that the neck portion 11i is tilted down in a state where the upper portion of the unfilled portion 11h is supported. In this way, the deformation of the unfilled portion 11h can be suppressed.

Then, as shown in FIGS. 8G and 8H, after the unfilled portion 11 of the bagged culture medium block 14 is tilted down, the blowing of the blower 38a of the tilting mechanism 38 is stopped. In a case where a mechanical arm member such as in a rod-shaped body, a square-shaped body, or a plate-shaped body is used as a tilting mechanism, the arm member is moved to the original position before the operation. Here, the unfilled portion 11h of the bagged culture medium block 14 is in a tilted state. When the unfilled portion 11h of the bagged culture medium block 14 is tilted down, the blower 32a of the opening mechanism 32 may be operated to blow air from above to keep the unfilled portion 11h of the bagged culture medium block 14 tilted down. This completes the folding of the unfilled portion 11h of the bagged culture medium block 14 with the folding means 34.

Next, the second feeding means 40 will be described. The bagged culture medium block 14 is fed onto the container 15 of the container carrying device 42, which will be described later, by the second feeding means 40, and the unfilled portion 11h is folded-in by the next folding-in means 41. 2. Here, the container carrying device 42, in which the container 15 into which the bagged culture medium block 14 fed by the second feeding means 40 is carried is arranged, will be described with reference to FIGS. 1 to 3 and 9. In FIG. 9, the opening assist member 39 is omitted.

As shown in FIGS. 9A and 9B, the container carrying device 42 is provided with a plurality of the rod-shaped bodies 48, on which the bagged culture medium block 14 is to be placed, the elevating mechanism 51 for raising and lowering these rod-shaped bodies 48, a rotating member 49 for rotating the placed container, and a rotating mechanism 47 for rotating the rotating member 49. Further, the elevating mechanism 51 has a mechanism, in which the plurality of the rod-shaped bodies 48 are raised and lowered and are inserted into and pulled out from a plurality of gaps 15b provided in a bottom portion 15a of the container 15 to store the plurality of bagged culture medium blocks 14 in the container 15 in an aligned state. Further, the rotating member 49 of the rotating mechanism 47 is provided with a convex member (not shown) for positioning and fixing the container 15, and is configured to move in and out the convex member according to the movement of the container 15.

The rotating mechanism 47 has a rotatable, for example, disk-shaped rotating member 49 having a predetermined size, and a rotating shaft portion 50 for rotating the rotating member 49. The rotating member 49 is rotatable together with the container 15 and the bagged culture medium block 14 placed on the upper surface thereof. Further, the rotating member 49 is formed with a plurality of openings 58 through which each rod-shaped body 48 of the elevating mechanism 51 can be inserted.

Further, as shown in FIGS. 9A and 9B, the elevating mechanism 51 repeatedly raises a plurality of the rod-shaped bodies 48. The rod-shaped bodies 48 are configured to be inserted into and pulled out from the openings 58 formed in the rotating member 49 of the rotating mechanism 47 and from the plurality of gaps 15b formed in the bottom portion 15a of the container 15. Further, the rod-shaped bodies 48 are arranged below the underlay member 56 sent out from the folding means 34 described above, and as will be described later, when the underlay member 56 is pulled back, the bagged culture medium block 14 placed on the underlay member 56 is placed on the upper portions of the rod-shaped bodies 48. Here, the folding-in means 41 regulates the movement of the bagged culture medium block 14, and even if the underlay member 56 is moved, the bagged culture medium block 14 can be placed on the rod-shaped bodies 48.

Then, in a state where the container 15 is not carried in, that is, in a state before the container is carried in, as shown in FIGS. 9A and 9B, each rod-shaped body 48 is lowered by the elevating mechanism 51, and is placed below the rotating member 49 and has a height at which the container 15 can be carried.

Then, as shown in FIGS. 9C and 9D, after the container 15 is carried in a predetermined position, each rod-shaped body 48 is raised by the elevating mechanism 51 as shown in FIGS. 9E and 9F. Here, each rod-shaped body 48 is penetrated through the gap 15b provided in the bottom portion 15a of the container 15 and the opening 58 of the rotating member 49, respectively. In this state, the bagged culture medium block 14 will be sent onto the rod-shaped bodies 48 so that the bagged culture medium block 14 can be placed on the rod-shaped bodies 48.

Further, in the container carrying device 42, there are provided container setting means 43, which takes out a container from a plurality of the containers 15 prepared in advance and set the container, and a container transporting means 44, in which the container 15 in which the bagged culture medium block 14 is carried is fed to a next machine, for example, a sterilizer (see FIGS. 1 and 3). As the container transporting means 44, a configuration which transport the container to a movable shelf for transporting the container to the sterilizer is included.

In the container setting means 43, after the container 15 on the container carrying device 42, in which the bagged culture medium block 14 is stored, is transported to the next machine, one container 15 is automatically set in the container carrying device 42 from the plurality of stacked containers 15. When the container 15 is transported from the container carrying device 42, the empty container 15 pushes out the container 15 storing the bagged culture medium block 14 from the container setting means 43, so that the container 15 is replaced. Further, in the container transporting means 44, the container 15 storing the bagged culture medium block 14, which is pushed out by the new empty container 15, is transported by a conveyor or the like.

Further, the number of the rod-shaped bodies 48 of the elevating mechanism 51 and the openings 58 in the rotating member 49 of the rotating mechanism 47 may be arbitrarily provided, but it is preferable that they are provided at least in portions on which the bagged culture medium block 14 fed by the second feeding means 40 can be supported, for example, portions including the size of the bagged culture medium block 14.

Next, the second feeding means 40 will be described with reference to FIGS. 10 to 12. As shown in FIGS. 10 to 12, the second feeding means 40 feeds the bagged culture medium block 14 to the container carrying device 42 in a state where the unfilled portion 11h of the bagged culture medium block 14 is tilted down. Here, in order to prevent the unfilled portion 11h of the bagged culture medium block 14 from rising, the folding-in means 41 may be provided with a blower such as the opening mechanism 32 or the other opening means 62 as described above. In FIGS. 10 to 12, the opening assist member 39 is omitted.

When the bagged culture medium block 14 is fed by the second feeding means 40, first, as shown in FIGS. 10A and 10B, the second feeding means 40 is brought into contact with the bagged culture medium block 14 from the opposite side in the moving direction of the bagged culture medium block 14 in which the unfilled portion 11h is folded by the folding means 34. Here, the container 15 in which the bagged culture medium block 14 is to be stored is arranged in the container carrying device 42.

Next, as shown in FIGS. 10C and 10D, there is provided the underlay member 56 which is taken in and out from below the position, at which the bagged culture medium block 14 in the folding means 34 is placed, to the container carrying device 42 side. The second feeding means 40 feeds the bagged culture medium block 14 so that the bagged culture medium block 14 is once placed on the underlay member 56. Here, when the bagged culture medium block 14 is fed by the second feeding means 40, the regulating member 54 is moved away from the traveling direction of the bagged culture medium block 14. The regulating member 54 may be configured to be repeatedly moved together with the second feeding means 40. Further, in the container carrying device 42, the rod-shaped bodies 48 are raised by the elevating mechanism 51, and is moved to a position arranged under the underlay member 56.

Next, as shown in FIGS. 11A and 11B, the second feeding means 40 is pulled back and placed at a predetermined position in the folding means 34. Here, the second feeding means 40 is moved to a position away from the moving direction of the bagged culture medium block 14 so that the next bagged culture medium block 14 can be sent to the folding means 34, and after the bagged culture medium block 14 is arranged in the folding means 34, the second feeding means 40 is moved to a position where the second feeding means 40 can push the bagged culture medium block 14.

After that, as shown in FIGS. 11C and 11D, the folding-in means 41 is moved downward, and the bagged culture medium block 14 is surrounded by the folding-in member 41a. Here, the unfilled portion 11h of the bagged culture medium block 14 is folded-in by a folding-in wall portion 41c of the folding-in means 41 so that the bag mouth 11f faces downward, that is, toward the container 15 (see FIGS. 13A to 13D).

Next, as shown in FIGS. 12A and 12B, the underlay member 56 is pulled back in a state where the bagged culture medium block 14 is surrounded by the folding-in member 41a of the folding-in means 41. Here, since the folding-in member 41a does not move, the bagged culture medium block 14 is stopped at the sent out position by the second feeding means 40, so that even when the underlay member 56 is moved, the bagged culture medium block 14 stays in place. Then, by moving the underlay member 56, the bagged culture medium block 14 is moved downward and placed on the rod-shaped bodies 48.

After that, as shown in FIGS. 12C and 12D, the rod-shaped bodies 48 of the container carrying device 42 are lowered by the elevating mechanism 51, the folding-in means 41 is also moved downward, and the bagged culture medium block 14 is stored in the container 15. After the bagged culture medium block 14 is stored in the container 15, the folding-in means 41 is moved upward (see FIGS. 13E and 13F).

Next, with reference to FIGS. 13A to 13F, the folding-in means 41 for folding-in the unfilled portion 11h of the bagged culture medium block 14 will be described. Here, in FIGS. 13B, 13D, 13F and the like, the orientation of the unfilled portion 11h is shown in a different direction from that in FIGS. 12B, 12D and the like for easy understanding the folding-in operation of the unfilled portion 11h.

First, the bagged culture medium block 14, which is fed from the folding means 34 by the second feeding means 40 and the underlay member 56, is arranged on the upper portions of the rod-shaped bodies 48 as shown in FIGS. 13A and 13B. The container 15 is arranged in the container carrying device 42, and the rod-shaped bodies 48 are arranged so as to penetrate the gaps 15b in the bottom portion 15a of the container 15 and the openings 58 of the rotating member 49. Further, the unfilled portion 11h of the bagged culture medium block 14 is in a folded state where the unfilled portion 11h is substantially parallel to the culture medium 12.

After that, as shown in FIGS. 13C and 13D, the folding-in member 41a of the folding-in means 41 is moved downward, that is, toward the bagged culture medium block 14, and folds-in the folded unfilled portion 11h, and the rod-shaped bodies 48 of the container carrying device 42 are lowered by the elevating mechanism 51, so that the bagged culture medium block 14 in which the unfilled portion 11h is folded-in is stored in the container 15. Here, the rod-shaped body 48 are lowered below the container 15 and the rotating member 49.

In the folding-in means 41, the bottom portion 41d of the folding-in wall portion 41c of the folding-in member 41a pushes the unfilled portion 11h, and the unfilled portion 11h is folded-in downward along the longitudinal side surface 11c of the bagged culture medium block 14 so that, as shown in FIG. 13D, the bagged culture medium block 14 is shaped in a substantially cubic shape (see FIG. 4C).

After that, as shown in FIGS. 13E and 13F, the folding-in member 41a of the folding-in means 41 is moved upward, and the folding of the bagged culture medium block 14 by the folding device 31 is completed. Here, by storing a bagged culture medium block 14 in the container 15, the process of storing a bagged culture medium block 14 in the container carrying device 42 of the containerization device 46 is also completed.

The unfilled portion 11h of the bagged culture medium block 14 may be folded-in by the folding-in means 41 at the same time as the rod-shaped bodies 48 are lowered by the elevating mechanism 51, or after the bagged culture medium block 14 is stored in the container 15.

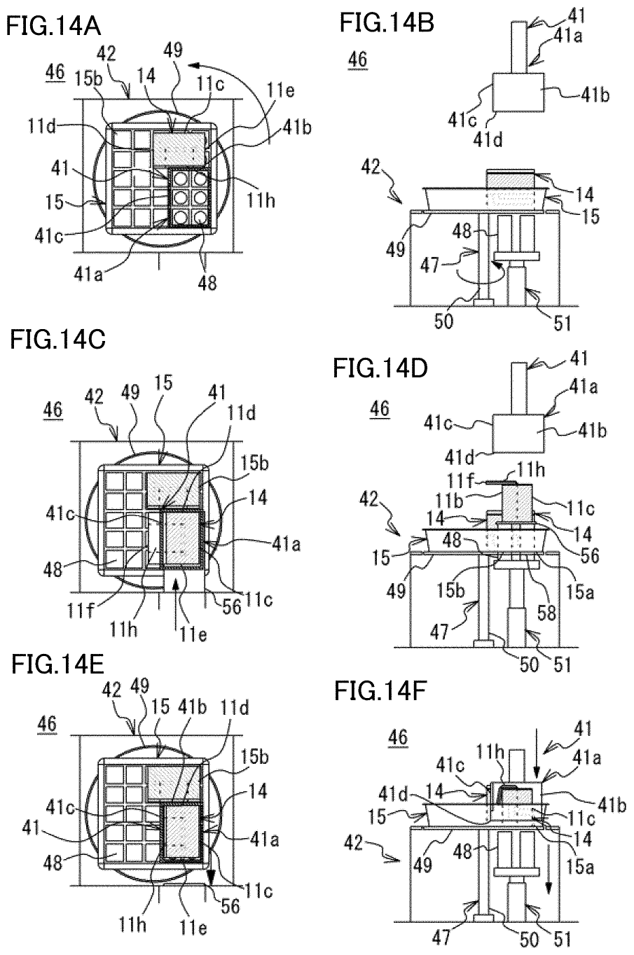

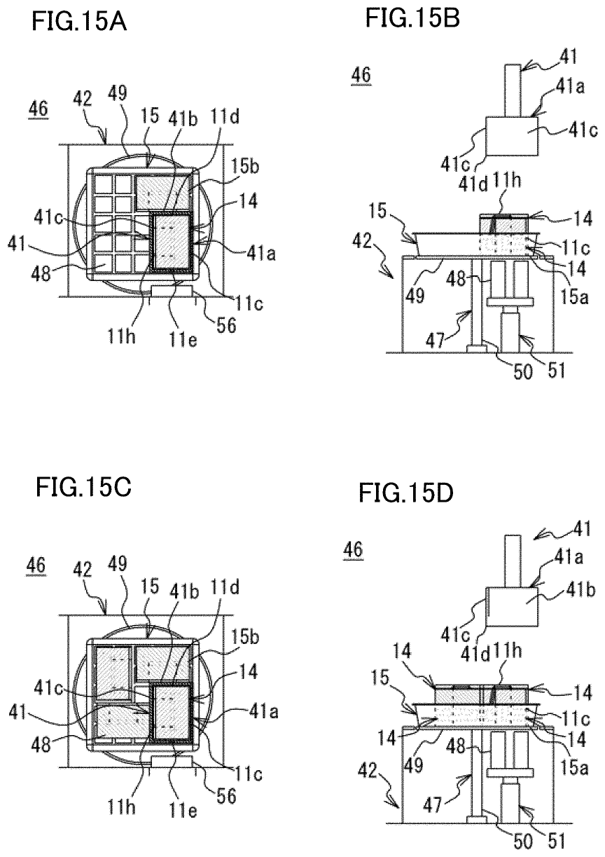

Next, with reference to FIGS. 14 and 15, the storing and carrying of a plurality of (in embodiment 1, four) bagged culture medium blocks 14 into the container carrying device 42 in the containerization device 46 will be described.

First, in the above-described process, a bagged culture medium block 14 is stored in the container 15 of the container carrying device 42 (see FIGS. 13E and 13F). After that, as shown in FIGS. 14A and 14B, the rotating member 49 is rotated, for example, counterclockwise by approximately 90 degrees, and the bagged culture medium block 14 is rotated together with the container 15. The rotating member 49 may be rotated clockwise.

After that, as shown in FIGS. 14C and 14D, the rod-shaped bodies 48 are raised by the elevating mechanism 51, penetrate the openings 58 of the rotating member 49 and the gaps 15b of the container 15, and are placed in the predetermined positions, that is, positions below the underlay member 56 of the folding device 31 and having a height on which the bagged culture medium block 14 is placed. Then, the next bagged culture medium block 14 is arranged on the rod-shaped bodies 48 of the container carrying device 42 by the second feeding means 40 and the underlay member 56.

Then, as shown in FIGS. 14E and 14F, the folding-in member 41a of the folding-in means 41 is moved downward, and the rod-shaped bodies 48 are lowered by the elevating mechanism 51, so that the bagged culture medium block 14 in which the unfilled portion 11h is folded-in is stored in the container 15. Here, the unfilled portion 11h of the previously stored bagged culture medium block 14 is folded-in again by a wall portion 41b different from the folding-in wall portion 41c of the folding-in member 41a in the folding-in means 41, and is brought into contact with the newly stored next bagged culture medium block 14, so that the folded-in state can be maintained.

Then, as shown in FIGS. 15A and 15B, the rotating member 49 is rotated counterclockwise by approximately 90 degrees again to store the next bagged culture medium block 14.

Then, the above processes are repeated, and as shown in FIGS. 15C and 15D, the four bagged culture medium blocks 14 are stored in the container 15 of the container carrying device 42 in a so-called spiral shape, and the feeding of the bagged culture medium blocks 14 to the container carrying device 42 is temporarily suspended.

After that, as shown in FIGS. 1 and 3, the container 15 in which the bagged culture medium blocks 14 are stored is transported to the next device, for example, a sterilizer by the container transporting means 44, and the empty container 15 is set in the container carrying device 42 by the container setting means 43. Then, through the above-described processes again, the bagged culture medium block 14 is stored in the container 15.

The folded bagged culture medium block 14 can be fed from the folding device 31 to the container 15 of the container carrying device 42 by using a robot arm.

Through the above processes, a series of operation processes for manufacturing the bagged culture medium block 14 including the folding of the unfilled portion 11h of the bag mouth of the bagged culture medium block 14 is completed.

### Application Example 1

In the folding device 31 of the embodiment 1, the folding means 34 uses the pair of the pushing members 36a as the pushing mechanism 36 for pushing the short side surfaces 11d and 11e of the unfilled portion 11h of the bagged culture medium block 14. However, the present invention is not limited to this configuration, and wind pressure may be used as the pushing mechanism 36 for pushing the short side surfaces 11d and 11e of the unfilled portion 11h.

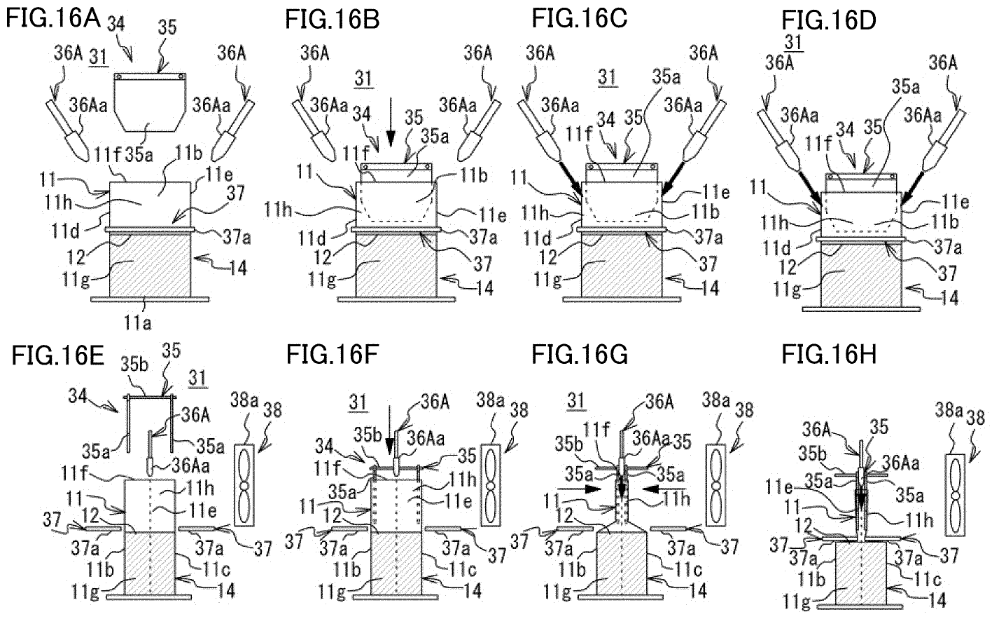

That is, as shown in FIG. 16, pushing mechanisms 36A for pushing the unfilled portion 11h of the bagged culture medium block 14 may be configured to blow air from the sides of the short side surfaces 11d and 11e with blowers 36Aa such as nozzles to push the sides of the short side surfaces 11d and 11e of the unfilled portion 11h of the bagged culture medium block 14 by wind pressure to fold the unfilled portion 11h. In FIG. 16, the opening mechanism 32 and the opening assist member 39 are omitted.

Specifically, as shown in FIGS. 16A and 16B, the supporting mechanism 35, the pushing mechanisms 36A and the pressing mechanism 37 of the folding means 34 are arranged with respect to the bagged culture medium block 14 fed by the first feeding means 33, respectively.

Next, as shown in FIGS. 16C and 16D, in the folding means 34, the opening mechanism 32 blows air, and each supporting member 35a of the supporting mechanism 35 is moved downward from above the bag mouth 11f of the bagged culture medium block 14, and each supporting member 35a is inserted into the unfilled portion 11h from the opened bag mouth 11f of the bagged culture medium block 14. Each supporting member 35a is arranged along the longitudinal side surfaces 11b and 11c of the bagged culture medium block 14. Here, the blowers 36Aa of the pushing mechanisms 36A do not need to move since the blowers 36Aa are arranged at positions where the wind pressure reach the side surfaces 11d and 11e.

After each supporting member 35a is inserted into the unfilled portion 11h, the pushing mechanisms 36A are operated. As shown in FIGS. 16E and 16F, the pushing mechanisms 36A blow air to the short side surfaces 11d and 11e of the unfilled portion 11h of the bagged culture medium block 14 from the sides of the short side surfaces 11d and 11e of the bagged culture medium block 14 using a pair of the blowers 36Aa to push the side surfaces 11d and 11e by wind pressure. Then, each of the short side surfaces 11d and 11e of the unfilled portion 11h of the bagged culture medium block 14 is pushed by the wind pressure of each blower 36Aa, so that the short side surfaces 11d and 11e are pushed along the creases. At the same time, each of the longitudinal side surfaces 11b and 11c of the bagged culture medium block 14 is moved toward the center side to close the bag mouth 11f.

Here, each supporting member 35a of the supporting mechanism 35 is moved to the center side in accordance with the movement of the longitudinal side surfaces 11b and 11c, and, as shown in FIG. 16F, each supporting member 35a is collected in the central portion together with the unfilled portion 11h of the bagged culture medium block 14. When the unfilled portion 11h of the bagged culture medium block 14 is collected on the center side, the boundary between the unfilled portion 11h and the filled portion 11g, that is, the unfilled portion 11h on the upper surface side of the culture medium 12, is not flat, that is, not substantially parallel to the upper surface of the culture medium 12, and for example, the central portion may be in a convex shape or distorted (see FIG. 16F).

After each supporting member 35a of the supporting mechanism 35 is collected together with the unfilled portion 11h in the central portion and the opposing supporting members 35a are in close proximity to each other, as shown in FIGS. 16G and 16H, the pressing mechanism 37 presses the upper surface side of the culture medium 12 of the unfilled portion 11h of the bagged culture medium block 14 and the neck portion 11i is provided, which functions as an axis when the unfilled portion 11h is tilted. Here, the blowers 36Aa of the pushing mechanism 36A may be kept in a state where the wind pressure is applied to the bagged culture medium block 14. Hereinafter, the same processes as in the embodiment 1 are performed.

In this way, the number of mechanical processes can be reduced and the cost can be reduced. Since the other operations of the application example 1 are common to those of the embodiment 1, detailed description thereof is omitted.

### Application Example 2

In the folding device 31 of the embodiment 1, the case where, in the folding means 34, the pair of the pressing members 37a is used as the pressing mechanism 37 for pressing the unfilled portion 11h of the bagged culture medium block 14 is described, but the present invention is not limited to this configuration. Wind pressure may be used as the pressing mechanism 37A for pressing the unfilled portion 11h.

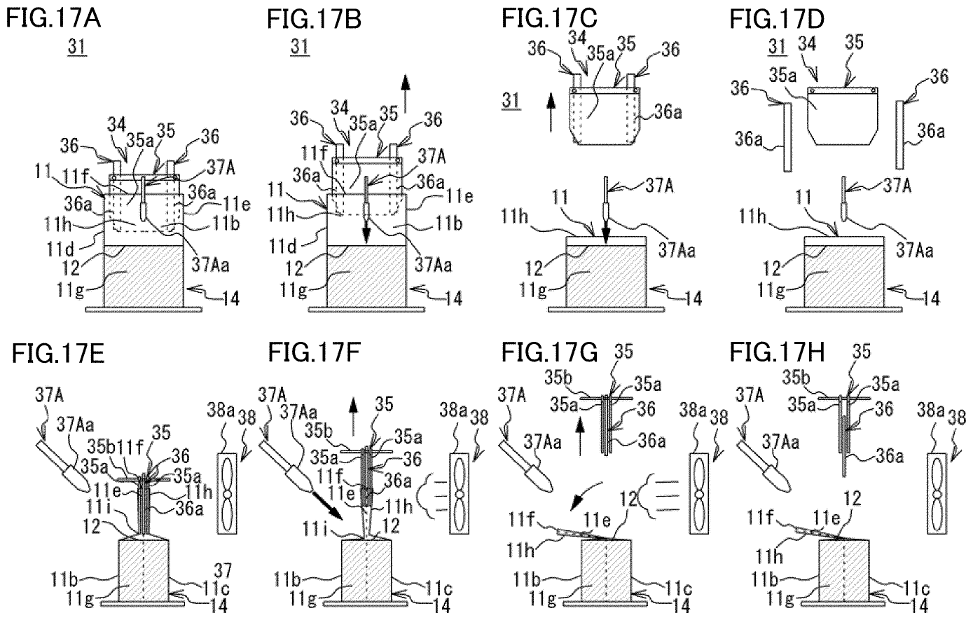

That is, as shown in FIG. 17, at the neck portion 11i between the unfilled portion 11h and the filled portion 11g collected in the central portion of the bagged culture medium block 14, a blower 37Aa such as a nozzle is used from the side opposite to the tilting mechanism 38 to apply wind pressure, so that the root portion of the unfilled portion 11h, that is, the neck portion 11i is formed, which functions as a support axis when the unfilled portion 11h is tilted by the tilting mechanism 38. In FIG. 17, the opening mechanism 32 and the opening assist member 39 are omitted.

Specifically, as shown in FIGS. 17A and 17B, the upper surface side of the culture medium 12 of the unfilled portion 11h of the bagged culture medium block 14 is pressed by the wind pressure of the blower 37Aa of the pressing mechanism 37A, and the neck portion 11i is formed, which functions as an axis when the unfilled portion 11h is tilted. In the pressing mechanism 37A, air is blown from one side, that is, the side of the longitudinal side surface 11b of the bagged culture medium block 14 opposite to the tilting mechanism 38, toward the central portion on the upper surface side of the culture medium 12 of the filled portion 11g to apply wind pressure to the unfilled portion 11h.

Then, after the unfilled portion 11h of the bagged culture medium block 14 is pressed by the wind pressure of the blower 37Aa of the pressing mechanism 37A, as shown in FIGS. 17C and 17D, the supporting member 35a of the supporting mechanism 35 and the pushing members 36a of the pushing mechanism 36 are pulled out from the unfilled portion 11h.

Then, as shown in FIGS. 17E and 17F, the unfilled portion 11h is pressed by the wind pressure from the side of the longitudinal side surface 11b of the unfilled portion 11h of the bagged culture medium block 14 due to the air blown by the blower 38a of the tilting mechanism 38, and the unfilled portion 11h is rotated around the neck portion 11i that is pressed by the blower 37Aa and tilted down. Here, as in the embodiment 1, the tilting mechanism 38 blows air in a state where the supporting member 35a and the pushing members 36a are in the unfilled portion 11h of the bagged culture medium block 14.

Then, as shown in FIGS. 17G and 17H, the blower 38a of the tilting mechanism 38 stops blowing, and in a state where the unfilled portion 11h of the bagged culture medium block 14 is tilted down, the blower 37Aa of the pressing mechanism 37A stops blowing. After that, the same processes as in the embodiment 1 are performed.

In this way, the number of mechanical processes can be reduced and the cost can be reduced. Since the operations other than that of the pressing mechanism 37A in the application example 2 are common to those in the embodiment 1, detailed description thereof is omitted.

Further, in the application example 1, the blowers 36Aa are used as the pushing mechanisms 36A, and in the application example 2, the blower 37Aa is used as the pressing mechanism 37A. However, the present invention is not limited to these configurations. The blowers 36Aa may be used as the pushing mechanisms 36A and the blower 37Aa may be used as the pressing mechanism 37A so that both of the pushing mechanisms 36A and the pressing mechanism 37A apply the wind pressure.

### Application Example 3

Further, in the embodiment 1, the case where the so-called gusset type bag body 11 is used for the bagged culture medium block 14 is described, but the present invention is not limited to this case, and the bagged culture medium block 14 may be folded in the I-shaped folding or in the bundled folding. The gusset folding is a method of folding a bag in a substantially M shape according to the creases on the short side surfaces of the bag, and the opening side of the bag has four layers at the short side ends and two layers at the central portion. The I-shaped folding is a method of folding a bag with both short sides straightly extended outward, and the opening side of the bag has two layers everywhere. The bundled folding is a method of folding a bag in which the opening of the bag is bundled, and the folding lines are irregularly formed.

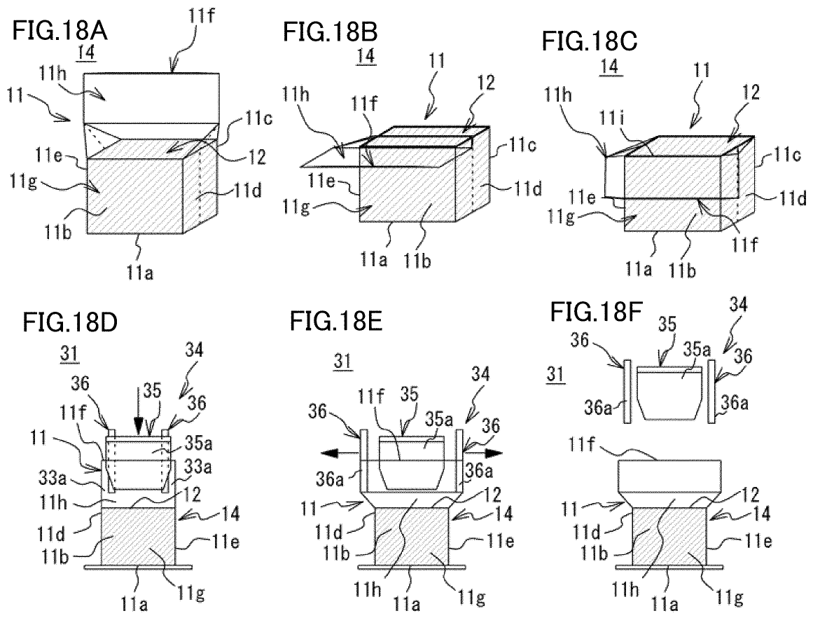

Here, as shown in FIG. 18A, the I-shaped folding is a method of folding a bag with both short sides 11d and 11e straightly extended outward when the bag mouth 11f side of the unfilled portion 11h of the bagged culture medium block 14 is closed, thus, the bag mouth 11f side of the bag has two layers everywhere. With this I-shaped folding, as shown in FIGS. 18B and 18C, the unfilled portion 11h can also be folded to form the bagged culture medium block 14.

Further, in the case of the I-shaped folding, the I-shaped folding can be performed by, for example, using the structure of the folding means 34 of the folding device 31 of the embodiment 1 and changing a part of the operation. That is, as shown in FIG. 18D, after inserting each supporting member 35a of the supporting mechanism 35 and the pushing members 36a of the pushing mechanism 36 in the folding means 34 from the opened bag mouth 11f side of the bagged culture medium block 14, respectively, the pushing members 36a are moved to and pushed outward both short sides 11d and 11e of the bagged culture medium block 14 as shown in FIG. 18E, so that the bag mouth 11f can be closed in the I-shape. After that, as shown in FIG. 18F, after pulling out the supporting mechanism 35 and the pushing mechanism 36, the subsequent processes of the pressing mechanism 37 and the tilting mechanism 38 are operated in a state where the bag mouth 11f of the unfilled portion 11h is folded in the I-shaped folding, and then, the bagged culture medium block 14 is carried into the container. When the tilting mechanism 38 is operated, the supporting member 35a is inside the unfilled portion 11h, as in the embodiment 1.

### Application Example 4

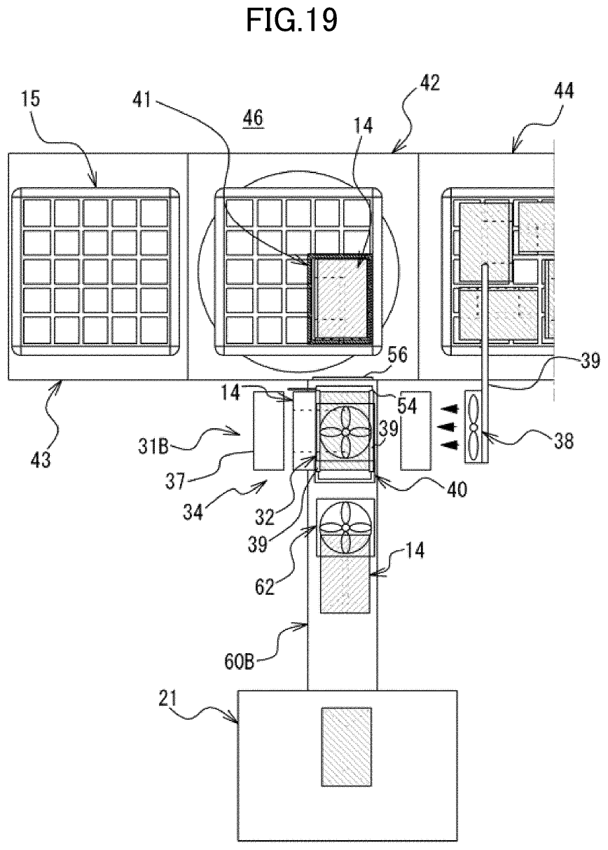

Further, in the embodiment 1, the case where the transporting means 60 from the block forming device 21 and the folding device 31 are arranged at a substantially right angle is described, but the present invention is not limited to this configuration, and as shown in FIG. 19, transporting means 60B from the block forming device 21 and a folding device 31B may be arranged so as to be substantially linear.

In this case, the first feeding means described in the embodiment 1 can be omitted, and the bagged culture medium block 14 can be directly transported from the block forming device 21 to the folding device 31B by the transporting means 60, and the unfilled portion 11h of the bagged culture medium block 14 is folded by the folding means 34. Here, the bagged culture medium block 14 is brought into contact with the regulating member 54 by the movement of the transporting means 60B, and is positioned for being folded by the folding means 34.

Here, regarding the orientation of the bagged culture medium block 14, as in the embodiment 1, the short sides of the bagged culture medium block 14, that is, the narrow side surfaces 11d and 11e with the gusset folding lines face the upstream side and the downstream side, and the bagged culture medium block 14 is moved in the direction along the wide side surfaces 11b and 11c without the gusset folding line of the bagged culture medium block 14.

### Application Example 5

Furthermore, the case where the supporting member 35a of the supporting mechanism 35 of the embodiment 1 is composed of one plate-shaped body or a plurality of plate-shaped pieces or rod-shaped bodies is described, but the supporting member 35a may have the thickness at least at the portions corresponding to the four corners of the bag mouth 11f of the culture medium block 14.

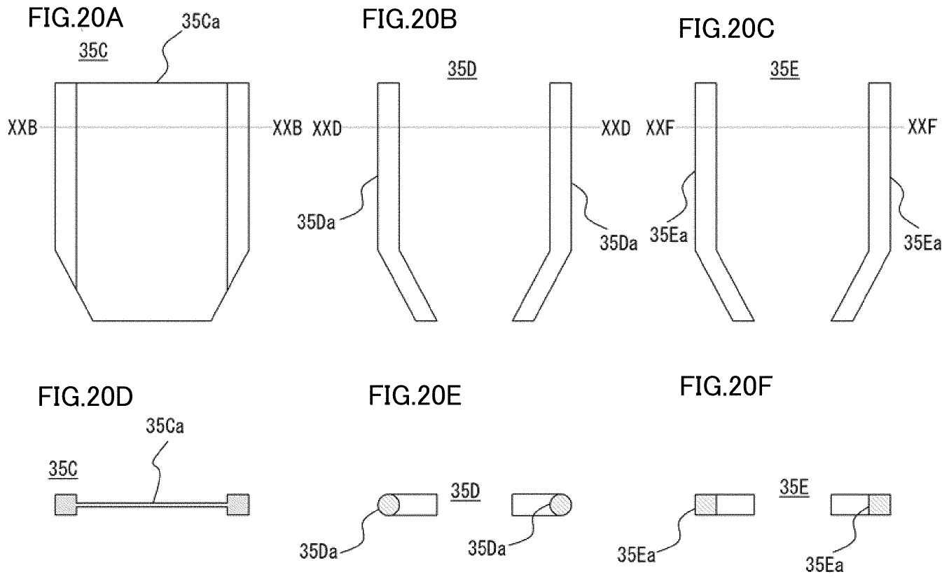

That is, as shown in FIGS. 20A and 20B, for example, in a case where a supporting member 35Ca of the supporting mechanism 35C is formed of a single plate-like body, the thickness of both ends is thicker than the thickness of portions other than both ends, so that, for example, they are formed to have quadrangular shapes, that is, they are formed in quadrangular columnar shapes. In addition, they may be formed in columnar. Further, as shown in FIGS. 20C to 20F, in a case where the supporting member 35a of the supporting mechanism 35 is formed of a plurality of plate-shaped pieces or rod-shaped bodies, the cross section is a circular shape whose thickness is thicker than the supporting member 35a shown in the embodiment 1, that is, the supporting members are columnar supporting members 35Da of the columnar mechanism 35D (see FIGS. 20C and 20D), or the cross section is a square shape, that is, the supporting members are square columnar supporting members 35Ea of the columnar mechanism 35E (see FIGS. 20E and 20F).

By using the supporting members 35Ca to 35Ea having such configurations, when the unfilled portion 11h of the bagged culture medium block 14 is folded, at the time when the thick portion around the supporting members 35Ca to 35Ea is folded, gaps are provided on each side surface 11b, 11c, 11d and 11e of the unfilled portion 11h. Then, by folding or folding-in the bagged culture medium block 14 in this state, when the bagged culture medium block 14 is shaped into a block shape, gaps are formed in the bag mouth 11f of the unfilled portion 11h, and the sealing of the inside of the bag body 11 is suppressed. By suppressing the sealing of the bag body 11, for example, in a sterilization process in which the bagged culture medium block 14 is carried into a subsequent sterilization pot to be sterilized, the generation of the pressure difference between the inside of the bag body 11 and the atmospheric pressure can be suppressed.

In a case where a plurality of the supporting members, for example, a pair of supporting members in which each supporting member is arranged on each side is provided, arbitrary shape and size can be adopted as long as the shape is thicker than the portion where the supporting members are not provided, that is, as long as the shape can generate a gap.

### Modified Example 1

Next, a containerization device 46F, which is a modification example 1 of the containerization device 46 of the embodiment 1, will be described. In the embodiment 1, the case where the bagged culture medium block 14 having a volume of about 2.5 kg to 2.8 kg is mainly used is described, but in the modified example, a case where the volume is smaller than that of the bagged culture medium block 14 of the embodiment 1 and is about 1.0 kg to 1.3 kg and a bagged culture medium block 14F having a size of about ½ to ⅓ is used will be described.

When such a small bagged culture medium block 14F is used, in the containerization device 46F, a part of the carrying and storing operation of the container carrying device 42 connected to the folding device 31 is changed, and in the process of carrying the bagged culture medium block 14F into the container 15 after the operation of the folding means 34, a part of the carrying and storing operation is different from the embodiment 1, so that the bagged culture medium block 14F can be carried into the container 15 more efficiently.

Since the block forming device 21 is commonly used, detailed description thereof will be omitted. Since a folding device 31F is partially different from the folding device 31, the same reference numerals will be given to the common configurations, and detailed description thereof will be omitted.

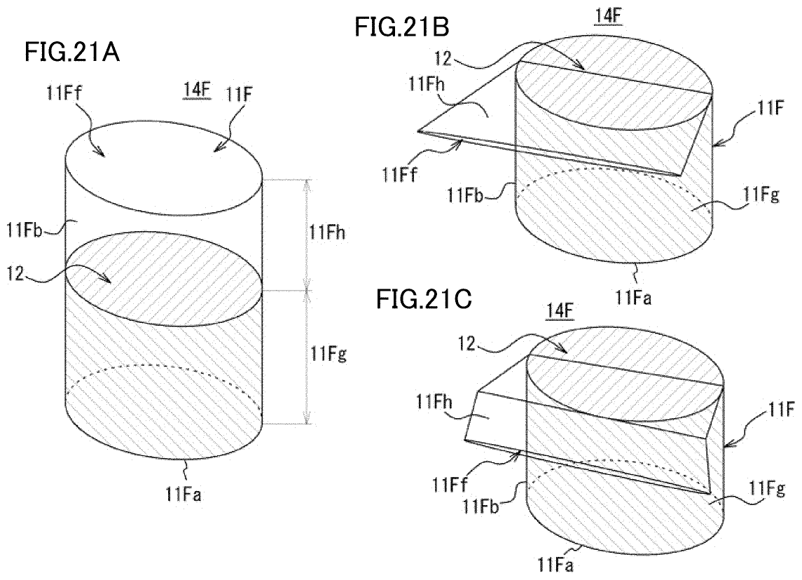

Here, the bagged culture medium block 14F having a volume of about 1.0 kg to 1.3 kg (hereinafter, simply referred to as the bagged culture medium block 14F) will be described. As shown in FIG. 21, the bagged culture medium block 14F is composed of a bag body 11F and the culture medium 12 filled in the bag body 11F, as in the embodiment 1. In FIG. 21A, a case where a bag mouth 11Ff is open in a state where the culture medium 12 is filled in the bag body 11F and the bagged culture medium block 14F is not folded is shown.

As shown in FIG. 21A, the bag body 11F has a circular bottom surface 11Fa, which has a predetermined length and width, and a side surface 11Fb, which has a predetermined height from the long side of the bottom surface 11Fa, and the bag body 11F is columnar. Here, the upper portion facing the bottom surface 11Fa is open, and this open portion is the bag mouth 11Ff, through which the culture medium 12 described later is filled. The material of the bag body 11F is the same as that of the embodiment 1.

Further, the bag body 11F is divided into a filled portion 11Fg filled with the culture medium 12 and an empty unfilled portion 11Fh above the filled portion 11Fg. That is, when the culture medium 12 described later is filled, the filled portion 11Fg has a predetermined height from the bottom surface 11Fa to the upper surface of the culture medium 12, and the unfilled portion 11Fh has a height from the top of the filled portion 11Fg, which is the upper surface of the culture medium 12, to the bag mouth 11Ff.

The culture medium 12 to be filled in the bag body 11F is common to that of the embodiment 1, and the weight when the culture medium 12 is filled in the bag body 11F is, for example, about 1.0 kg to 1.3 kg.

The size of the bag body 11F is not limited to the above dimensions, the bottom surface 11Fa may be rectangular, and the lengths of the filled portion 11Fg and the unfilled portion 11Fh may be changed according to the amount of the culture medium 12 to be used, and the weight may be increased or decreased.

Further, as in the embodiment 1, first, in the folding device 31F, the bag mouth 11Ff of the bagged culture medium block 14F is open as shown in FIG. 21A. Then, as shown in FIG. 21B, the bag mouth 11Ff of the bag body 11F is closed, and the boundary between the filled portion 11Fg and the unfilled portion 11Fh is folded along the upper surface of the filled portion 11Fg. In addition, in the bagged culture medium block 14F of the modified example 1, it is folded in the I-shaped folding.

Further, in the folding device 31F, the bagged culture medium block 14F in the state shown in FIG. 21B is further folded-in by the folding-in means to be in the state shown in FIG. 21C. That is to say, as shown in FIG. 21C, in the bagged culture medium block 14F, the bag mouth 11Ff of the bag body 11F is closed, and the boundary between the filled portion 11Fg and the unfilled portion 11Fh is bent along the upper surface of the filled portion 11Fg, and the block shape is formed by bending the unfilled portion 11Fh again along the side surface of the filled portion 11Fg so that the bag mouth 11Ff side faces downward. The bagged culture medium block 14F will be packed in the container 15 in a blocked shape in which the unfilled portion 11Fh of the bag body 11F of the bagged culture medium block 14F is folded.

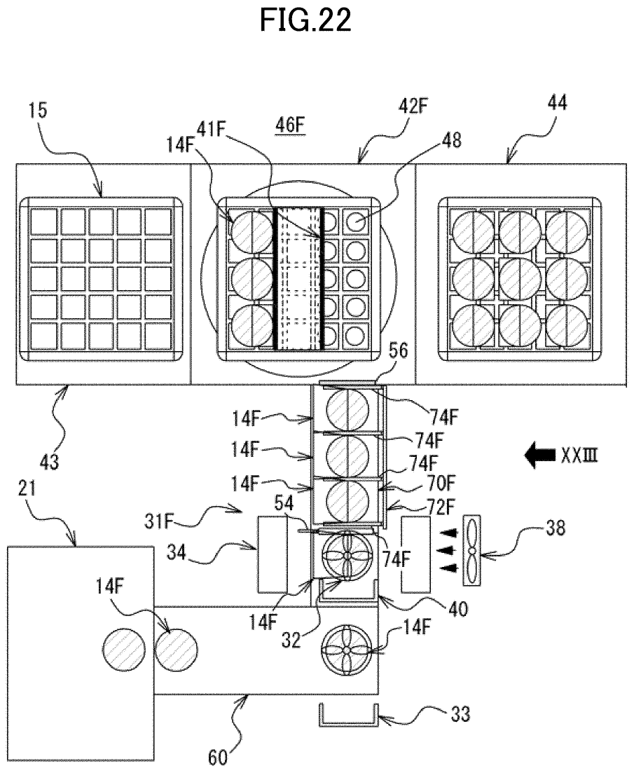

Next, with reference to FIGS. 22 to 32, the carrying and storing of the bagged culture medium block 14F from the folding device 31F to the container carrying device 42F in the containerization device 46 of the modified example 1 will be described. Since the opening mechanism 32, the first feeding means 33 and the folding means 34 of the folding device 31F in the modified example 1 are the same as those in the embodiment 1, detailed description thereof will be omitted. A belt conveyor or the like may be used as the first feeding means 33. Therefore, the processes after the operation of the folding means 34 of the folding device 31F, which are different from those in the embodiment 1, will be mainly described.

In the modified example 1, as shown in FIG. 22, the bagged culture medium blocks 14F are arranged in a 3×3 row in the container 15, so that the nine bagged culture medium blocks 14F are stored. Here, the unfilled portion 11Fh of each bagged culture medium block 14F is arranged so that the folded side faces inward.

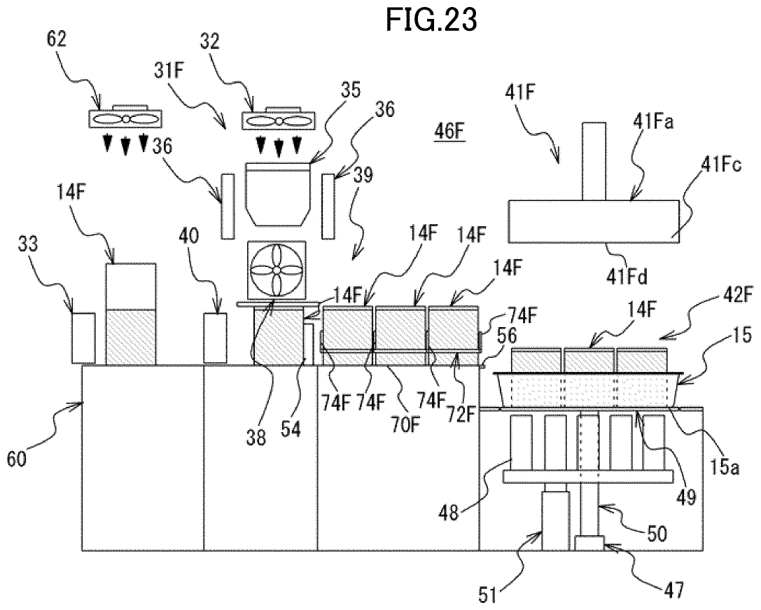

Further, as shown in FIGS. 22 and 23, in the folding device 31F of the modified example 1, an alignment section 70F having a predetermined size is provided before the container carrying device 42F, in which a predetermined number (three in the modified example 1) of the bagged culture medium blocks 14F are aligned as described later.

Further, in the folding device 31F of the modified example 1, there is provided an alignment member 72F for aligning and moving the bagged culture medium block 14F. The alignment member 72F is provided with a plurality of (four in the modified example 1) separating means 74F for restricting the movement of the bagged culture medium block 14F and for partitioning each bagged culture medium block 14F. The separating means 74F are attached so that the separating means 74F can be repeatedly moved with respect to the moving direction of the bagged culture medium block 14F between a position at which the movement of the bagged culture medium block 14F is blocked and a position at which the movement is not blocked.

Further, a folding-in member 41Fa of folding-in means 41F of the modified example 1 is different in shape from the folding-in member 41a of the embodiment 1, and is configured to have two rows of plate bodies 41Fc. That is, the two rows of the plate bodies 41Fc are provided side by side substantially in parallel in the direction in which the bagged culture medium block 14F is carried into the container 15. Further, the opposite side of a bottom portion 41Fd, which folds-in the unfilled portion 11Fh of the bagged culture medium block 14F, of the plate body 41Fc is configured to integrally connect the two rows of the plate bodies 41Fc.

Further, in the container carrying device 42F of the modified example 1, the movement of the container 15 is different from that of the embodiment 1, but the details thereof will be described later.

Hereinafter, with reference to FIGS. 22 to 32, regarding the carrying of the bagged culture medium block 14F of the modified example 1 into the container 15, the processes after the operation of the folding means 34 for the bagged culture medium block 14F is completed will be described.

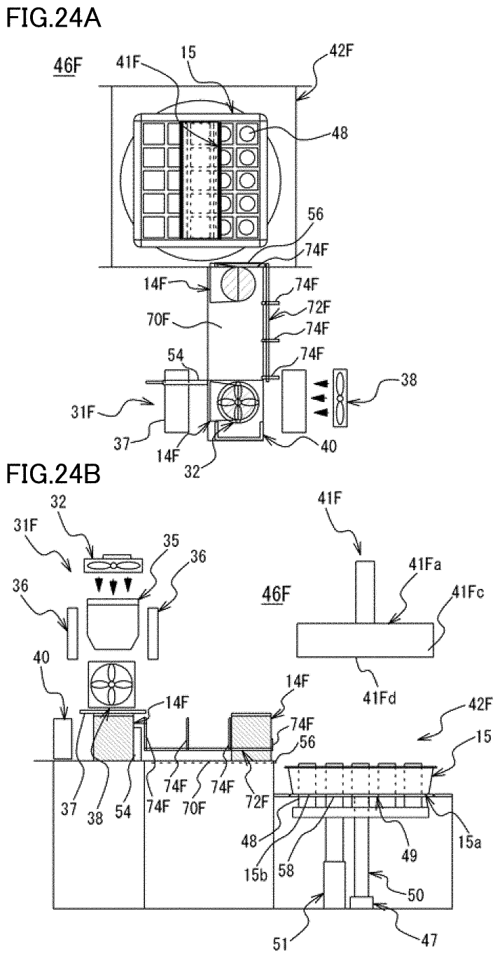

First, as shown in FIG. 24, in the folding device 31F of the modified example 1, the bagged culture medium block 14F folded by the folding means 34 is aligned in the alignment section 70F. That is, after the bagged culture medium block 14F is folded at the position positioned by the regulating member 54, the bagged culture medium block 14F is fed to the alignment section 70F.

Here, in the alignment member 72F provided in the alignment section 70F, the separating means 74F on the farthest side that is farthest from the folding means 34, that is, on the side closest to the container 15, is closed, and the other separating means 74F are in the opened state. Therefore, the bagged culture medium block 14F in which the unfilled portion 11Fh is folded is fed so as to be in contact with or close to the separating means 74F on the farthest side in the alignment section 70F and aligned. The second feeding means 40 for feeding the bagged culture medium block 14F to the alignment section 70F may push the bagged culture medium block 14F with an arm-shaped member, or a belt conveyor or the like may be used. Further, the elevating mechanism 51 of the container carrying device 42F was moved upward and is arranged below the position of the underlay member 56.

In addition, in FIGS. 22 and 23, the transporting means 60 and the folding device 31F are arranged at a substantially right angle, but the present invention is not limited to this configuration, and the transporting means 60 and the folding device 31F may be arranged so as to be substantially linear (see FIG. 19).

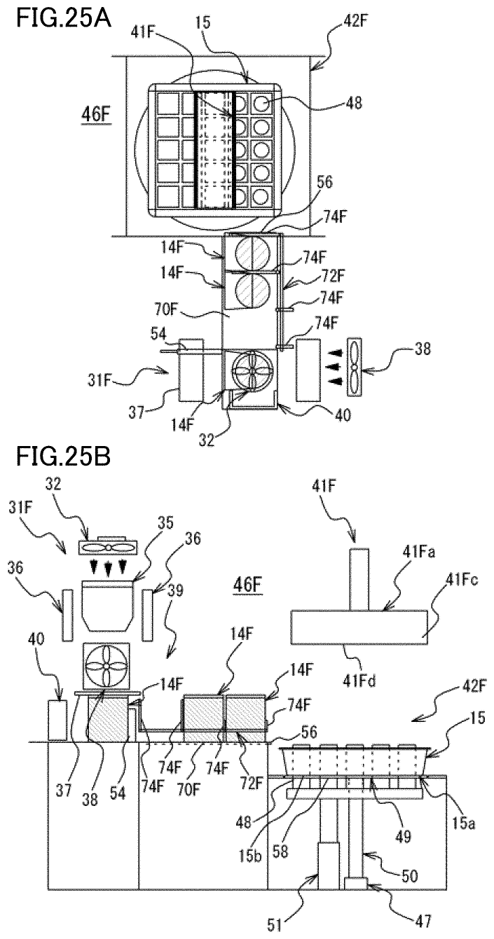

Next, as shown in FIGS. 25A and 25B, the second bagged culture medium block 14F newly folded by the folding means 34 is fed to the alignment section 70F. Here, in the alignment member 72F provided in the alignment section 70F, the separating means 74F on the second side from the back farthest from the folding means 34, that is, the separating means 74F next to the bagged culture medium block 14F previously aligned in the alignment section 70F is closed. Then, the bagged culture medium block 14F in which the unfilled portion 11Fh is folded is fed to a position where the bagged culture medium block 14F is brought into contact with or close to the second separating means 74F, and is aligned.

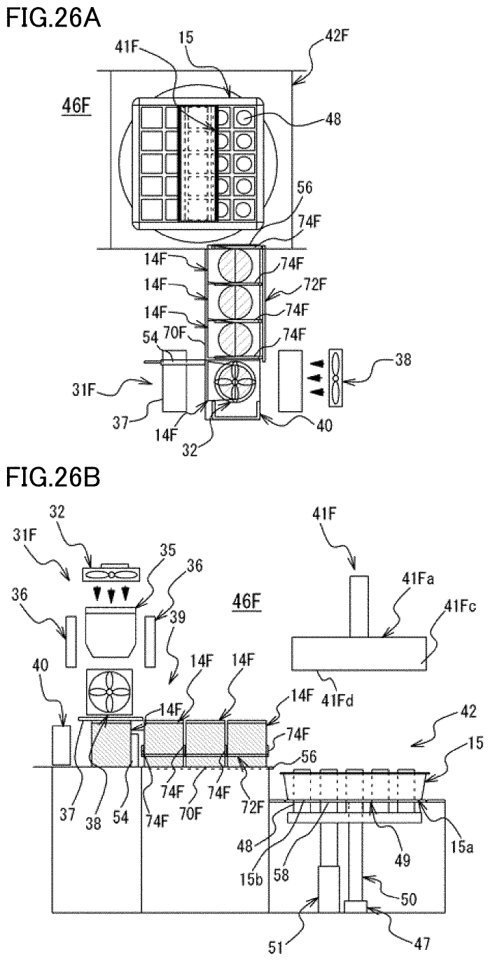

Next, as shown in FIGS. 26A and 26B, the third bagged culture medium block 14F newly folded by the folding means 34 is fed to the alignment section 70F. Here, in the alignment member 72F provided in the alignment section 70F, the separating means 74F on the third side from the back farthest from the folding means 34, that is, the separating means 74F next to the second bagged culture medium block 14F previously aligned in the alignment section 70F is closed.

Then, the bagged culture medium block 14F in which the unfilled portion 11Fh is folded is fed to a position where the bagged culture medium block 14F is brought into contact with or is close to the third separating means 74F, and is aligned. Further, after the three bagged culture medium blocks 14F are arranged in the alignment section 70F, the separating means 74F on the folding means 34 side is closed.

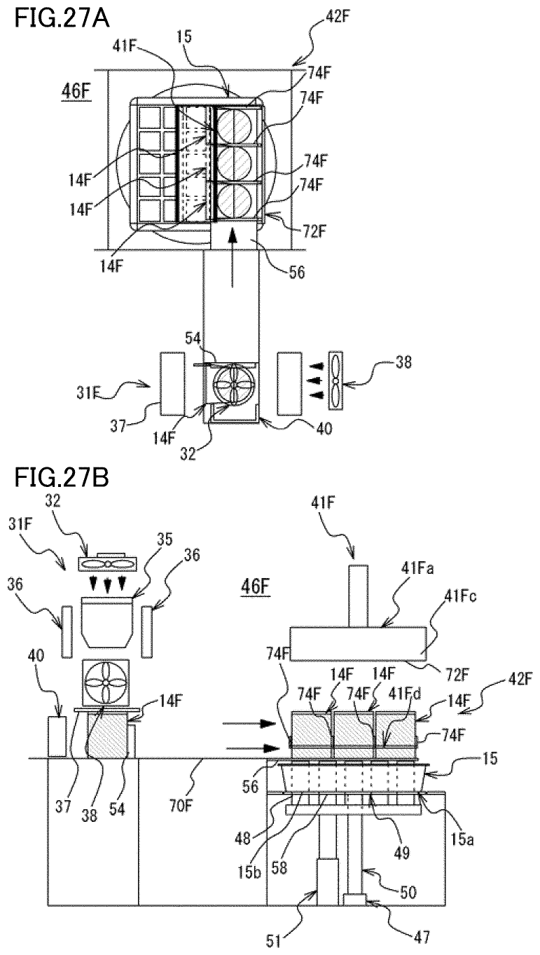

Next, as shown in FIGS. 27A and 27B, the alignment member 72F is moved so that each bagged culture medium block 14F aligned in the alignment section 70F is moved from the alignment section 70F onto the underlay member 56. Here, in a case where a belt conveyor is used, the belt conveyor may be operated.

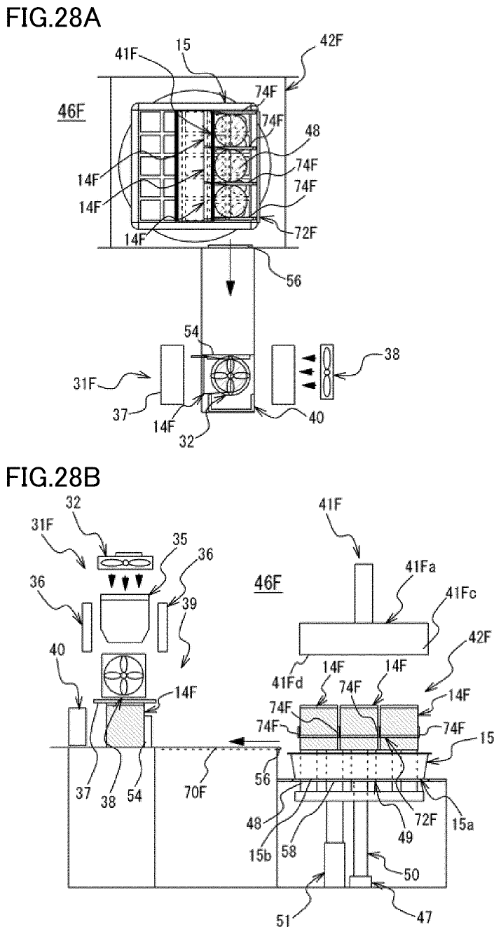

After that, as shown in FIGS. 28A and 28B, the underlay member 56 is pulled back. Here, each bagged culture medium block 14F is caught by each separating means 74F of the alignment member 72F, so that the bagged culture medium blocks 14F stay in places against the movement of the underlay member 56. Then, since the underlay member 56 is removed, each bagged culture medium block 14F is placed on the upper portions of the rod-shaped bodies 48.

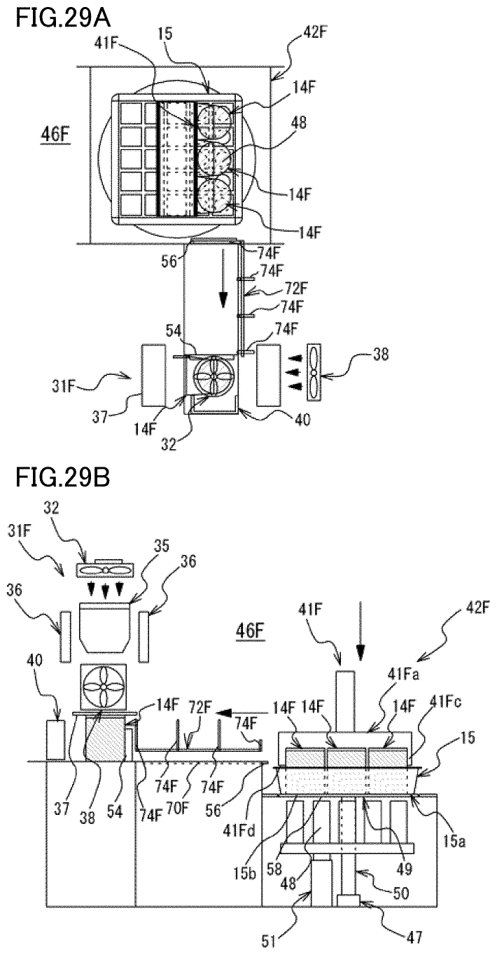

Next, as shown in FIGS. 29A and 29B, the elevating mechanism 51 is moved downward and the rod-shaped bodies 48 are lowered, so that each bagged culture medium block 14F on the rod-shaped bodies 48 is stored in the container 15. Further, the folding-in member 41Fa of the folding-in means 41F, which is arranged above each bagged culture medium block 14F, is moved downward, and the unfilled portion 11Fh of each bagged culture medium block 14F is folded-in. Here, each bagged culture medium blocks 14F is shaped into a block shape. The detail of the storing the bagged culture medium block 14F from the underlay member 56 into the container 15 is the same as that in the embodiment 1.

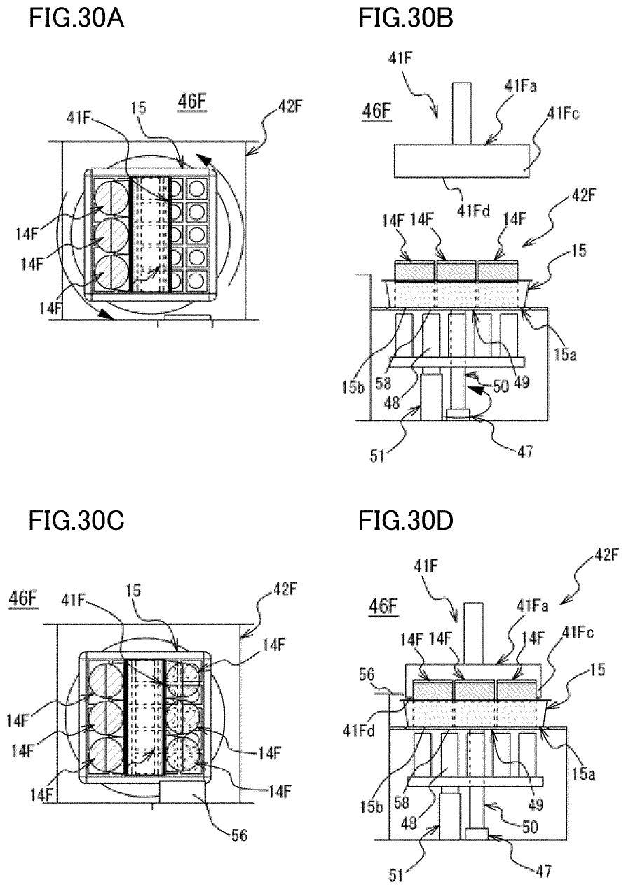

Next, as shown in FIGS. 30A and 30B, after the folding-in member 41Fa of the folding-in means 41F is moved upward, the rotating member 49 of the rotating mechanism 47 of the container carrying device 42 is rotated by about 180 degrees. Here, the plurality of (three in the modified example 1) the previously stored bagged culture medium blocks 14F are arranged on the opposite side, that is, at positions away from the movement direction of the underlay member 56 and the folding means 34. The folded unfilled portion 11Fh of each bagged culture medium block 14F faces the center side of the container 15.

Next, as shown in FIGS. 30C and 30D, the above-described processes shown in FIGS. 24 to 29 are performed, and the three bagged culture medium blocks 14F are stored in the container 15 again. Then, the folding-in member 41Fa of the folding-in means 41F is moved downward again to fold-in the unfilled portion 11Fh of each newly stored bagged culture medium block 14F. Here, since the folding-in member 41Fa of the folding-in means 41F is formed in two rows, the unfilled portion 11Fh of each bagged culture medium block 14F previously stored is also folded-in again. Therefore, the bagged culture medium blocks 14F are arranged side by side on both ends of the container 15, and the bagged culture medium blocks 14F are not stored in the central portion of the container 15.

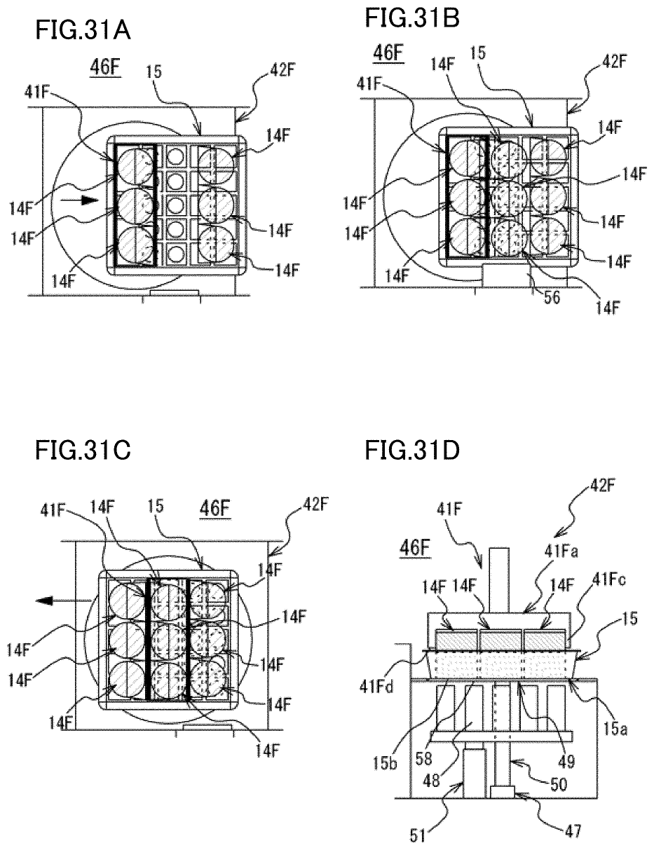

Next, as shown in FIG. 31A, after the folding-in member 41Fa of the folding-in means 41F is moved upward, the container 15 is moved in the container carrying device 42F. The container 15 is moved such that the row of the central portion in which the bagged culture medium block 14F is not stored is substantially in line with the underlay member 56, that is, in line with the moving direction of the newly fed bagged culture medium blocks 14F. The folding-in member 41Fa of the folding-in means 41F remains in its original position without being moved.

Then, as shown in FIG. 31B, the processes shown in FIGS. 24 to 29 are repeated to align the three bagged culture medium blocks 14F in the central portion of the container 15.

Next, as shown in FIGS. 31C and 31D, after the container 15 is moved to the original position by the container carrying device 42F, the folding-in member 41Fa of the folding-in means 41F is moved downward. Then, the unfilled portions 11Fh of the stored bagged culture medium blocks 14F stored at the central portion of the container 15 is folded-in, and the previously stored bagged culture medium blocks 14F on both ends are folded-in again. Here, the unfilled portions 11Fh of the bagged culture medium blocks 14F are arranged so that any of the unfilled portions 11Fh do not face the outside of the container 15, that is, the unfilled portions 11Fh face inward. Therefore, it is possible to prevent the bag mouth 11Ff of the unfilled portion 11Fh of the bagged culture medium block 14F from being open in the container 15.

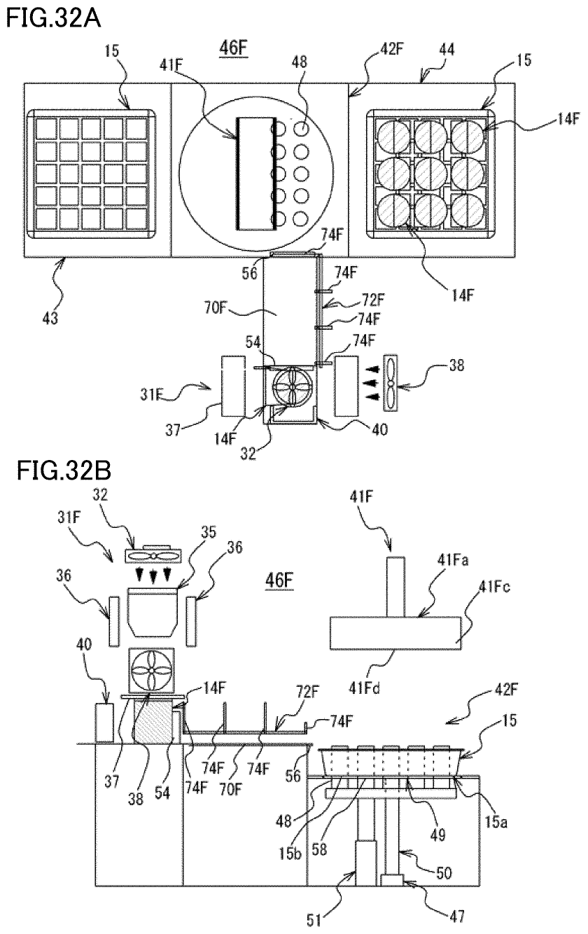

After that, as shown in FIGS. 32A and 32B, the container 15 storing the nine bagged culture medium blocks 14F is fed to the next process (sterilization process) by the container transporting means 44, and a new container 15 is set by the container setting means 43, and these processes are repeated.

This completes the processes of the bagged culture medium block 14 from the operation in the folding means 34 of the folding device 31F to the storage in the container 15 in the modified example 1.

In the embodiment 1 and the modified example 1, the case where the number of rod-shaped bodies 48 of the elevating mechanism 51 of the container carrying devices 42 and 42F corresponds to the number of the bagged culture medium blocks 14 that are to be stored is described. However, the present invention is not limited to this configuration, and by adopting the configuration in which each rod-shaped body can be raised and lowered independently, arbitrary number of the rod-shaped bodies may be provided and the rod-shaped bodies at necessary positions may be raised and lowered. Here, the number of gaps in the container may be changed according to the number of rod-shaped bodies of the elevating mechanism 51, and conversely, the number of rod-shaped bodies may be changed according to the number of gaps in the container.

Further, although the description of the opening assist member 39 is omitted in the modified example 1, the opening assist member 39 may be provided in the folding device 31F as in the embodiment 1.

Further, in the folding device 31 of the embodiment 1, a space such as the alignment section 70F as shown in the modified example 1 may be provided between the folding means 34 of the folding device 31 and the container carrying device 42.

### Modified Example 2

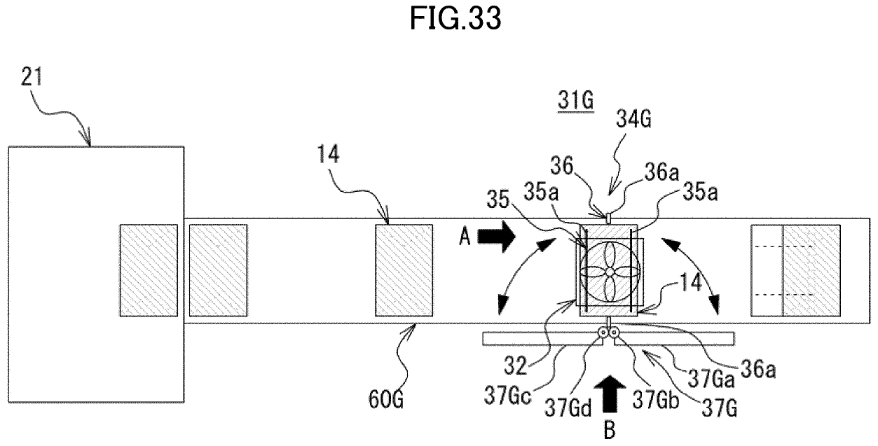

Next, a folding device 31G according to the modified example 2 will be described with reference to FIGS. 33 to 36. The same reference numerals are given to the configurations common to those in the embodiment 1, and detailed description thereof will be omitted.

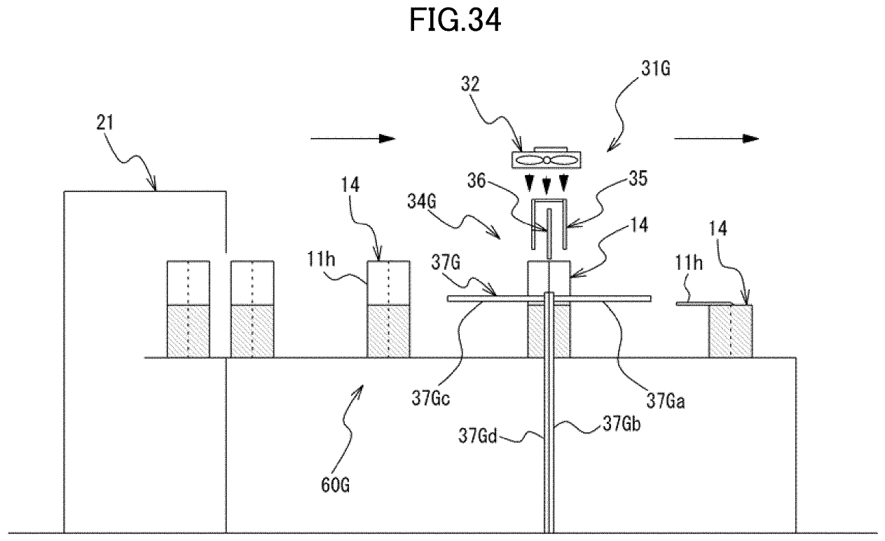

As shown in FIGS. 33 and 34, the folding device 31G according to the modified example 2 has a folding means 34G for folding the bagged culture medium block 14 transported by transporting means 60G. The folding device 31G in the modified example 2 is a device in which the unfilled portion 11h of the bagged culture medium block 14 is folded so as to be substantially parallel to the culture medium 12.

Further, the bagged culture medium block 14 transported by the transporting means 60G of the modified example 2 has a different orientation from that in the embodiment 1 in transportation, and the wide side surfaces 11b and 11c of the bagged culture medium block 14 face the upstream side or the downstream side in the transport direction when transported.

As shown in FIGS. 33 and 34, the folding device 31G of the modified example 2 is composed of the opening mechanism 32, the supporting mechanism 35, the pushing mechanism 36 and a pressing mechanism 37G which are provided at a place where the bagged culture medium block 14 is folded.

Further, in the folding device 31G of the modified example 2, after the transporting means 60G stops the bagged culture medium block 14 at a position, at which the folding operation is to be performed by the folding means 34G, the folding operation is performed, and the unfilled portion 11h of the bagged culture medium block 14 is pressed by the final pressing mechanism 37G. After that, the moving operation by the transporting means 60G is performed, and the bagged culture medium block 14 is transported in a state where the unfilled portion 11h is pressed, so that the folding operation of the pressed unfilled portion 11h is performed in accordance with this transportation.

The opening mechanism 32, the supporting mechanism 35 and the pushing mechanism 36 have substantially the same configuration as those in the embodiment 1. That is, as shown in FIGS. 33, 34, 35A and 35B, the opening mechanism 32 blows air from above the positioned bagged culture medium block 14, that is, from the bag mouth 11f side, for example, using the blower 32a or the like, so that the bag mouth 11f is kept open (see FIGS. 6C and 6D). In the modified example 2, as in the embodiment 1, in addition to the opening mechanism 32, the other opening means 62 including a blower or the like may be provided before the folding device 31G.

As shown in FIGS. 33, 34, 35A and 35B, the supporting mechanism 35 is composed of the supporting members 35a that is a pair of plates of a predetermined size, which is to be inserted into the unfilled portion 11h from the opened bag mouth 11f of the bagged culture medium block 14. In the modified example 2, these supporting members 35a are not arranged along the short side surfaces 11d and 11e of the bagged culture medium block 14 on which the gusset folding lines are formed, but along the longitudinal side surfaces 11b and 11c so as to face each other. That is, each supporting member 35a is arranged in a direction orthogonal to the feeding direction of the bagged culture medium block 14.

Further, each supporting member 35a is connected to each other via, for example, the beam member 35b or the like, and is configured so that they can be repeatedly moved at the same time in a direction in which they approach each other and a direction in which they are separated from each other. Further, the supporting member 35a may be composed of a plurality of plate-shaped pieces or rod-shaped bodies instead of a single plate-shaped body. In a case where the supporting member 35a is composed of a plurality of plate-shaped pieces, rod-shaped bodies or the like, they are provided at least on the four corner sides of the bag mouth 11f of the bagged culture medium block 14. The supporting member may be inclined or curved on the tip side, that is, the side that is first inserted into the bag mouth 11f, so that the supporting member can be easily inserted from the bag mouth 11f of the bagged culture medium block 14.

As shown in FIGS. 33, 34, 35A and 35B, the pushing mechanism 36 is composed of a pair of plate-shaped pushing members 36a that face each other with the bagged culture medium block 14 being therebetween, is arranged on the side of the short side surfaces 11d and 11e with the creases of the bagged culture medium block 14, and is configured to be repeatedly moved with respect to the bagged culture medium block 14. The pushing members 36a are arranged on the side orthogonal to the transport direction of the bagged culture medium block 14 with the bagged culture medium block 14 being therebetween. The pushing member is not limited to a plate shape, but may be a rod shape.

The pressing mechanism 37G in the modified example 2 has a configuration different from that in the embodiment 1. As shown in FIGS. 33, 34, 35A and 35B, the pressing mechanism 37G of the modified example 2 is composed of a downstream side pressing member 37Ga, which presses the unfilled portion 11h of the bagged culture medium block 14 on the downstream side in the transport direction of the bagged culture medium block 14, downstream side rotation means 37Gb, which rotationally moves the downstream side pressing member 37Ga, an upstream side pressing member 37Gc, which presses the unfilled portion 11h of the bagged culture medium block 14 on the upstream side in the transport direction of the bagged culture medium block 14, and upstream side rotation means 37Gd, which rotationally moves the upstream side pressing member 37Gc. Further, around the downstream side rotation means 37Gb and the upstream side rotation means 37Gd, the downstream side pressing member 37Ga and the upstream side pressing member 37Gc are moved to open and close, respectively.

Here, the pressing mechanism 37G is moved from the side of the longitudinal side surfaces 11b and 11c of the unfilled portion 11h of the bagged culture medium block 14 to the substantially central portion by the supporting mechanism 35 and the pushing mechanism 36 described above. Then, by clamping the portion close to the culture medium 12 of the unfilled portion 11h of the bagged culture medium block 14 with the downstream side pressing member 37Ga and the upstream side pressing member 37Gc, the culture medium 12 side of the unfilled portion 11h can be clamped and pressed.

Further, since the transporting operation by the transporting means 60G is performed in a state where the unfilled portion 11h is pressed by the downstream side pressing member 37Ga and the upstream side pressing member 37Gc of the pressing mechanism 37G, the unfilled portion 11h is tilted to the upstream side in the transport direction. Details of this operation will be described later.

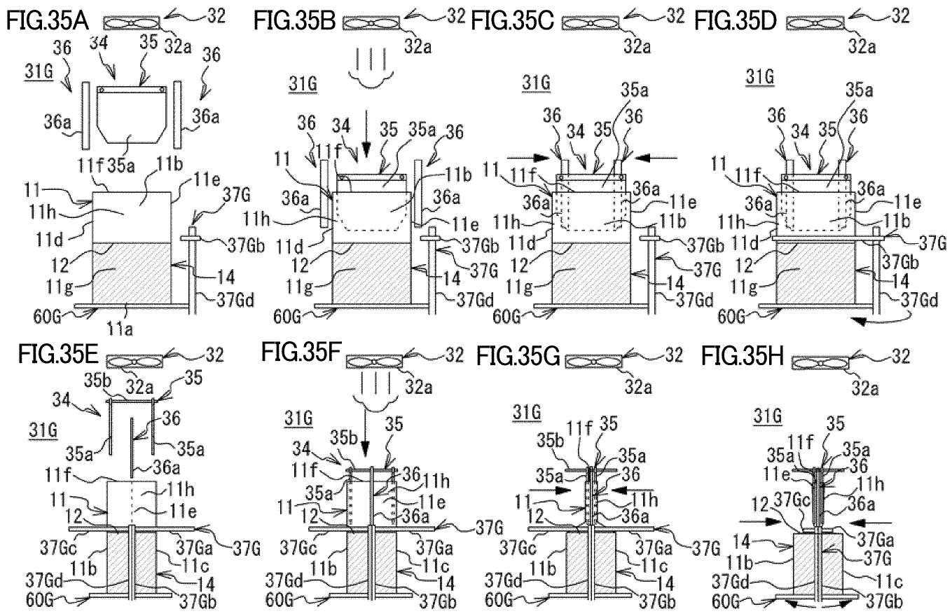

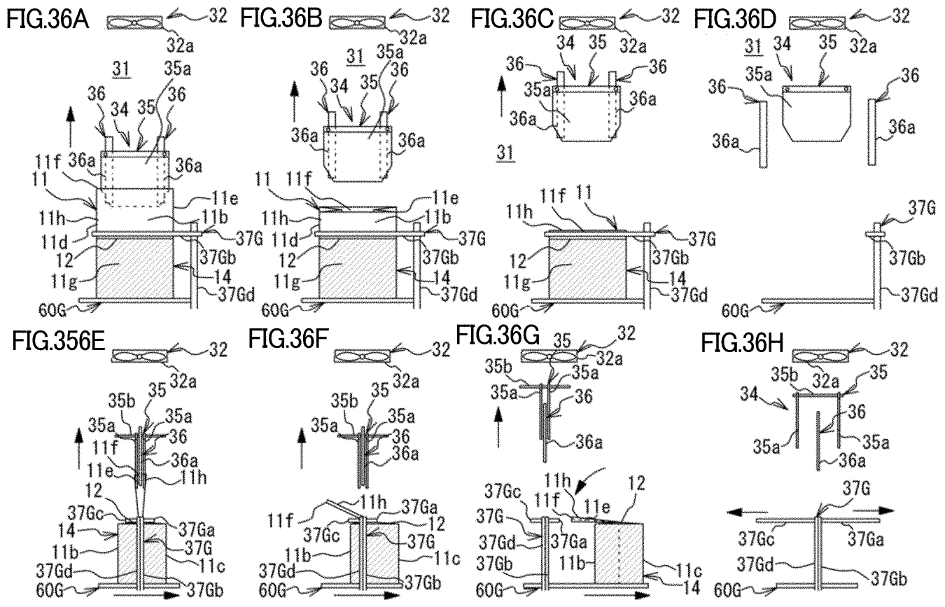

Next, with reference to FIGS. 35 and 36, the folding operation of the bagged culture medium block 14 by the folding device 31G in the modified example 2 will be described. The bagged culture medium block 14 that is to be transported to the folding device 31G in the modified example 2 is transported in a state in which the culture medium 12 is filled in the bag body 11 by the block forming device 21 (see FIG. 1 and the like) as shown in the embodiment 1. Further, FIG. 35A is a view seen from the A side of FIG. 33, FIG. 35B is a view seen from the B side of FIG. 33, and hereinafter figures are shown in this manner.

First, as shown in FIGS. 35A and 35B, the bagged culture medium block 14 in which the bagged body 11 is filled with the culture medium 12 is transported by the transporting means 60G in a state where the wide side surfaces 11b and 11c of the bagged culture medium block 14 face the upstream side and the downstream side, and the bagged culture medium block 14 is arranged at a position where the folding operation by the folding device 31G is performed (see FIGS. 33 and 34). Here, regarding a method of arranging the bagged culture medium block 14 at the position where the folding operation by the folding device 31G is performed, the transporting means 60G may stop the bagged culture medium block 14 at a predetermined position, or a regulating member for regulating the movement of the bagged culture medium block 14 may be provided on the transporting means 60G to stop the movement of the bagged culture medium block 14.

Regarding the folding of the unfilled portion 11h of the bagged culture medium block 14, as shown in FIGS. 35C and 35D, the blower 32a as the opening mechanism 32 first blows air toward the bag mouth 11f of the bagged culture medium block 14 from above the bag mouth 11f to keep the bag mouth 11f of the bagged culture medium block 14 open (see FIGS. 6C and 6D). Regarding the bagged culture medium block 14, by providing the other opening means 62 for blowing air before the bagged culture medium block 14 is moved to the folding means 34, the bag mouth 11f is more easily opened. Further, together with the operation of the opening mechanism 32, each supporting member 35a of the supporting mechanism 35 and the pushing members 36a of the pushing mechanism 36 are moved downward from above the bag mouth 11f of the bagged culture medium block 14, and among them, each supporting member 35a is inserted into the unfilled portion 11h from the opened bag mouth 11f of the bagged culture medium block 14. Each supporting member 35a is arranged along the longitudinal side surfaces 11b and 11c of the bagged culture medium block 14. Here, since each supporting member 35a is inserted into the unfilled portion 11h of the bagged culture medium block 14 while the blower 32a of the opening mechanism 32 blows air to keep the bag mouth 11f open, each supporting member 35a can be easily inserted.

Next, after each supporting member 35a is inserted into the unfilled portion 11h, the pushing mechanism 36 is moved toward the bagged culture medium block 14 as shown in FIGS. 35E and 35F. In the pushing mechanism 36, the pair of the pushing members 36a is moved from the short side surfaces 11d and 11e of the bagged culture medium block 14 so as to push the short side surfaces 11d and 11e of the unfilled portion 11h of the bagged culture medium block 14. Then, each of the short side surfaces 11d and 11e of the unfilled portion 11h of the bagged culture medium block 14 is pushed by each pushing members 36a so that the short side surfaces 11d and 11e are pushed along the creases, and each of the longitudinal side surfaces 11b and 11c of the bagged culture medium block 14 is moved toward the center side to close the bag mouth 11f.

Here, each supporting member 35a of the supporting mechanism 35 is moved to the center side in accordance with the movement of the longitudinal side surfaces 11b and 11c, and, as shown in FIG. 35F, each supporting member 35a is collected in the central portion together with the unfilled portion 11h of the bagged culture medium block 14. When the unfilled portion 11h of the bagged culture medium block 14 is collected on the center side, the boundary between the unfilled portion 11h and the filled portion 11g, that is, the unfilled portion 11h on the upper surface side of the culture medium 12, is not flat, that is, not substantially parallel to the upper surface of the culture medium 12, and for example, the central portion may be in a convex shape or distorted (see FIG. 35F).

Next, after each supporting member 35a of the supporting mechanism 35 and each pushing member 36a of the pushing mechanism 36 are collected together with the unfilled portion 11h in the central portion and the opposing supporting members 35a are in close proximity to each other, as shown in FIGS. 35G and 35H, the pressing mechanism 37G presses the upper surface side of the culture medium 12 of the unfilled portion 11h of the bagged culture medium block 14. Here, the pressing mechanism 37G is operated by moving the downstream side pressing member 37Ga and the upstream side pressing member 37Gc with the downstream side rotation means 37Gb and the upstream side rotation means 37Gd to clamp the unfilled portion 11h of the bagged culture medium block 14. Then, the unfilled portion 11h of the bagged culture medium block 14 is in a state in which the portion close to the culture medium 12 is pressed by the downstream side pressing member 37Ga and the upstream side pressing member 37Gc.

Next, as shown in FIGS. 36A and 36B, each supporting member 35a of the supporting mechanism 35 and each pushing member 36a of the pushing mechanism 36 are moved upward, and the transporting operation of the transporting means 60G is started to move the bagged culture medium block 14. Here, since the unfilled portion 11h of the bagged culture medium block 14 is clamped with the downstream side pressing member 37Ga and the upstream side pressing member 37Gc of the pressing mechanism 37G, as shown in FIGS. 36C and 36D, the unfilled portion 11h is tilted down according to the movement of the bagged culture medium block 14.

When the bagged culture medium block 14 is transported, it is preferable that the bagged culture medium block 14 is transported in a state where at least each supporting member 35a of the supporting mechanism 35 or each pushing member 36a of the pushing mechanism 36 is in the unfilled portion 11h of the bagged culture medium block 14. In this way, it is possible to suppress the defect of the folding of the unfilled portion 11h. This is because the upper portion on the bag mouth 11f side of the unfilled portion 11h being tilted down is temporarily supported, so that the unfilled portion 11h is tilted down gradually from the lower side, that is, the side close to the culture medium 12.

Next, as shown in FIGS. 36E and 36F, after the unfilled portion 11h of the bagged culture medium block 14 is tilted down, the downstream side pressing member 37Ga and the upstream side pressing member 37Gc of the pressing mechanism 37G that pressed the unfilled portion 11h are moved away from the unfilled portion 11h. Similarly, the supporting mechanism 35 and the pushing mechanism 36 are also moved away from the unfilled portion 11h.

After that, as shown in FIGS. 36G and 36H, the supporting mechanism 35 and the pushing mechanism 36 are moved to their original positions, and similarly, the downstream side pressing member 37Ga and the upstream side pressing member 37Gc of the pressing mechanism 37G are moved to be opened so as to be arranged for folding the next bagged culture medium block 14.

This completes the operation of the folding device 31G of the modified example 2. The folded bagged culture medium block 14 may be carried into the container 15 by, for example, connecting the above-mentioned container carrying device 42 to the transporting means 60G, or may be manually carried into the container.

The folding device 31G in the modified example 2 may be also provided with the opening assist member 39 for partially restricting the expansion of the bag mouth 11f of the bagged culture medium block 14 when the opening mechanism 32 is operated as in the embodiment 1.

### Modified Example 3

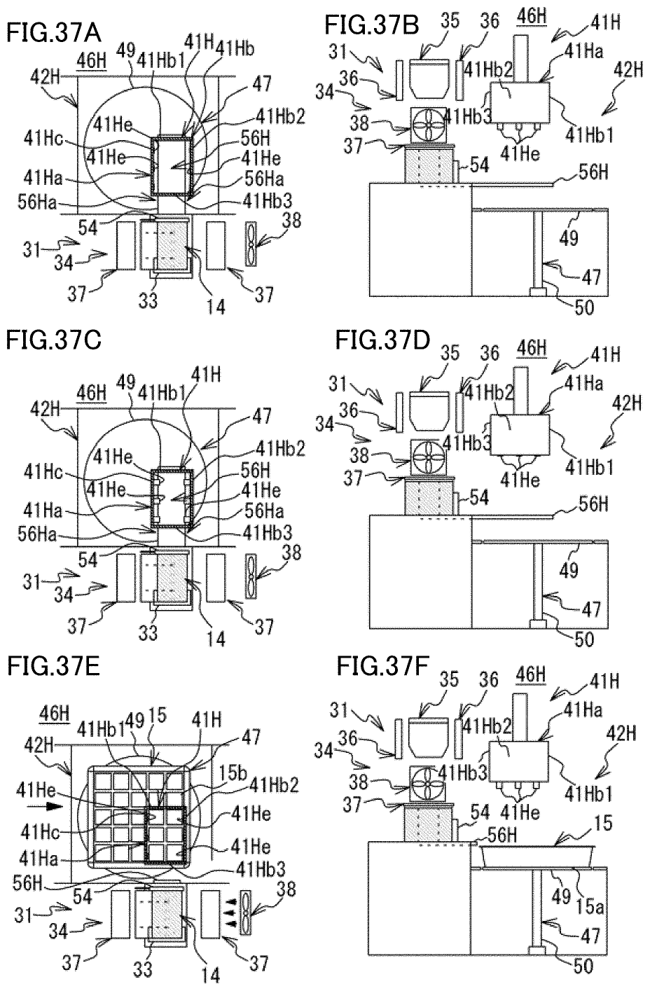

Next, with reference to FIGS. 37 to 41, a container carrying device 42H related to a containerization device 46H according to the modified example 3 will be described. The container carrying device 42H according to the modified example 3 is different from the container carrying device 42 shown in the embodiment 1 in the method of storing the bagged culture medium block 14 in the container 15. Since, the processes up to the folding operation of the unfilled portion 11h of the bagged culture medium block 14 are common to those in the embodiment 1, the same reference numerals are given to the configurations common to those in the embodiment 1, and detailed description thereof will be omitted.

Further, in the containerization device 46H of the modified example 3, the configuration from the completion of the folding operation of the bagged culture medium block 14 by the folding means 34 in the folding device 31 to the container carrying device 42H in which the bagged culture medium block 14 is carried into the container 15 is different. Therefore, the description will be given regarding the processes after the completion of the common folding operation of the unfilled portion 11h of the bagged culture medium block 14 by the folding device 31. In FIGS. 37 to 41, the opening assist member 39 is omitted.

In the carrying of the bagged culture medium block 14 into the container 15 in the container carrying device 42H of the modified example 3, the configurations different from those in the embodiment 1 are mainly the configuration of an underlay member 56H provided in the folding device 31 and the configuration of the folding-in member 41a that constitutes folding-in means 41H. Further, the configuration, in which the rod-shaped bodies 48 and the elevating mechanism 51 for raising and lowering the rod-shaped bodies 48 provided in the container carrying device 42 of the embodiment 1 are omitted, is also different.

As shown in FIGS. 37A, 37C and 37E, the underlay member 56H relating to the container carrying device 42H in the modified example 3 is, compared with the underlay member 56 of the container carrying device 42 provided in the embodiment 1, provided with notch portions 56Ha, in which both sides along the direction of the repeated movement of the underlay member 56H are notched, so that the width of the central portion of the underlay member 56H is narrower than that of the underlay member 56 of the embodiment 1. This width is formed so that movable claw members 41He, which are provided on side walls 41Hb2 and 41Hc of a folding-in member 41Ha provided in the folding-in means 41H (described later), can be moved through the notch portion 56Ha and the bagged culture medium block 14 can be mounted on the underlay member 56. Here, the bagged culture medium block 14 placed on the underlay member 56H of the modified example 3 is placed so as to partially exist on the notch portion 56Ha. The underlay member 56H of the modified example 3 is also arranged on the folding device 31 side, and is configured to be movable so as to be taken in and out of the container carrying device 42 side.

As shown in FIGS. 37A to 37D, the folding-in member 41Ha of the folding-in means 41H in the modified example 3 has a tubular body having a size that allows the bagged culture medium block 14 to be inserted and composed of each side wall 41Hb1, 41Hb2, 41Hb3 and 41Hc like the folding-in member 41a of the folding-in means 41 of the embodiment 1. Here, one of the side walls is the folding-in side wall 41Hc as in the embodiment 1.

Further, in the folding-in member 41Ha according to the modified example 3, among the side walls, on the lower side of the side walls 41Hb2 and 41Hc arranged on the side of the wide side surfaces 11b and 11c of the bagged culture medium block 14, that is, on the side close to the underlay member 56H, a plurality of the movable claw members 41He are provided. The movable claw members 41He are portions on which the bagged culture medium block 14 is placed from the folding device 31 for lifting the bagged culture medium block 14 when the bagged culture medium block 14 is carried into the container 15. The movable claw members 41He are configured to be repeatedly moved between the position for supporting the bottom surface 11a side of the bagged culture medium block 14 in which the unfilled portion 11h is folded and the position for releasing the support of the bagged culture medium block 14, that is, between the direction substantially parallel to the bottom surface 11a of the bagged culture medium block 14 and the direction away from the bottom surface 11a of the bagged culture medium block 14 (that is substantially orthogonal to the bottom surface 11a of the bagged culture medium block 14). The movable claw members 41He can be moved by using the power of a motor, a cylinder or the like.

Further, as shown in FIGS. 37E and 37F, the container 15 is conveyed to the container carrying device 42H as in the embodiment 1. Since this configuration is common to the container setting means 43 in the embodiment 1, detailed description thereof will be omitted.

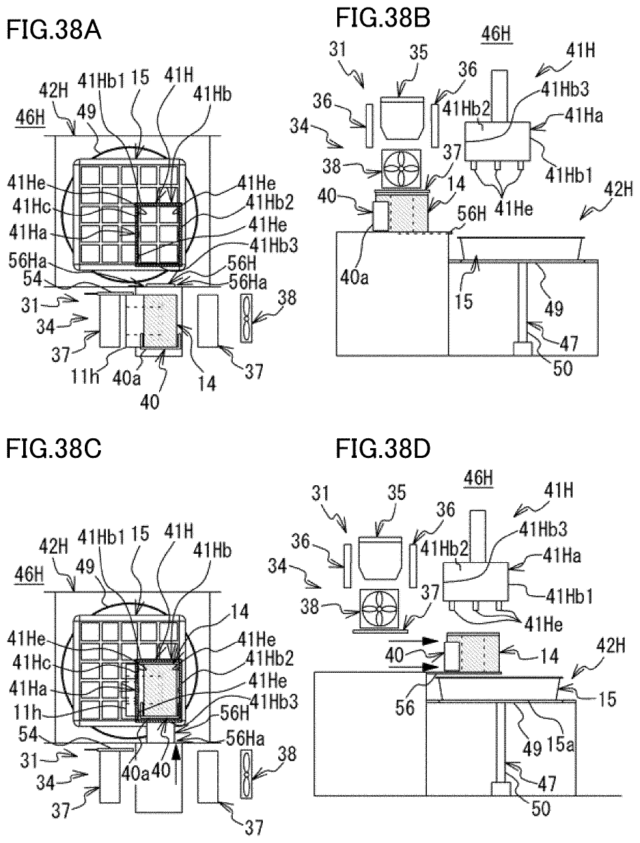

Next, in the containerization device 46H of the modified example 3, the process of carrying the bagged culture medium block 14, in which the unfilled portion 11h is folded, from the folding device 31 into the container 15 in the container carrying device 42H will be described with reference to FIGS. 38 to 41.

First, as shown in FIGS. 38A and 38B, the unfilled portion 11h of the bagged culture medium block 14 is folded by the folding device 31, as in the embodiment 1. Here, the container 15 in which the bagged culture medium block 14 is to be stored is arranged in the container carrying device 42. Further, each movable claw member 41He provided below the side walls 41Hb2 and 41Hc of the folding-in means 41H is arranged so as to be along, that is parallel to, each side wall 41Hb2 and 41Hc.

Next, as shown in FIGS. 38C and 38D, the bagged culture medium block 14 is moved by the second feeding means 40, and the underlay member 56H, which is taken in and out from the folding device 31 in the direction to the container carrying device 42H, is protruded, and the bagged culture medium block 14 is placed on this protruded underlay member 56H and moved onto the container 15.

Here, the underlay member 56H in the modified example 3 is formed so that the width on the side orthogonal to the direction of repeated movement is narrower than that of the underlay member 56 in the embodiment 1, but the underlay member 56H has a size that is large enough for the bagged culture medium block 14 to be placed. Further, when the bagged culture medium block 14 is placed on the underlay member 56H, the bagged culture medium block 14 is placed in a state where a part of the wide side surfaces 11b and 11c of the bagged culture medium block 14 exists on the notch portion 56Ha of the underlay member 56H.

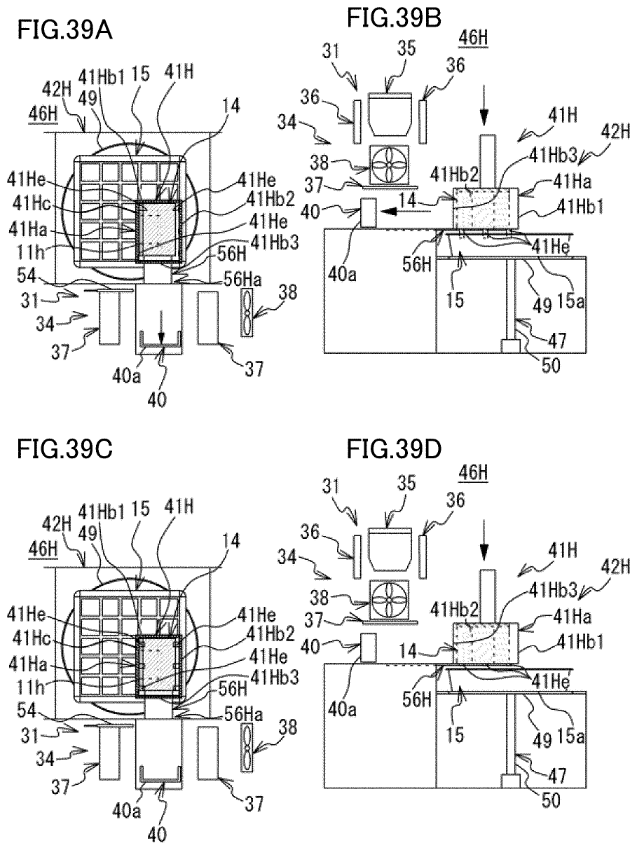

Next, as shown in FIGS. 39A and 39B, the second feeding means 40 is pulled back and placed at a predetermined position in the folding means 34, and the folding-in means 41H is moved downward, and the bagged culture medium block 14 is surrounded by the folding-in member 41a. Here, the unfilled portion 11h of the bagged culture medium block 14 is folded-in by the folding-in side wall 41Hc of the folding-in means 41H so that the bag mouth 11f faces downward, that is, toward the container 15 (see FIGS. 13A to 13D). Here, the second feeding means 40 is moved to a position away from the moving direction of the bagged culture medium block 14 so that the next bagged culture medium block 14 can be sent to the folding means 34, and after the bagged culture medium block 14 is arranged in the folding means 34, the second feeding means 40 is moved to a position where the second feeding means 40 can push the bagged culture medium block 14.

After that, as shown in FIGS. 39C and 39D, the movable claw members 41He provided at lower portions of the side walls 41Hb2 and 41Hc that are arranged, in the folding-in means 41H, on the side of the wide side surfaces 11b and 11c of the bagged culture medium block 14 (in other words, provided on the bottom on the underlay member 56H side in the folding-in means 41H) are operated, so that the movable claw members 41He are moved from positions substantially parallel to each side wall 41Hb2 and 41Hc in a direction substantially orthogonal to each side wall 41Hb2 and 41Hc. Here, since the notch portions 56Ha are formed in the underlay member 56H, each movable claw member 41He is moved through each notch portion 56Ha, and is arranged at substantially the same height as the underlay member 56H or slightly below the underlay member 56H. Then, in this state, the bagged culture medium block 14 can be placed on the movable claw members 41He.

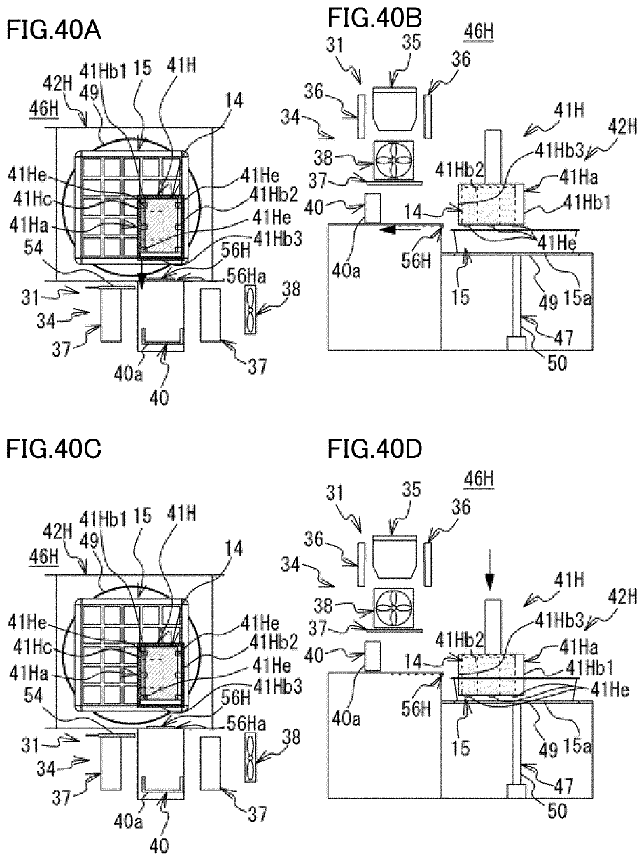

Next, as shown in FIGS. 40A and 40B, the underlay member 56 is pulled back in a state where the bagged culture medium block 14 is surrounded by the folding-in member 41a of the folding-in means 41H. Here, since the folding-in member 41a does not move, the bagged culture medium block 14 is stopped at the sent out position by the second feeding means 40, so that even when the underlay member 56 is moved, the bagged culture medium block 14 stays in place. Then, by moving the underlay member 56, the bagged culture medium block 14 is moved downward so as to be placed on the movable claw members 41He provided on the side walls 41Hb2 and 41Hc of the folding-in means 41H.

After that, as shown in FIGS. 40C and 40D, the folding-in means 41H is moved downward, and the bagged culture medium block 14 is arranged at a position where the bagged culture medium block 14 is stored in the container 15.

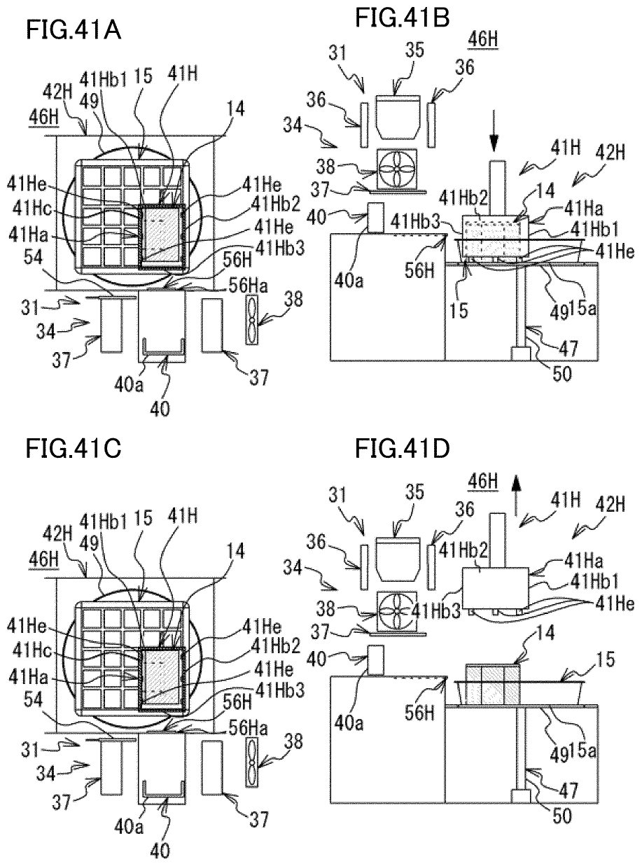

Next, as shown in FIGS. 41A and 41B, each movable claw member 41He provided on each side wall 41Hb2 and 41Hc of the folding-in means 41H is moved in a direction so as to be parallel to each side wall 41Hb2 and 41Hc, respectively, so that the bagged culture medium block 14 placed on each movable claw member 41He is moved into the container 15 and placed on the bottom portion 15a of the container 15.

After that, as shown in FIGS. 41C and 41D, each folding-in means 41H is raised and moved to the original position. As a result, the unfilled portion 11h of the bagged culture medium block 14 is folded-in and the bagged culture medium block 14 is carried into the container 15. This completes the carrying of one bagged culture medium block 14 into the container 15.

After that, as in the embodiment 1, the container 15 is rotated by the rotating mechanism 47, the four bagged culture medium blocks 14 are carried into the container 15, and after the completion of the carrying, the container 15 in which the bagged culture medium blocks 14 are stored is advanced to the next process.

In this way, by adopting the configuration of the container carrying device 42H in the modified example 3, the process of inserting the rod-shaped bodies 48 from below the container 15 can be omitted. Therefore, even in a case where it is difficult to insert the rod-shaped bodies 48, or various containers having different sizes are used, the bagged culture medium block 14 can be carried into the containers.

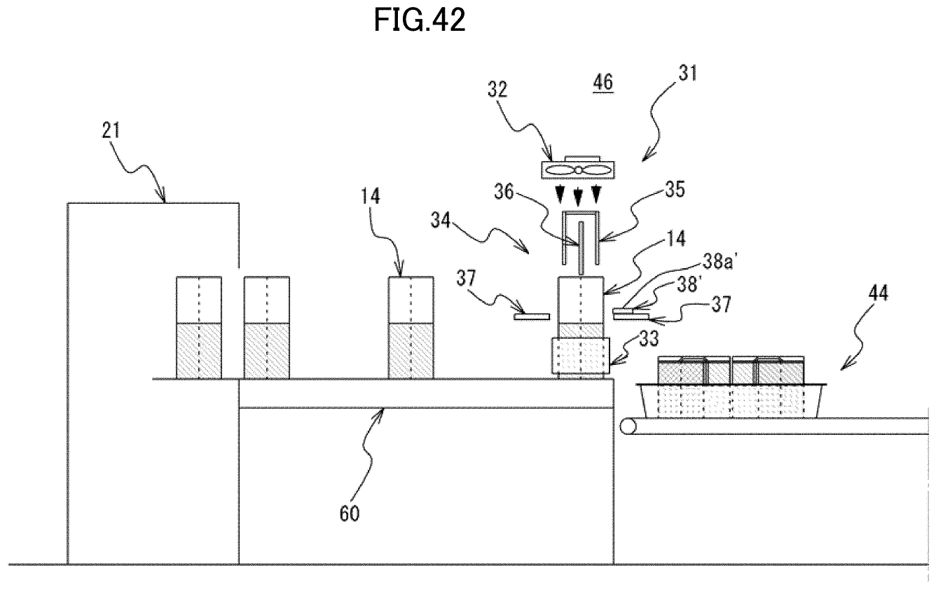

Here, in the folding device 31 according to the embodiment 1, the case where the blower 38a is used as the tilting mechanism 38 is shown, but the present invention is not limited to the use of the wind pressure of the blower or the like. For example, a tilting member 38a′ of the arm member in a rod-shaped body, a cuboid-shaped body, a plate-shaped body or the like similar to a tilting mechanism 38′ shown in FIG. 42 may be used and repeatedly moved to be brought into contact with the unfilled portion 11h of the bagged culture medium block 14 so that the unfilled portion 11h is tilted down.

Further, in the embodiment 1 and the like, in addition to the above-described case, the bagged culture medium block 14 can be carried from the folding device 31 to the container 15 of the container carrying device 42 by using a robot arm.

### Embodiment 2

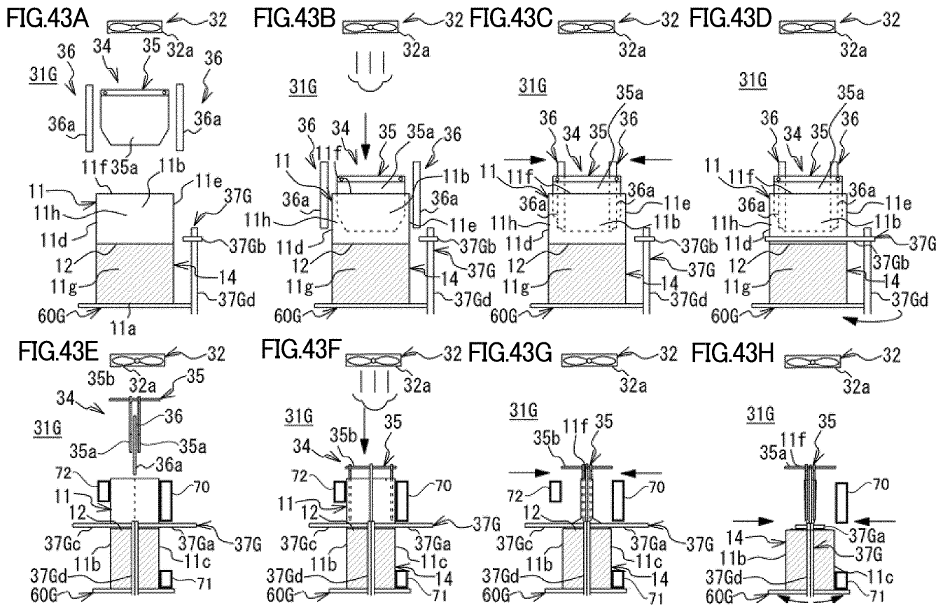

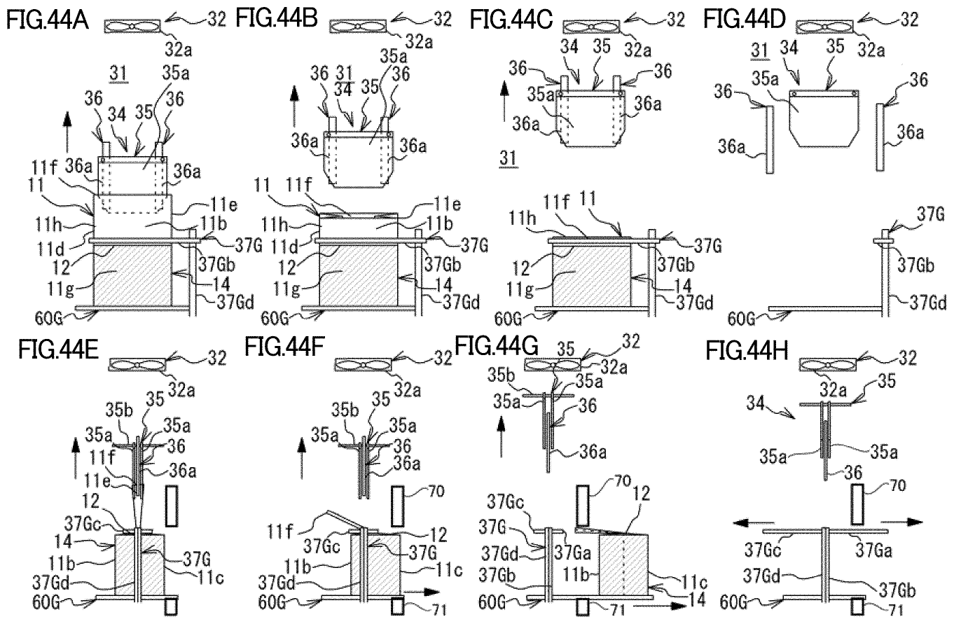

The folding device 31G according to the embodiment 2 will be described with reference to FIGS. 43 and 44. The folding device 31G according to the embodiment 2 is different form the folding device 31G (FIGS. 35 and 36) in the modified example 2 of the embodiment 1 in that the folding device 31G has a fixed bag mouth regulating member 70, a movable bag mouth regulating member 72 and a positioning block 71 as bag mouth expansion range adjusting means. The same reference numerals are used for the configurations common to those in FIGS. 35 and 36, and the description thereof will be omitted.

FIG. 43 are views illustrating processes of the folding means according to the embodiment 2, and FIGS. 43A, 43C, 43E and 43G are views seen from the traveling direction of the transporting means (A side of FIG. 33), and FIGS. 43B, 43D, 43F and 43H are views seen from the direction orthogonal to the traveling direction of the transporting means (B side of FIG. 33). Further, FIG. 44 are views illustrating processes following FIG. 43, and FIGS. 44A, 44C, 44E and 44G are views seen from the traveling direction of the transporting means (A side of FIG. 33), and FIGS. 44B, 44D, 44F and 44H are views seen from the direction orthogonal to the traveling direction of the transporting means (B side of FIG. 33). The bagged culture medium block is transported in the A direction by the transporting means so that the long side faces the traveling direction, as shown in FIG. 33.

As shown in FIGS. 43A and 43B, the bagged culture medium block transported by the transporting means is stopped at the position of the positioning block 71 and the fixed bag mouth regulating member 70. The fixed bag mouth regulating member 70 is, for example, a plate-shaped member. In particular, the fixed bag mouth regulating member 70 has, but is not limited thereto, the width wider than the length of the long side of the bagged culture medium block, and the height corresponding to the height range of the unfilled portion of the bagged culture medium block. The bottom position of the fixed bag mouth regulating member 70 is higher than the pressing mechanism 37G by a predetermined distance, and the gap thereof is provided so that the pressing mechanism 37G is not brought into contact with the bottom portion of the fixed bag mouth regulating member 70 when the pressing mechanism 37G is moved. The top position of the fixed bag mouth regulating member 70 is not particularly limited, but may be set to a position slightly lower than the bag mouth 11f.

When the bagged culture medium block is positioned at the position of the positioning block 71, the movable bag mouth regulating member 72 moves to the bag mouth regulating position by, for example, being rotated upward. The height position of the movable bag mouth regulating member 72 at the bag mouth regulating position corresponds to the height range of the unfilled portion of the bagged culture medium block. The movable bag mouth regulating member 72 is, for example, a plate-shaped member. In particular, the movable bag mouth regulating member 72 has, but is not limited thereto, the width wider than the length of the long side of the bagged culture medium block, and the height range corresponding to the height of the unfilled portion of the bagged culture medium block. The length dimension of the movable bag mouth regulating member 72 in the height direction can be smaller than that of the fixed bag mouth regulating member 70. The movable bag mouth regulating member 72 is movable between the storage position and the bag mouth regulating position. The movable bag mouth regulating member 72 can be moved from the storage position to the bag mouth regulating position by, for example, being rotated upward, and can be moved from the bag mouth regulating position to the storage position by being rotated in the opposite direction. The top position of the movable bag mouth regulating member 72 is not particularly limited, but may be set to a position slightly lower than the bag mouth 11f.

In a state where the movable bag mouth regulating member 72 is moved to the bag mouth regulating position, the blower 32a blows air from the bag mouth 11f side, so that the bag mouth is kept open. Here, the opening range of the bag mouth is regulated to a predetermined range by being clamped with the fixed bag mouth regulating member 70 and the movable bag mouth regulating member 72. The bagged culture medium block does not always have an accurate rectangular parallelepiped shape. Therefore, the position of the bottom surface of the culture medium and the opening position of the bag mouth may be different from each other. Even in such a case, the bottom surface side of the bagged culture medium block is positioned at the position of the positioning block 71, and the bag mouth is kept open within a predetermined range regulated by being clamped with the fixed bag mouth regulating member 70 and the movable bag mouth regulating member 72. Therefore, the supporting mechanism 35 can be reliably inserted, and the pushed positions by the pushing mechanism 36 are also stable, so that the unfilled portion 11h can be accurately folded in the Z-shape.

As shown in FIGS. 43C and 43D, the pushing mechanism 36 is inserted from the bag mouth in a state where the blower 32a blows air from the bag mouth 11f side. The time when the blower 32a starts blowing, the time when the movable bag mouth regulating member 72 is moved to the bag mouth regulating position, and the time when the pushing mechanism 36 is inserted can be appropriately set. However, it is desirable that the pushing mechanism 36 is inserted into the bag mouth at least after the blowing is started. For example, the time can be set so that the blower 32a starts blowing air, and then the movable bag mouth regulating member 72 is moved to the bag mouth regulating position, and then the pushing mechanism 36 is inserted. Further, for example, the time can be set so that the blower 32a starts blowing air, and then the movable bag mouth regulating member 72 is moved to the bag mouth regulating position, and at the same time the insertion of the pushing mechanism 36 is started.

As shown in FIGS. 43G and 43H, when the bag mouth of the bagged culture medium block is pressed by the pressing mechanism 37G, the movable bag mouth regulating member 72 is no longer in contact with the bag mouth. Therefore, the movable bag mouth regulating member 72 is moved to the storage position.

In FIGS. 44A and 44B, the position of the positioning block 71 is moved so that the bagged culture medium block can be moved toward the right direction in the drawing. In addition, in FIGS. 44A to 44H, the positioning block 71 is shown to be retracted downward for easy explanation, but the present embodiment is not limited to this configuration, and for example, the positioning block 71 may be retracted laterally or upward.

As shown in FIGS. 44C to 44F, since the bagged culture medium block is moved toward the right direction in the drawing in a state where the bag mouth of the bagged culture medium block is pressed by the pressing mechanism 37G, the bag mouth is folded toward the left side in the drawing. Further, since the fixed bag mouth regulating member 70 is arranged above the pressing mechanism 37G at a predetermined distance, the bag mouth of the bagged culture medium block is in a folded state below the fixed bag mouth regulating member 70.

### Embodiment 3

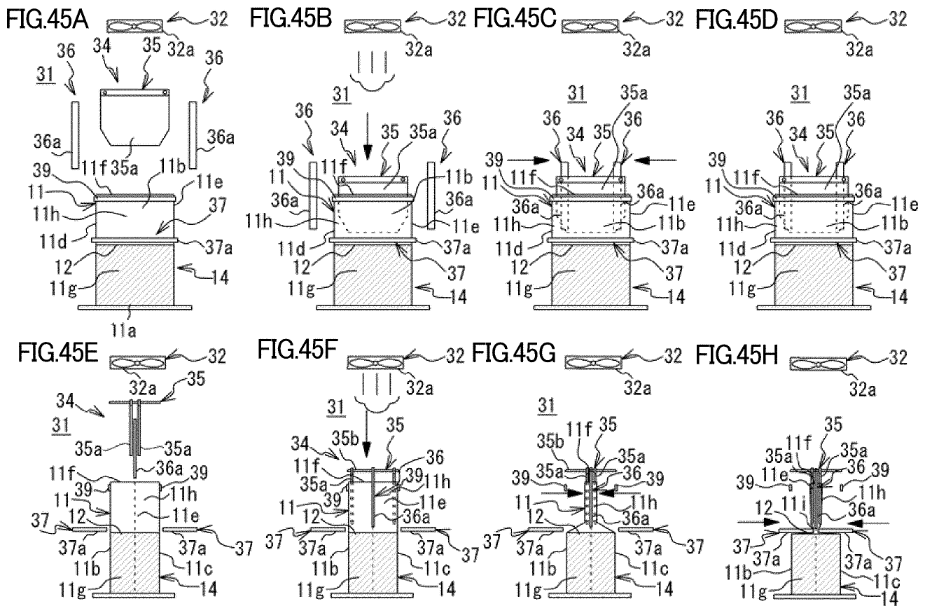

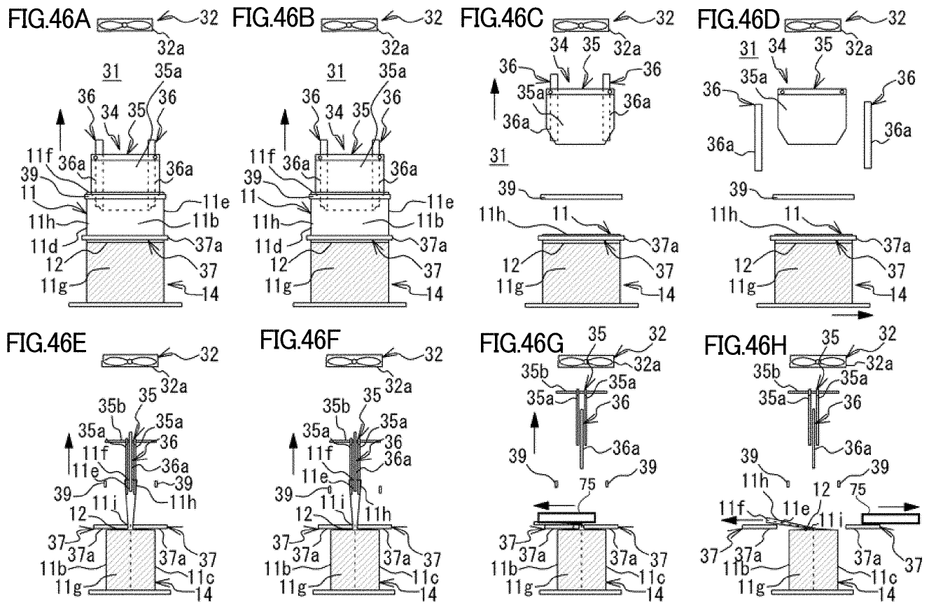

The folding device 31 according to the embodiment 3 will be described with reference to FIGS. 45 and 46. The folding device 31 according to the embodiment 3 is different from the aspects of FIGS. 7 and 8 in the embodiment 1 in that a bending member 75 is used as the tilting mechanism 38 instead of the blower 38a.

FIG. 45 are a view illustrating processes of the folding means according to the embodiment 3, and FIGS. 45A, 45C, 45E and 45G are views seen from the direction orthogonal to the traveling direction of the transporting means (long side direction of the bagged culture medium block), and FIGS. 45B, 45D, 45F and 45H are views seen from the traveling direction of the transporting means (short side direction of the bagged culture medium block). Further, FIG. 46 are views illustrating processes following FIG. 45, and FIGS. 46A, 46C, 46E and 46G are views seen from the direction orthogonal to the traveling direction of the transporting means (long side direction of the bagged culture medium block), and FIGS. 46B, 46D, 46F and 46H are views seen from the traveling direction of the transporting means (short side direction of the bagged culture medium block). The same reference numerals are used for the same configurations as those in FIGS. 7 and 8, and the description thereof will be omitted.

In FIGS. 45A and 45B, the bagged culture medium block is transported with the short side thereof facing the traveling direction. The bagged culture medium block is transported in the direction toward the right side of FIG. 45A. Although not shown in FIG. 45B, by providing the bag mouth expansion range adjusting means on both sides of the bag mouth, the opening range of the bag mouth can be regulated when the blower 32 blows air from the bag mouth 11f side.

As shown in FIG. 46F, in a state where the bag mouth pressed by the pressing mechanism 37 and a predetermined gap is provided above the pressing mechanism 37, the bending member 75 is moved from the right side to the left side in FIG. 46F so that the bag mouth can be bent. The bending member 75 is not particularly limited, but may be composed of, for example, a plate-shaped member. In FIG. 46H, the bending member 75 is moved to a retracted position.

### Embodiment 4

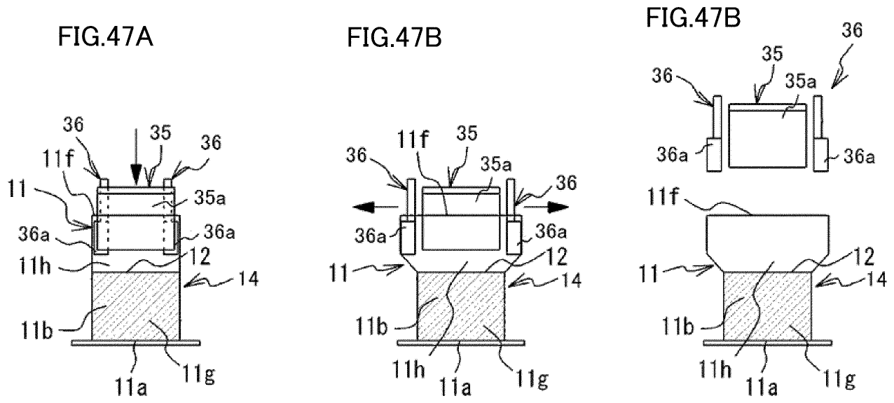

The folding device 31 according to the embodiment 4 will be described with reference to FIG. 47. The same reference numerals are used for the same configurations as those of the folding devices 31 according to the embodiments 1 to 3, and the description thereof will be omitted.

In the embodiments 1 to 3, the case of the gusset folding is mainly described, but in the present embodiment, the case of the I-shaped folding will be described. In the case of the gusset folding, the pushing members 36a are moved from the outside to the inside, but in the case of I-shaped folding, the pushing members 36a are moved from the inside of the bag mouth to the outside (see FIG. 47B). That is, in FIG. 47A, in a state where a fan blows air from above to open the bag mouth, a pair of the pushing members 36a and a pair of the supporting members 35a that are in a state of being spaced from each other are inserted from the bag mouth into the inside of the bag body. In FIG. 47B, each of the pair of the pushing members 36a inserted inside the bag body are moved outward, and the pair of supporting members 35a are brought close to each other to narrow the interval, so that the bag mouth becomes in the I-shape. Next, in FIG. 47C, the pair of the pushing members 36a and the pair of the supporting members 35a are pulled upward from the bag mouth.

In FIG. 47, an example in which the pair of the supporting members 35a and the pair of the pushing members 36a are used is described, but the present embodiment is not limited to this configuration, and the I-shaped folding may be performed only with the pair of the pushing members 36a without using the pair of the supporting members 35a as the supporting mechanism 35. That is, in FIG. 47A, in a state where the fan blows air to open the bag mouth, the pair of the pushing members 36a are inserted from the bag mouth into the inside of the bag body, and in FIG. 47B, each of the pair of the pushing members 36a inserted inside the bag body is moved outward so that the bag mouth is in the I-shape, and in FIG. 47C, the pair of the pushing members 36a are pulled upward from the bag mouth. Here, the pair of the supporting members 35a shown in FIG. 47 can be omitted.

Further, in the present embodiment, when the bag mouth of the bagged culture medium block 14 is folded in the I-shape by the folding device, the string member is inserted from the bag mouth. In the sterilization process, the bagged culture medium block 14 is sterilized with high-pressure steam in the sterilization chamber, and then the sterilization chamber is returned to normal pressure. In a case where the string member is not inserted into the bag mouth, the bag mouth is kept closed by the pressure of the high-pressure steam and the culture medium in the bagged culture medium block 14 may be hardened. If a string member is inserted into the bag mouth of the bagged culture medium block 14 when the bag mouth is folded, an air flow path can be formed in the bag mouth, so that the culture medium of the bagged culture medium block 14 can be finished softly compared with the case where the string member is not inserted. The material of the string member is not particularly limited, but for example, it is desirable to use a natural material such as a hemp string. This is because the string member is removed after the sterilization process, but even if the string member is mixed in the culture medium, if the string member is a natural material such as hemp string, it will not affect the growth of mushrooms, and the environmental load can also be reduced in the subsequent treatment of the culture medium.

Hereinafter, a method of inserting the string member will be described with an example in which the I-shaped folding is performed only with the pair of the pushing members 36a and without the pair of the supporting members 35a as the supporting mechanism 35. At the folding position in the folding device, in a state where the fan blows air to open the bag mouth, the pair of the pushing members 36a are inserted into the bag mouth, and the string guide member is provided toward the bag mouth from the position corresponding to one of the supporting members 35a in FIG. 47 (here, the supporting member 35a is not used), and the string member is inserted into the bag mouth from above by being guided by a string guide member. Here, the string member is guided along the inside of the long side on the string guide member side of the bag mouth and inserted into the bag. Further, the string member is inserted into the bagged culture medium block 14 so that one end of the string member touches the upper surface of the culture medium and the other end protrudes from the bag mouth.

### Embodiment 5

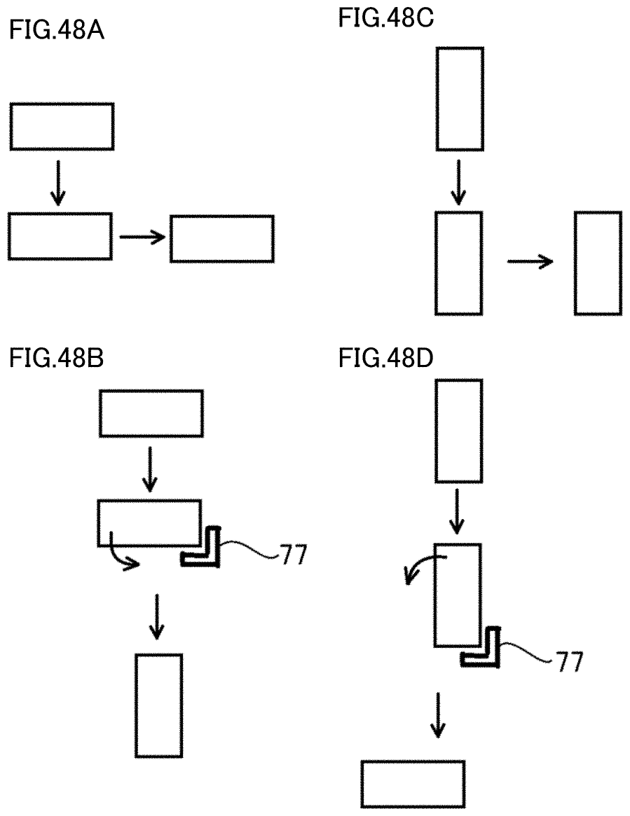

The folding device 31 according to the embodiment 5 will be described with reference to FIG. 48. The same reference numerals are used for the same configurations as those of the folding devices 31 according to the embodiments 1 to 4, and the description thereof will be omitted. FIG. 48 schematically illustrate a method of changing the direction and the orientation of the bagged culture medium block. In FIGS. 48A and 48C, the transport direction is changed by 90 degrees. FIGS. 48B and 48D show a method of rotating the orientation of the bagged culture medium block by 90 degrees during transportation by providing a rotation fulcrum member 77 on the transport path.

### Embodiment 6

In the embodiment 6, various aspects of the containerization device 46 will be described with reference to a plurality of examples. In the embodiment 1, as shown in FIGS. 9 to 15, an aspect in which the bagged culture medium blocks 14 are stored one by one in the container 15 by the folding-in member 41, the underlay member 56, the rod-shaped bodies 48 and the like is described. However, the aspect in which the bagged culture medium block 14 is stored in the container 15 is not limited to this configuration, and various aspects including, for example, examples 1 to 3 can be adopted, and any aspect can be adopted as long as the bagged culture medium block 14 can be stored in the container 15.

### Example 1

In the example 1, a plate-shaped member, which has vacuum suction nozzles facing at least two side surfaces, for example two opposing surfaces, three surfaces or four surfaces of the bagged culture medium block 14, is used to lift the bagged culture medium block 14 one by one so that the bagged culture medium block 14 is stored in the container 15.

### Example 2

In the example 2, by using an arm robot provided with means for holding the bagged culture medium block 14, for example, an articulated arm robot, the bagged culture medium block 14 can be held and moved by the arm robot and stored in the container 15. Further, since the arm robot can not only hold and move the bagged culture medium block 14 but also adjust the posture of the bagged culture medium block 14, the posture of the bagged culture medium block 14 can be adjusted without rotating the container 15. Therefore, the bagged culture medium block 14 can be stored in the container in a state where a plurality of the bagged culture medium blocks 14 are aligned in the container 15, for example, in a state where the four bagged culture medium blocks 14 are aligned in a spiral shape as shown in FIG. 15C.

### Example 3

In the example 3, there are provided the plate-shaped members, which face at least two side surfaces, for example, two opposing surfaces, three to four surfaces, or the entire side surfaces of the bagged culture medium block 14, and claw members for supporting the bottom portion of the bagged culture medium block 14 on the bottom portion of at least one surface, for example, one surface, two surfaces, or three or four surfaces of the plate-shaped members. The claw members can be moved, transform, change the posture between a position where the claw members engage with the bottom portion of the bagged culture medium block 14 to hold the bagged culture medium block 14 and a position where the claw members do not engage with the bottom portion of the bagged culture medium block 14 and do not hold the bagged culture medium block 14. For example, in a case where the angle of the claw members can be changed by hinges, the angle of the claw members can be changed so that the claw members can be moved between a position where the claw members engage with the bottom portion of the bagged culture medium block 14 and a position where the claw members do not engage with the bottom portion of the bagged culture medium block 14.

At least one or more claw members, for example, a plurality of claw members such as three claw members can be provided. At the bottom portion of the plate-shaped member provided around the outer periphery of the bagged culture medium block 14, recesses or holes are provided in portions corresponding to the claw members, and the claw members can be moved from the recess or hole of the plate-shaped member to the position where the claw members protrude and engage with the bottom portion of the bagged culture medium block 14. The number of the recesses or holes in the plate-shaped member corresponds to the number of claw members. For example, in a case where there are three claw members, the number of recesses or holes in the plate-shaped member is three. The protruding length of the claw member from the inside of the plate-shaped member to the position where the claw members engage with the bottom portion of the bagged culture medium block 14 may be such that the bagged culture medium block 14 can be held, for example, 50 mm or less and, for example, about 5 mm to 10 mm.

By holding the bagged culture medium block 14 with the plate-shaped member and the claw members, it is possible to lift the bagged culture medium block 14 without using the rod-shaped bodies 48 or the like as in the embodiment 1, and by lifting the bagged culture medium block 14 one by one, the bagged culture medium block 14 can be stored in the container 15.

In a case where the four bagged culture medium blocks 14 are stored in the container 15 in a spiral shape as shown in FIG. 15C, if the claw members are provided on one surface of the plate-shaped member, the claw members are arranged between the inner circumference of the outer peripheral wall of the container and the outer circumference of the long side of the bagged culture medium block 14. By arranging the claw members in this way, when the bagged culture medium blocks 14 are lifted one by one and stored in the container 15 and then the plate-shaped member is lifted in a state where the claw members are at the engaging position, it is possible to prevent the claw member from interfering with the folded bag mouth 11f of other bagged culture medium block 14 and from raising the bag mouth 11f.

### Embodiment 7

In the embodiment 7, an embodiment in which the containerization device 46 is provided with a fan for blowing air from above toward the bagged culture medium block 14 will be described. In a state where a plurality of bagged culture medium blocks 14 are arranged and stored in the container 15, for example, four bagged culture medium blocks 14 are arranged and stored in a spiral shape as shown in FIG. 15C, a fan is provided above the container 15 and blows air toward the bagged culture medium block 14 stored in the container 15 so that the bag mouth 11f of each bagged culture medium block 14 folded by the folding device 31 is not raised again.

There may be provided a large-capacity fan capable of simultaneously blowing air from above to the plurality of bagged culture medium blocks 14. Alternatively, there may be provided a plurality of individual fans having a capacity capable of individually blowing air from above toward the positions corresponding to each bagged culture medium block 14 stored in the container 15. For example, there may be provided the number of fans equal to the number of the bagged culture medium blocks 14 stored in the container 15, for example, specifically four of fans. Alternatively, one fan can blow air above two or more, for example, two bagged culture medium blocks 14. As described above, the number of fans can be appropriately set so that air can be blown from above to each bagged culture medium block 14 according to the capacity of the fans.

### Embodiment 8

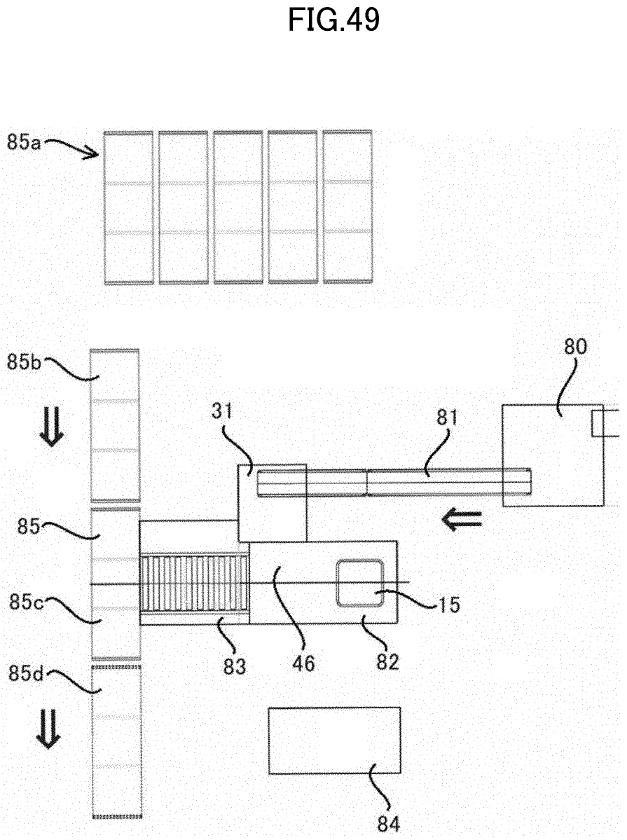

A shelf insertion device according to the embodiment 8 will be described with reference to FIGS. 49 to 53. The same reference numerals are used for the same configurations as those in the above-described drawings, and the description thereof will be omitted.

FIG. 49 is an example of a layout view of the shelf insertion device according to the embodiment 8. In a filling machine 80, the culture medium transported from a mixer is filled in the bag body 11 to manufacture the bagged culture medium block 14. The bagged culture medium block 14 manufactured by the filling machine 80 is conveyed to the folding device 31 by a conveyor 81, and the bag mouth 11f of the bagged culture medium block 14 is folded in the folding device 31. The container 15 for storing the bagged culture medium block 14 is supplied from a container supply section 82. A container storage area 84 is provided in the vicinity of the container supply section 82. The bagged culture medium block 14 in which the bag mouth 11f is folded in the folding device 31 is stored in the container 15 by the containerization device 46.

Empty sterilization trolleys 85 stocked in a spare trolley storage area 85a are moved to a standby position 85b one by one. The container 15 storing the plurality of bagged culture medium blocks 14 is transferred to the sterilization trolley 85 at a shelf insertion position 85c by a shelf insertion device 83. When the containers 15 are transferred to all the shelves, the sterilization trolley 85 is moved to a carry-out position 85d, and one of the empty sterilization trolleys 85 stocked in the spare trolley storage area 85a is moved to the standby position 85b, and the sterilization trolleys 85 standing by at the standby position 85b is moved to the shelf insertion position 85c. If the sterilization trolley 85 at the standby position 85b is connected to the sterilization trolley 85 at the shelf insertion position 85c, the sterilization trolley 85 at the standby position 85b can be moved in conjunction with the movement of the sterilization trolley 85 at the shelf insertion position, onto which the containers 15 were transferred. As a result, as the sterilization trolley 85 is moved to the carry-out position 85d, the next empty sterilization trolley 85 is arranged at the shelf insertion position 85c.

In the layout example of the shelf insertion device 83 of FIG. 49, the flow of the bagged culture medium block 14 in the folding device 31 is downward from the folding device 31 to the containerization device 46, and then, the flow of the container 15 in which the bagged culture medium block 14 is stored is in the left direction of FIG. 49 from the containerization device 46 to the shelf insertion device 83. Here, the present embodiment is not limited to this layout, and various layouts can be adopted in which, for example, the folding device 31 is arranged on the lower side of the containerization device 46 in FIG. 49.

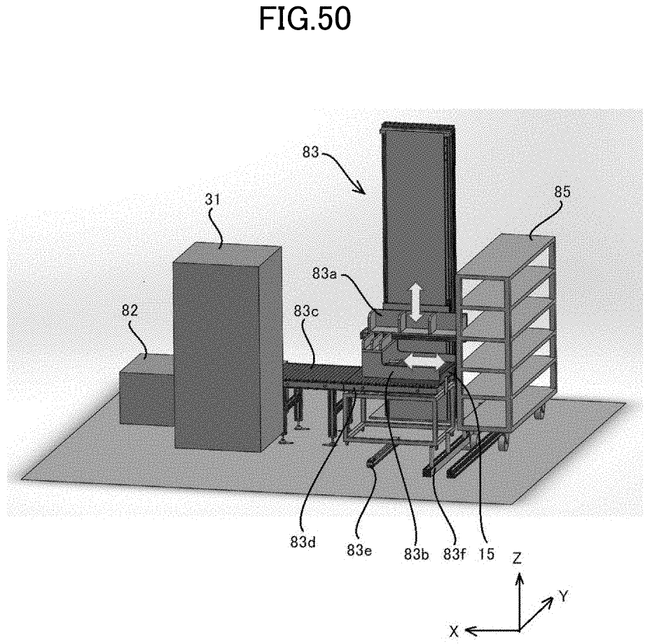

FIG. 50 is a perspective view of the shelf insertion device according to the embodiment 8. In FIG. 50, the X direction is the right-left direction, the X12 direction is the right direction, the X2 direction is the left direction, the Y direction is the depth direction, the Y1 direction is the depth direction, the Y2 direction is the front direction, the Z direction is the height direction, the Z1 direction is upward direction, and the Z2 direction is downward direction.

The shelf insertion device 83 includes an elevating device 83a, a transfer device 83b, a fixed conveyor 83c, a movable conveyor 83d, conveyor moving means 83e and sterilization trolley moving means 83f. After the bag mouth 11f of the bagged culture medium block 14 is folded in the folding device 31, the bagged culture medium block 14 is stored in the container 15 supplied from the container supply section 82, and the container 15 in which the bagged culture medium block 14 is stored is conveyed to the transfer device 83b via the fixed conveyor 83c and the movable conveyor. The container 15 conveyed to the transfer device 83b is raised and lowered by the elevating device 83a together with the transfer device 83b, so that the container 15 can be transferred onto the sterilization trolley 85 one by one in a state where the height of the container 15 is adjusted to the height of each stage of the sterilization trolley 85. The configuration of the sterilization trolley 85 is not particularly limited, but in the example of FIG. 50, the sterilization trolley 8 is composed of a shelf having six stages, and each stage stores three containers 15.

As an example of the procedure for transferring the containers 15 to the sterilization trolley 85 one by one, a case where the containers 15 are transferred to the sterilization trolley 85 one by one while the sterilization trolley 85 moves in the Y1 direction will be described. In the example in which the three containers 15 are transferred to each stage of the sterilization trolley 85, each stage has a transfer position on the Y1 side, a transfer position at the center, and a transfer position on the Y2 side. First, the empty sterilization trolley 85 is located at a position on the Y2 side, and is moved to a position at which the transfer position on the Y1 side of the sterilization trolley 85 corresponds to the position of the transfer device 83b. At this position, the containers 15 are transferred to each stage one by one.

Next, the sterilization trolley 85 is moved in the Y1 direction by a distance approximately corresponding to one container 15, and to a position at which the transfer position at the center of the sterilization trolley 85 corresponds to the position of the transfer device 83b. At this position, the containers 15 are transferred to each stage one by one. Finally, the sterilization trolley 85 further is moved in the Y1 direction by a distance approximately corresponding to one container 15, and to a position at which the transfer position at the Y2 side of the sterilization trolley 85 corresponds to the position of the transfer device 83b. At this position, the containers 15 are transferred to each stage one by one. At each position, the container 15 conveyed onto the transfer device 83b is raised and lowered by the elevating device 83a together with the transfer device 83b, so that the containers 15 can be transferred to the sterilization trolley 85 one by one in a state where the height of the container 15 is adjusted to the height of each stage of the sterilization trolley 85. It is arbitrary from which stage the container 15 is started to be transferred at each position, for example, the containers 15 may be transferred in order from the upper stage to the lower stage, or in order from the lower stage to the upper stage.

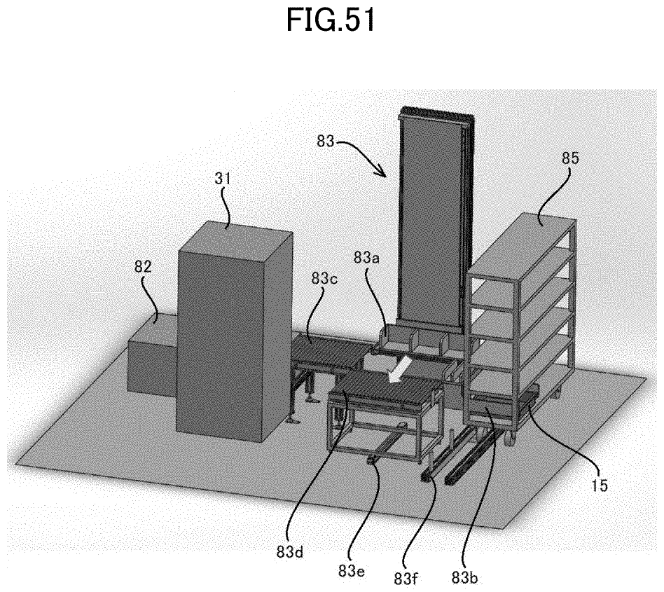

FIG. 51 is an explanatory view of the transfer positions on the lower stage in the shelf insertion device according to the embodiment 8. When the container 15 is transferred to the lower stage of the sterilization trolley 85, the movable conveyor 83d is moved in the Y2 direction by the conveyor moving means 83e in a state where the container 15 is held by the transfer device 83b. In the empty space provided by the movement of the movable conveyor 83d, the transfer device 83b holding the container 15 is lowered to the lower stage of the sterilization trolley 85 by an elevating device 83a, and the container is transferred to the sterilization trolley 85 in a state where the height of the container 15 is adjusted to the height of the lower stage.

### Modified Example 1

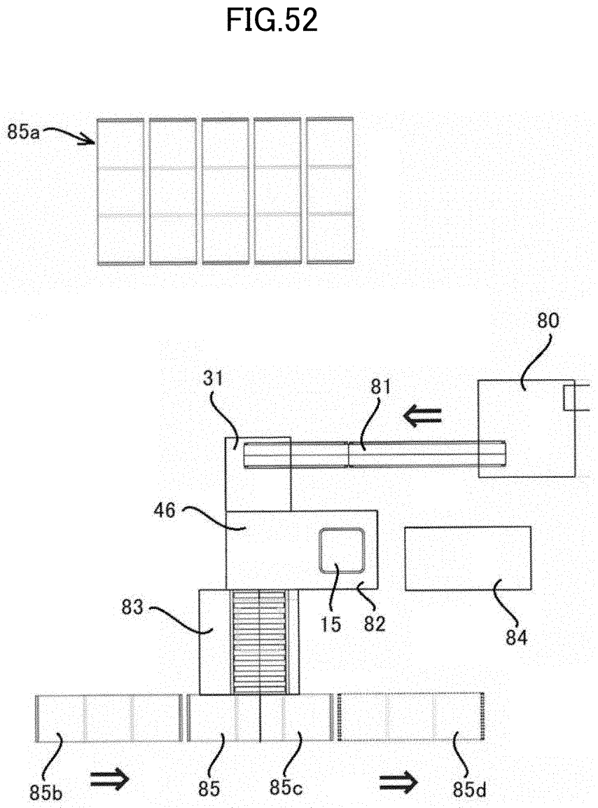

FIG. 52 is a layout view of the shelf insertion device according to the modified example 1 of the embodiment 8. In FIG. 52, the layout of the shelf insertion device is different from the example of FIG. 49. In the layout example of the modified example 1, the flow of the bagged culture medium block 14 in the folding device 31 is downward in FIG. 52 from the folding device 31 to the containerization device 46, and then the flow of the container 15 in which the bagged culture medium block 14 is stored is also downward in FIG. 52 from the containerization device 46 to the shelf insertion device 83. The present embodiment is not limited to this layout, and various layouts such as those in which the arrangement of the folding device 31 and the shelf insertion device 83 are reversed can be adopted.

### Modified Example 2

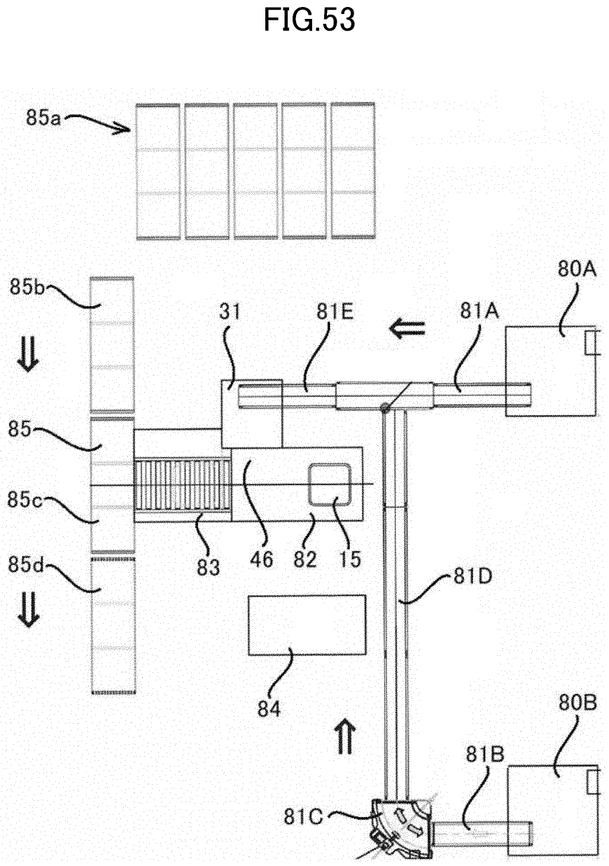

FIG. 53 is a layout view of the shelf insertion device according to the modified example 2 of the embodiment 8. The modified example 2 is a layout example having two filling machines 80A and 80B. The bagged culture medium block 14 manufactured in the filling machine 80A is conveyed via conveyors 81A and 81E. The bagged culture medium block 14 manufactured in the other filling machine 80B is conveyed via a conveyor 81B, a curved conveyor 81C, a conveyor 81D and the conveyor 81E.

### Embodiment 9

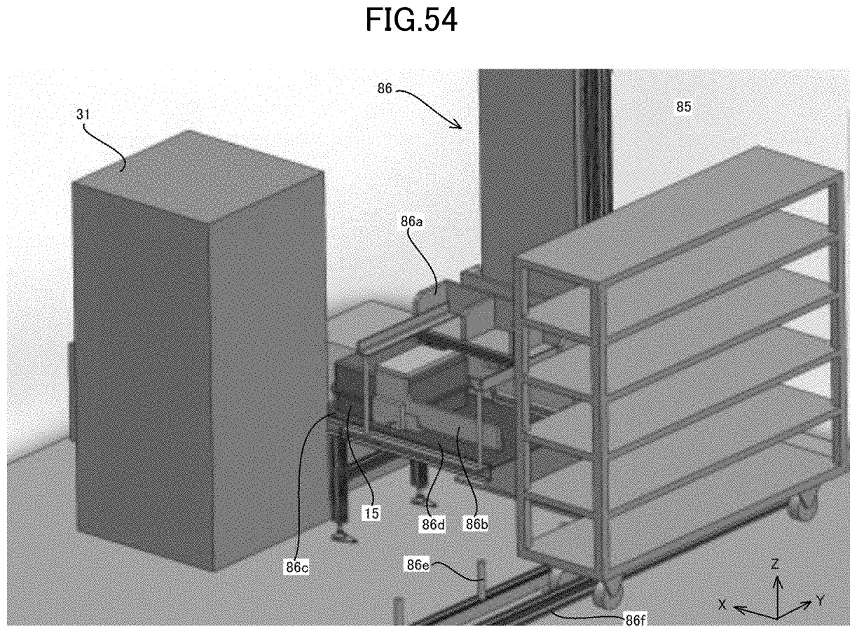

The shelf insertion device according to the embodiment 9 will be described with reference to FIGS. 54 to 60. The same reference numerals are used for the same configurations as those in the above-described drawings, and the description thereof will be omitted. The shelf insertion device according to the embodiment 9 is different from that of the embodiment 8 in that an elevating conveyor 86d is adopted.

FIG. 54 is a first perspective view of the shelf insertion device according to the embodiment 9. In FIGS. 54 to 59, the X direction is the transport direction of the elevating conveyor, the X1 direction is the right direction, the X2 direction is the left direction, the Y direction is the transport direction of the sterilization trolley, the Y1 direction is the left direction, and the Y2 direction is the right direction, the Z direction is the height direction, the Z1 direction is upward direction and the Z2 direction is downward direction.

A plurality of the bagged culture medium blocks 14 in which the bag mouths 11f are folded by the folding device 31 are stored in the container 15 in an aligned state, and the container 15 storing the plurality of bagged culture medium blocks 14 is transferred to the shelf of the sterilization trolley 85 by a shelf insertion device 86.

The shelf insertion device 86 includes an elevating device 86a, a transfer device 86b, a fixed conveyor 86c, the elevating conveyor 86d, a position sensor 86e, and sterilization trolley moving means 86f. After the bag mouth 11f of the bagged culture medium block 14 is folded in the folding device 31, the bagged culture medium block 14 is stored in the container 15 supplied from the container supply section 82, and the container 15 in which the bagged culture medium block 14 is stored is conveyed to the transfer device 86b via the fixed conveyor 86c and the elevating conveyor 86d. The transfer device 86b and the elevating conveyor 86d can be integrally raised and lowered by the elevating device 86a. The container 15 conveyed to the transfer device 86b is raised and lowered together with the transfer device 86b and the elevating conveyor 86d, so that the container 15 can be transferred onto the sterilization trolley 85 one by one in a state where the height of the container 15 is adjusted to the height of each stage of the sterilization trolley 85. The configuration of the sterilization trolley 85 is not particularly limited, but in the example of FIG. 54, the sterilization trolley 8 is composed of a shelf having six stages, and each stage stores three containers 15.

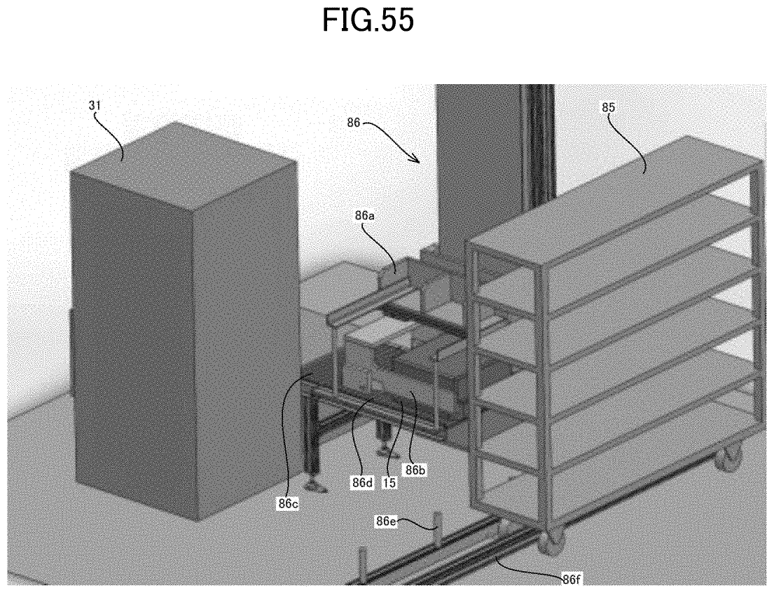

In the first perspective view of the shelf insertion device of the present embodiment of FIG. 54, the container 15 in which the bagged culture medium block 14 is stored is conveyed in the direction to the elevating conveyor 86d from the fixed conveyor 86c to the elevating conveyor 86d. FIG. 55 is the second perspective view of the shelf insertion device of the present embodiment, and in FIG. 55, the container 15 was conveyed to a predetermined transfer position of the transfer device 86b. The container 15 is conveyed along the elevating conveyor 86d by the momentum of being sent out from the storing means, which is for storing a plurality of the bagged culture medium blocks 14 in an aligned state in the container 15, to the fixed conveyor 86c so as to be set in the predetermined transfer position of the transfer device 86b. The transfer device 86b is provided with a fixed claw 86b1 and a movable claw 86b2 as described later, and the container 15 sent out with momentum along the fixed conveyor 86c is just fixed at the predetermined transfer position of the transfer device 86b by the fixed claw 86b1 and the movable claw 86b2.

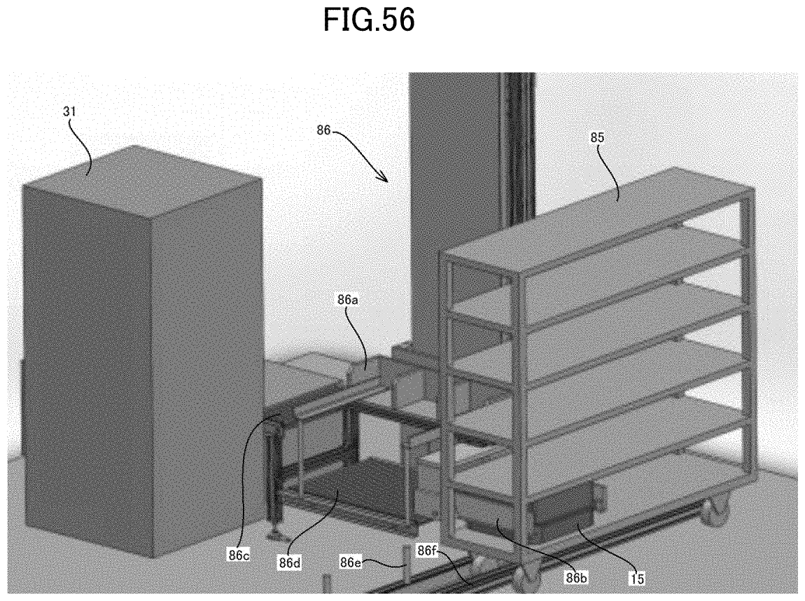

FIG. 56 is the third perspective view of the shelf insertion device of the present embodiment, in which the container 15 is conveyed in the Z2 direction together with the transfer device 86b and the elevating conveyor 86d, and the transfer device 86b slides along the upper portion of the elevating conveyor 86d in the X1 direction together with the container 15, and the container 15 is stored in the bottom row of the sterilization trolley 85 at the deepest position in the Y1 direction. The height of the transfer device 86b when the transfer device 86b slides in the X1 direction is set such that there is an appropriate gap between the bottom surface of the container 15 and the upper surface of a predetermined stage of the sterilization trolley 85. If this gap is too small, the bottom of the container 15 may rub against the upper surface of the stage of the sterilization trolley when the transfer device 86b slides in the X1 direction, and this is not preferable. On the other hand, if this gap is too large, the height of the container 15 is too high with respect to the height of the predetermined stage of the sterilization trolley, and the upper surface of the container 15 may come into contact with the upper stage of the predetermined stage.

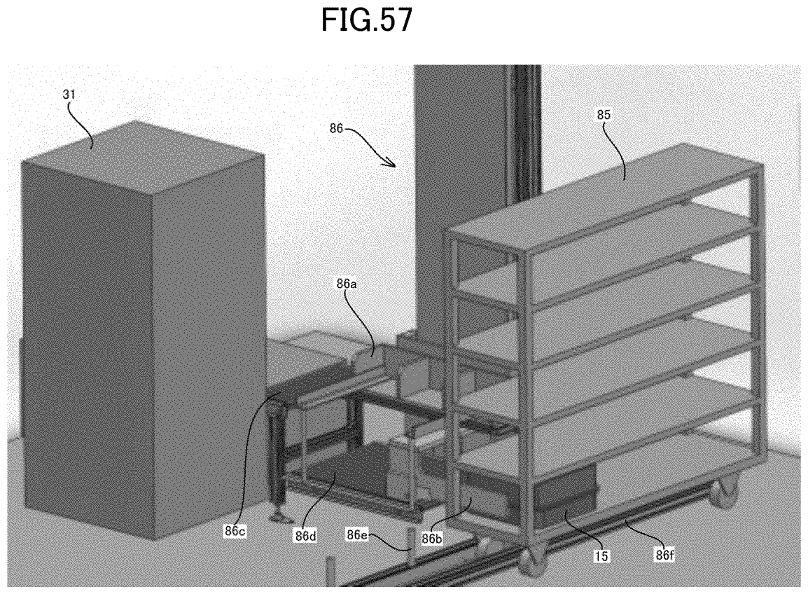

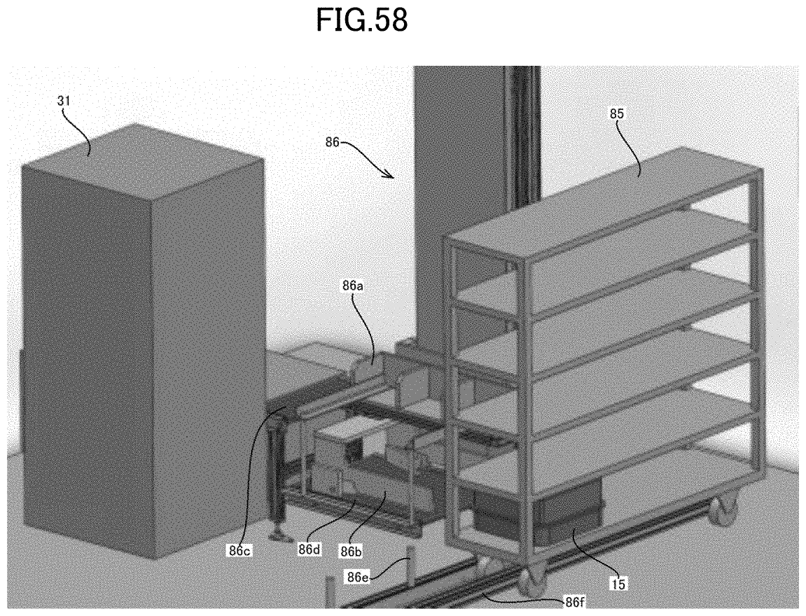

FIG. 57 is the fourth perspective view of the shelf insertion device of the present embodiment, in which, when the container 15 is carried to a predetermined position on a stage of the sterilization trolley 85, the transfer device 86b and the elevating conveyor 86d are integrally moved a little in the Z2 direction so that the container 15 is released from the restraint of the transfer device 86b. FIG. 58 is the fifth perspective view of the shelf insertion device of the present embodiment, in which only the transfer device 86b, which is released from the engagement with the container 15, is moved back in the X2 direction along the upper portion of the elevating container 86d while the container 15 is placed on the predetermined position of the sterilization trolley 85.

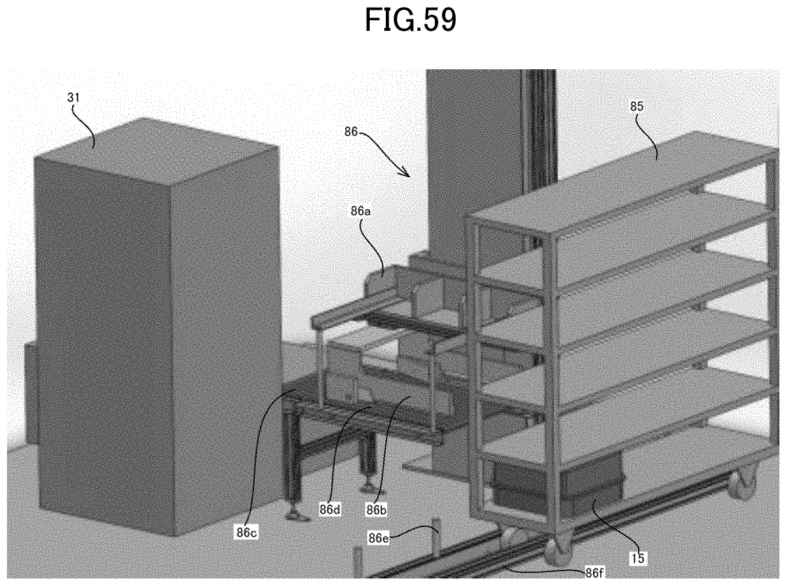

FIG. 59 is the sixth perspective view of the shelf insertion device of the present embodiment, in which the transfer device 86b and the elevating conveyor 86d are integrally moved in the Z2 direction by the elevating device 86a, and the transfer device 86b and the elevating conveyor 86d are returned to a limited position at which the height of the elevating conveyor 86d corresponds to the height of the fixed conveyor 86c. Although not particularly limited, it is desirable that the height of the elevating conveyor 86d is a height at which the container 15 can be directly transferred to a predetermined stage of the sterilization trolley 85. For example, in the example of FIG. 59, the height of the elevating conveyor 86d is set to a height at which the container 15 can be directly transferred to the second stage from the bottom of the sterilization trolley 85.

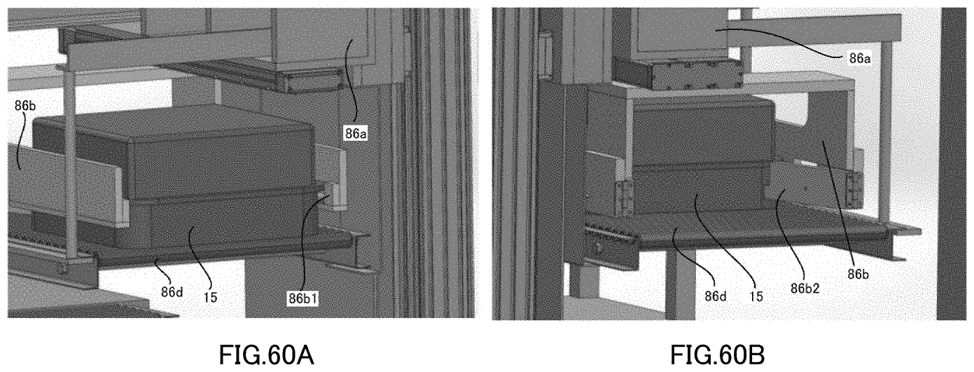

FIG. 60 illustrates the fixed claws 86b1 and the movable claws 86b2 of the transfer device 86b. As shown in FIG. 60A, a pair of the fixed claws 86b1 is provided at positions nearer to the X1 direction in the transfer device 86b. A flange extending outward is provided on the upper surface of the container 15. The container 15 is conveyed along the fixed conveyor 86c by the momentum of being sent out from the storing means, which is for storing a plurality of the bagged culture medium blocks 14 in an aligned state in the container 15, to the fixed conveyor 86c, but the fixed claws 86b1 restrict the flange on the upper surface of the container 15 in the X1 direction. In FIG. 60A, the front side along the transfer device 86b is the X1 direction.

As shown in FIG. 60B, a pair of the movable claws 86b2 is provided at positions nearer to the X2 direction in the transfer device 86b. In FIG. 60B, the front side along the transfer device 86b is the X2 direction. The X2 side of the movable claw 86b2 is fixed with an end portion of the transfer device 86b on the X2 side by, for example, a hinge so that the movable claw 86b2 can be moved around the hinge. The X1 side of the movable claw 86b2 has an open end, but is urged inward in the width direction by an elastic member, and when the container 15 enters the transfer device 86b from the X2 direction to the X1 direction, the container 15 can enter the transfer device 86b in the X1 direction so that the end face in the width direction of the container 15 advances along the inner surface side in the Y direction of the movable claw 86b2. On the other hand, once the container 15 advances in the X1 direction from the movable claw 86b2, the free end on the X1 direction side of the movable claw 86b2 is urged by the elastic member in the direction of narrowing the width in the Y direction, so that the container 15 is engaged with the open end in the X1 direction of the movable claw 86b2, thus the container 15 is prevented from coming out in the X2 direction.

In FIG. 60B, the movable claws 86b2 are only urged by the elastic member and do not require any power other than the elastic member. Further, the fixed conveyor 86c and the elevating conveyor 86d also do not require power. The container 15 is conveyed along elevating conveyor 86d by the momentum of being sent out from the storing means, which is for storing a plurality of the bagged culture medium blocks 14 in an aligned state in the container 15, to the fixed conveyor 86c, and is conveyed along the elevating conveyor 86d, and is set at a predetermined transfer position of the transfer device 86b by the fixed claws 86b1 and the movable claws 86b2.

Here, an example in which the fixed conveyor 86c and the elevating conveyor 86d are not provide with the power unit is described, but the present embodiment is not limited to this configuration. For example, in a case where the fixed conveyor 86d and/or the elevating conveyor 86 are/is provided with a power unit, the container 15 is always conveyed in the X1 direction by this power unit. Therefore, since the container 15 does not go backward in the X2 direction of the transfer device 86b, the movable claw 86b2 can be omitted in this case.

The fixed claws 86b1 regulate the flange on the upper surface of the container 15 in the X1 direction. Therefore, as shown in FIG. 57, when the transfer device 86b and the elevating conveyor 86d are integrally moved a little in the Z2 direction, the engagement between the flange on the upper surface of the container 15 and the fixed claws 86b1 is released, and the container 15 is released from the restraint of the transfer device 86b.

The folding device for the bagged culture medium block and the containerization device provided with the folding device according to the embodiment of the present invention have been described above, but these embodiments are for exemplifying the folding device for the bagged culture medium block and the containerization device provided with the folding device in order to embody the technical concept of the present invention, and do not specify the present invention to these embodiments. Thus, the present invention can be equally applied to a modification of each embodiment, a combination of each embodiment or the like. For example, the shape of the supporting member 35 is illustrated as a substantially square plate shape, but the shape is not limited to this shape, and various shapes such as, for example, those having a pair of rod-shaped or thin plate-shaped members on the left and right are available.

### Embodiment 10

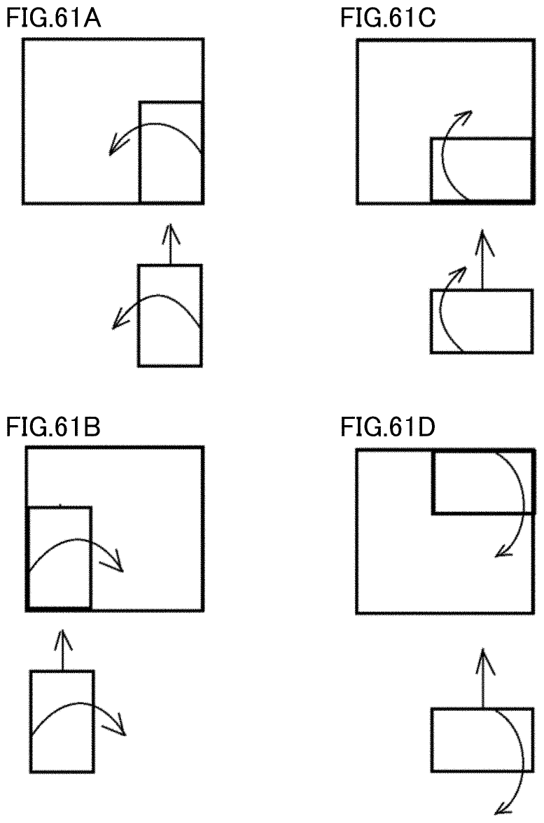

The shelf insertion device according to the embodiment 10 will be described with reference to FIG. 61. The same reference numerals are used for the same configurations as those in the above-described drawings, and the description thereof will be omitted. In FIGS. 61A to 61D, the combinations of the directions, in which the bag mouth 11f is folded by the folding device 31, and cases whether the bagged culture medium block 14 is stored in the container 15 with the traveling direction being the short side (FIGS. 61A and 61B) or being the long side (FIGS. 61C and 61D), are shown. Depending on the folding-in direction of the bag mouth 11f and whether the traveling direction of the bagged culture medium block 14 is on the long side or the short side, the position where the bagged culture medium block 14 is stored in the container varies, thus, various variations of the system can be constituted. Further, since the direction and the orientation of the bagged culture medium block 14 can be changed as shown in FIG. 48, the degree of freedom of this combination can be further increased, and the degree of freedom of the design can be increased according to the installation environment of the system.

### Embodiment 11

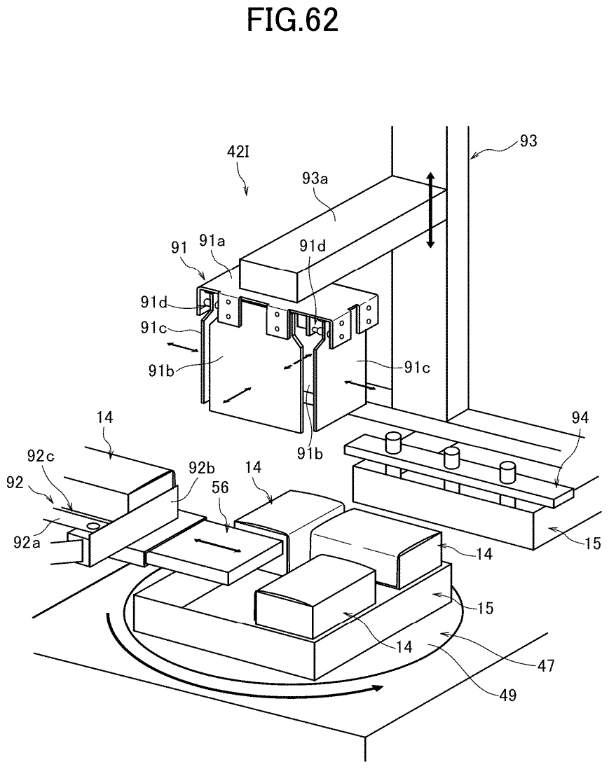

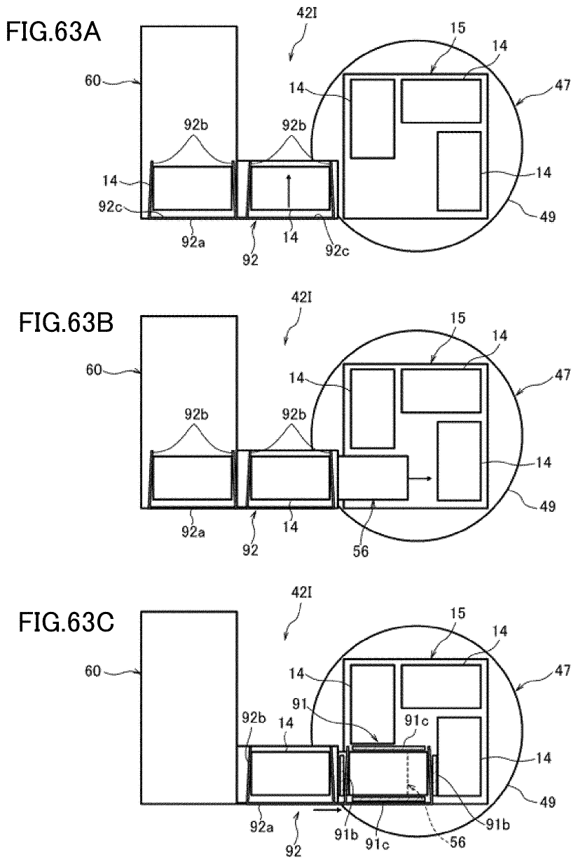

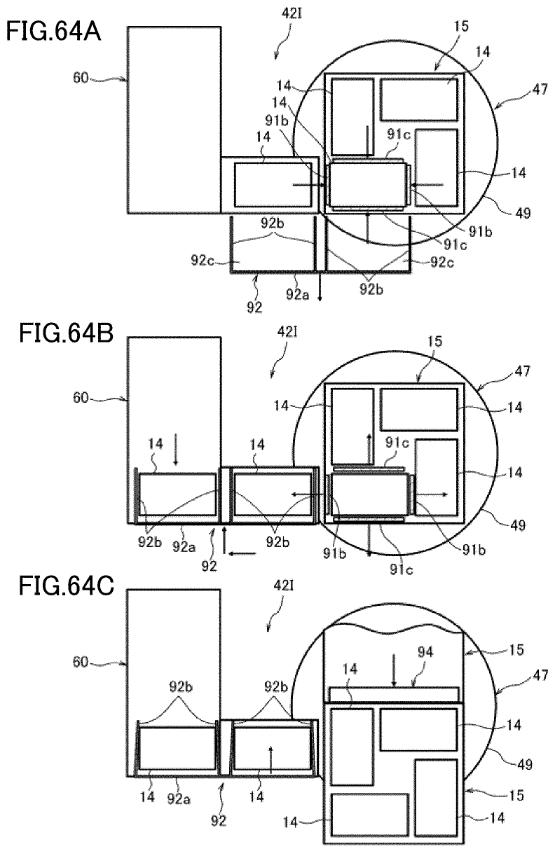

Next, a container carrying device 42I provided in a containerization device 46I according to the embodiment 11 will be described with reference to FIGS. 62 to 64. The same reference numerals are given to the configurations common to the embodiments 1 to 10, and detailed description thereof will be omitted. FIG. 62 is a perspective view of the container carrying device 42I provided in the containerization device 46I according to the embodiment 11. FIG. 63 are views simply illustrating processes of carrying the bagged culture medium block from the folding device into the container, FIG. 63A is a view illustrating a state in which the unfilled portion is folded by the folding device, and FIG. 63B is a view illustrating a state in which the underlay member is pulled out of the folding device side to the upper region of the container, and FIG. 63C is a view illustrating a state in which the culture medium clamping means is lowered to a position where the bagged culture medium block sent out from the folding device onto the underlay member can be clamped by the culture medium clamping means. FIG. 64 are views simply illustrating processes of carrying the bagged culture medium block from the folding device into the container, FIG. 64A is a view illustrating a state in which the bagged culture medium block is clamped by the culture medium clamping means, FIG. 64B is a view illustrating a state in which the bagged culture medium block is stored in the container by the culture medium clamping means, and FIG. 64C is a view illustrating a state in which the empty container is pulled out onto the rotating member of the rotating mechanism. The container carrying device 42I in the containerization device 46I according to the embodiment 11 is different from the container carrying device 42 in the containerization device 46 shown in the embodiments 1 to 10. However, the process up to the folding of the unfilled portion 11h of the bagged culture medium block 14 in the folding device 31 are the same as those in the embodiment 1 and the like. Therefore, the same reference numerals are given to the configurations common to those in the embodiment 1, and detailed description thereof will be omitted. In addition, in FIG. 63A, FIG. 63B and FIG. 64C, the culture medium clamping means 91 is omitted.

The configuration in which the container carrying device 42I of the embodiment 11 is different from the container carrying device 42 of the embodiment 1 is mainly the configuration of the culture medium clamping means 91 for clamping the bagged culture medium block 14, and further, the rod-shaped bodies 48 and the elevating mechanism 51 for raising and lowering the rod-shaped bodies 48 provided in the container carrying device 42 in the embodiment 1 are omitted.

The container carrying device 42I has culture medium feeding means 92, which feeds the bagged culture medium block 14 from the two filling machines 80A and 80B to the folding device 31 by the transporting means 60 and feeds the bagged culture medium block 14 folded by the folding device 34 to a position where the bagged culture medium block 14 can be clamped by the culture medium clamping means 91, the culture medium clamping means 91, which clamps the bagged culture medium block 14 fed by the culture medium feeding means 92 to carry the bagged culture medium block 14 into the container 15, elevating means 93 for raising and lowering the culture medium clamping means 91, a container transfer mechanism 94 for transferring the container 15, and the rotating mechanism 47.

The culture medium feeding means 92 feeds the bagged culture medium block 14 toward the folding device 31, and the feeding direction thereof is changed from that of the transporting means 60 by substantially right angle. Further, the culture medium feeding means 92 feeds the bagged culture medium block 14 in which the unfilled portion 11h has been folded by the folding device 31 onto the underlay member 56 that is pulled out onto the container 15.

The culture medium feeding means 92 includes a sending-out extending plate portion 92a extending parallel to the feeding direction of the bagged culture medium block 14, four protruding plate portions 92b protruding from the sending-out extending plate portion 92a in the direction orthogonal to the delivery direction, and a protruding plate rotating mechanism (not shown) for rotating the protruding plate portion 92b with one end that is connected to the sending-out extending plate portion 92a being a fulcrum. The culture medium feeding means 92 constitutes a culture medium receiving portion 92c for receiving one bagged culture medium block 14 between two adjacent protruding plate portions 92b of the four protruding plate portions 92b. That is, the culture medium feeding means 92 can receive the bagged culture medium block 14 in each of the two culture medium receiving portions 92c, and the two protruding plate portions 92b can clamp the bagged culture medium block 14 received in the culture medium receiving portion 92c by tilting the tip portions thereof inward.

Such culture medium feeding means 92 can be moved by a driving mechanism (not shown) in the direction in which the bagged culture medium block 14 is sent out, and the direction in which the culture medium feeding means 92 retreats from the moving region of the bagged culture medium block 14, that is more specifically, the direction orthogonal to the direction in which the bagged culture medium block 14 is sent out. Therefore, the culture medium feeding means 92 can simultaneously move the two bagged culture medium blocks 14 in a state of being arranged in line in the moving direction. More specifically, the culture medium feeding means 92 sends out the bagged culture medium block 14 that is received in the culture medium receiving portion 92c on the left side of FIGS. 63 and 64 from the transporting means 60 to the folding device 31, and sends out the bagged culture medium block 14 that is received in the culture medium receiving portion 92c on the right side from the folding device 31 onto the underlay member 56.

The culture medium clamping means 91 includes a clamping main body 91a constituting the main body of the culture medium clamping means 91, a pair of culture medium longitudinal side clamping plates 91b arranged to face each other in the longitudinal direction of the bagged culture medium block 14, a pair of culture medium short side clamping plates 91c arranged to face each other in the lateral direction of the bagged culture medium block 14, and a clamping plate driving portion 91d for moving the clamping plates 91b and 91c so that the facing distances between the pair of the culture medium longitudinal side clamping plates 91b and between the pair of the culture medium short side clamping plates 91c can be expanded or contracted.

The clamping main body 91a has a ceiling wall of the culture medium clamping means 91, and is connected to the elevating means 93 via an arm portion 93a. The pair of the culture medium longitudinal side clamping plates 91b, the pair of the culture medium short side clamping plates 91c and the clamping plate driving portion 91d are assembled to the clamping main body 91a.

The pair of the culture medium short side clamping plates 91c is to be in contact with the short side surface of each side surface of the bagged culture medium block 14. Therefore, the width between the pair of the culture medium short side clamping plates 91c corresponds to the longitudinal width of the bagged culture medium block 14.

The pair of the culture medium longitudinal side clamping plates 91b is to be in contact with the longitudinal side surface of each side surface of the bagged culture medium block 14. Therefore, the width between the pair of the culture medium longitudinal side clamping plates 91b corresponds to the width of the short side of the bagged culture medium block 14.

As the clamping plate driving portion 91d, for example, an air cylinder is used. The clamping plate driving portion 91d may be provided for each of the clamping plates 91b and 91c, or for each pair of the culture medium longitudinal side clamping plates 91b and each pair of the culture medium short side clamping plates 91c.

As the elevating means 93, for example, an electric actuator is used, and the elevating means 93 raises and lowers the culture medium clamping means 91 via the arm portion 93a. More specifically, the elevating means 93 raises and lowers the culture medium clamping means 91 among a standby position above the container 15, a clamping position at which the bagged culture medium block 14 sent out onto the underlay member 56 below the standby position is clamped, and a storing position that is further below the clamping position and in the container 15.

The container transfer mechanism 94 pulls out an empty container 15 from a container stock mechanism (not shown) for stocking a plurality of empty containers 15 and transfers the empty container 15 onto the rotating member 49 of the rotating mechanism 47.

Next, processes of carrying the bagged culture medium block 14, in which the unfilled portion 11h is folded, from the folding device 31 into the container 15 will be described with reference to FIGS. 63 and 64. In this description, the four bagged medium blocks 14 are to be stored in a spiral shape while the rotating member 49 of the rotating mechanism 47 is rotated approximately 90 degrees counterclockwise. And in this description, a series of flows from the state, in which the three bagged culture medium blocks 14 among the four bagged culture medium blocks 14 are completely stored, to the carrying of the remaining one bagged culture medium block 14 into the container 15 will be described. Further, in this description, the description of the series of flows is started from the state in which the bagged culture medium block 14 on the transporting means 60 is received in one of the culture medium receiving portions 92c of the culture medium feeding means 92 and the bagged culture medium block 14 received in the other culture medium receiving portion 92c is in a state where the unfilled portion 11h thereof is folded by the folding device 31.

First, in the bagged culture medium block 14 sent out from the transporting means 60 to the folding device 31 by the culture medium receiving portion 92c, the unfilled portion 11h is folded by the folding device 31 (see FIG. 63A).

Next, the underlay member 56 is pulled out from the folding device 31 side to the upper region of the container 15 (see FIG. 63B). The container 15 is arranged so that there is an empty space for storing the next one bagged culture medium block 14 below the underlay member 56.

Next, the bagged culture medium block 14 is sent out from the folding device 31 onto the underlay member 56 by the culture medium feeding means 92, and then the culture medium clamping means 91 is lowered from the standby position to the clamping position for the bagged culture medium block 14 on the underlay member 56 by the elevating means 93 (see FIG. 63C). In the culture medium clamping means 91, which is moved downward to the clamping position for the bagged culture medium block 14, the pair of the culture medium longitudinal side clamping plates 91b are arranged outside of the two protruding plate portions 92b that constitute the culture medium receiving portion 92c. Further, by moving the culture medium feeding means 92, the bagged culture medium block 14 on the transporting means 60 is sent out to the folding device 31.

Next, the bagged culture medium block 14 is clamped by the culture medium clamping means 91 (see FIG. 64A). Here, the clamping plate driving portion 91d drives the pair of the culture medium longitudinal side clamping plates 91b and the pair of the culture medium short side clamping plates 91c so as to contract their facing distances. Further, the culture medium feeding means 92 is moved to the retracted position. As a result, the bagged culture medium block 14 is clamped in the longitudinal direction by the pair of the culture medium longitudinal side clamping plates 91b of the culture medium clamping means 91, and is clamped in the lateral direction by the pair of the culture medium short side clamping plates 91c.

That is to say, the bagged culture medium block 14 is stably held by the culture medium clamping means 91 in a state where the four side surfaces are in contact with the pair of the culture medium longitudinal side clamping plates 91b and the pair of the culture medium short side clamping plates 91c of the culture medium clamping means 91, respectively. Therefore, the culture medium clamping means 91 can stably hold the bagged culture medium block 14 without a portion for supporting the bottom surface side of the bagged culture medium block 14. After the bagged culture medium block 14 is clamped by the culture medium clamping means 91, the underlay member 56 is returned to the folding device 31 side, so that the bagged culture medium block 14 held by the culture medium clamping means 91 is located above the empty space of the container 15.

Next, the bagged culture medium block 14 is stored in the remaining empty space in the container 15 by the culture medium clamping means 91, and the processes of carrying the bagged culture medium block 14 into one container 15 is completed (see FIG. 64B). As a result, the four bagged culture medium blocks 14 are stored in the container 15 in a spiral shape. Here, after the culture medium clamping means 91 clamping the bagged culture medium block 14 is lowered toward the storing position in the container 15 by the elevating means 93, the clamping plate driving portion 91d expands the facing distances between the pair of the culture medium longitudinal side clamping plates 91b and between the pair of the culture medium short side clamping plates 91c. The retracted culture medium feeding means 92 is moved to a position where the bagged culture medium block 14 transported from the transporting means 60 can be received in one of the culture medium receiving portions 92c. As a result, the bagged culture medium block 14 on the transporting means 60 is received in one of the culture medium receiving portions 92c, and the bagged culture medium block 14 that was located in the folding device 31 is received by the other culture medium receiving portion 92c.

When the processes of carrying the bagged culture medium block 14 into the one container 15 are completed in this way, the empty container 15 is pulled out onto the rotating member 49 of the rotating mechanism 47 by the container transfer mechanism 94, so that the carrying processes of the bagged culture medium block 14 into the container 15 are performed again (see FIG. 64C). Here, when the empty container 15 is pulled out onto the rotating member 49 of the rotating mechanism 47 by the container transfer mechanism 94, the empty container 15 pushes out the container 15 on the rotating member 49 from above the rotating member 49 onto the fixed conveyor 83c (see FIG. 50) connected to the shelf insertion device 83 (see FIG. 50). The container 15 pushed out onto the fixed conveyor 83c in this way is conveyed to the shelf insertion device 83 via the fixed conveyor 83c.

### Embodiment 12

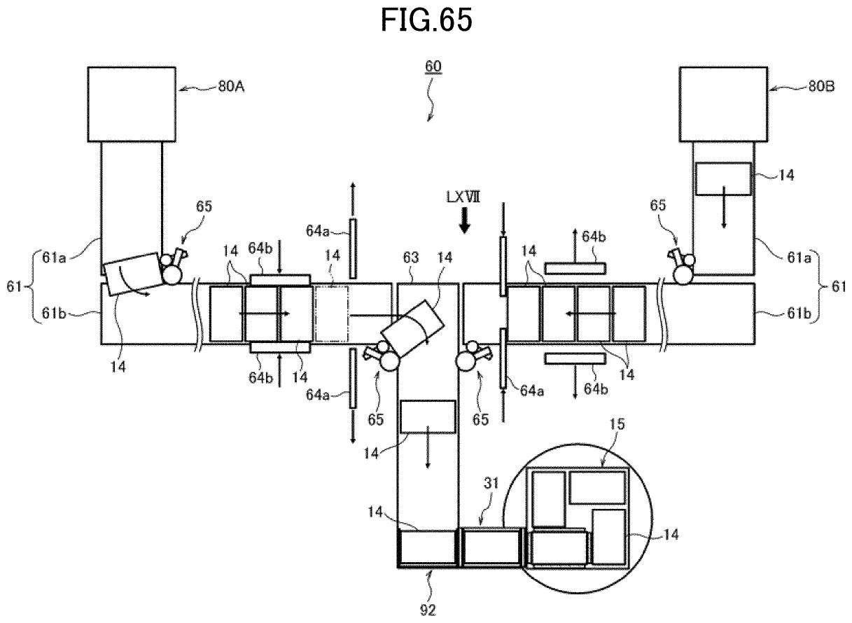

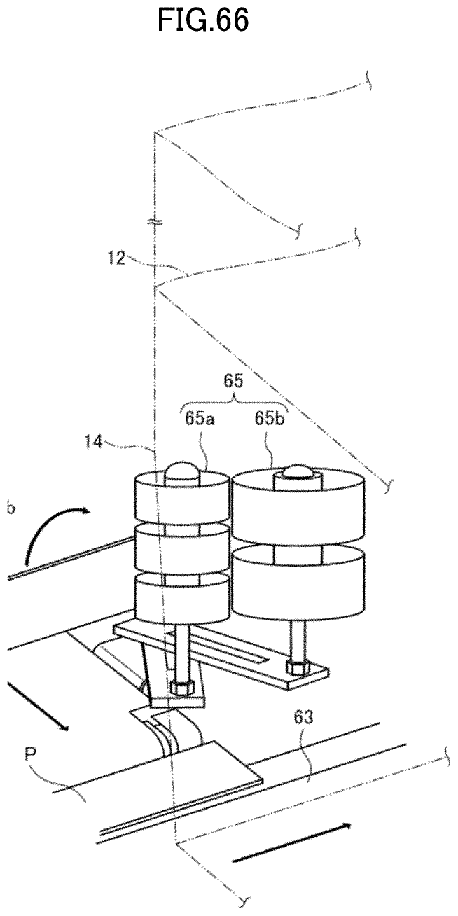

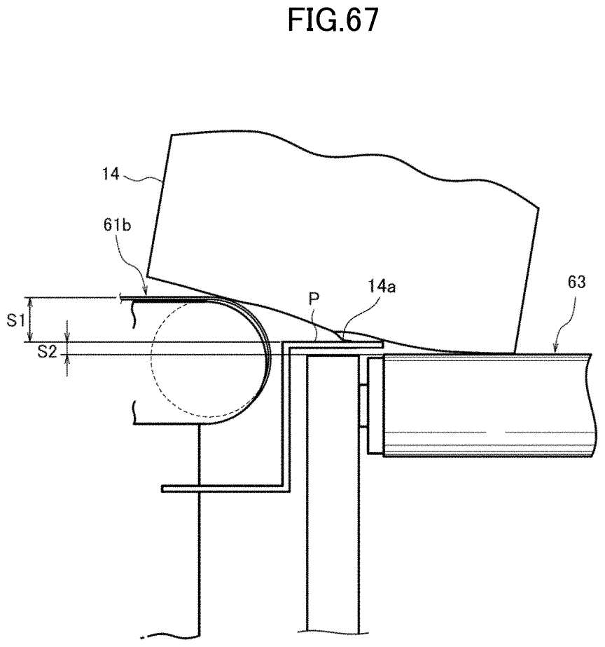

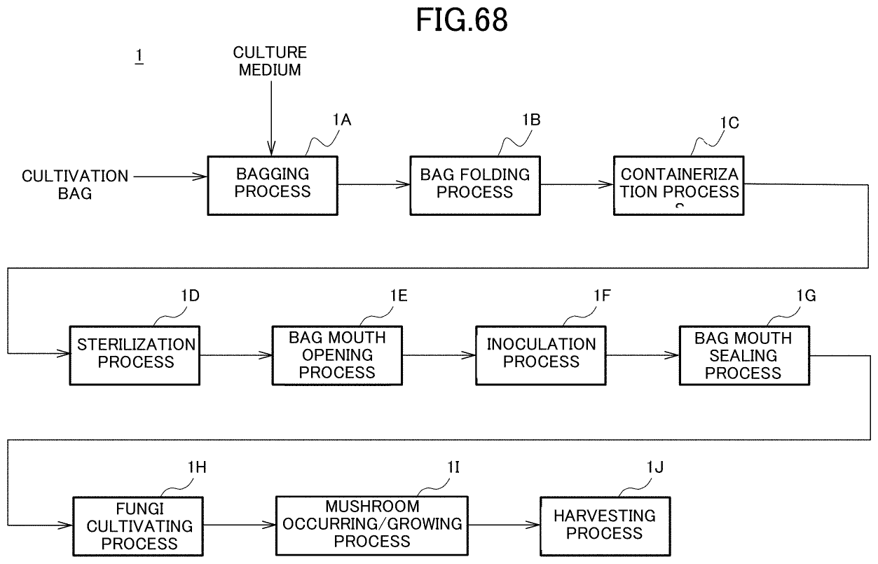

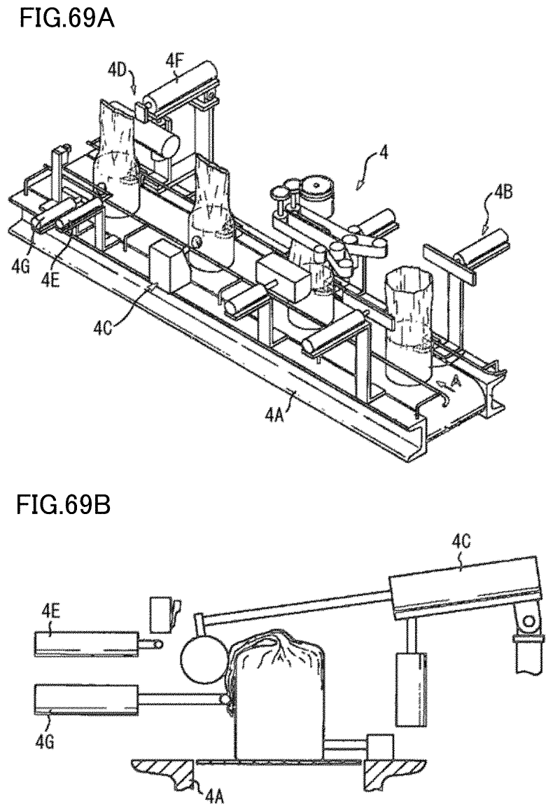

Next, the transporting means 60 according to the embodiment 12 will be described with reference to FIGS. 65 to 67. FIG. 65 is a schematic view illustrating the overall configuration of the transporting means 60 according to the embodiment 12. FIG. 66 is a perspective view of the periphery of a culture medium direction changing section 65 shown in FIG. 65. FIG. 67 is a side view seen from the LXVII side of FIG. 65. The transporting means 60 according to the embodiment 12 has various additional functions related to the transport of the bagged culture medium block 14 as compared with the conveyor shown in the modified example 2 of the embodiment 8. The same reference numerals are given to the configurations common to the embodiments 1 to 11, and detailed description thereof will be omitted.

The transporting means 60 according to the embodiment 12 transports the bagged culture medium block 14 from the two filling machines 80A and 80B to the folding device 31. The transporting means 60 is provided with two pre-merging transporting sections 61, on which each of the bagged culture medium blocks 14 sent out from the two filling machines 80A and 80B is transported, a merging transporting section 63, at which each of the bagged culture medium blocks 14 transported by the two pre-merging transporting sections 61 is merged and transported, a culture medium temporary standby section 64 for making the bagged culture medium blocks 14 on the two pre-merging transporting sections 61 temporarily stand by at predetermined positions, and the culture medium direction changing section 65 for assist the direction change of the bagged culture medium block 14.

The pre-merging transporting sections 61 and the merging transporting section 63 are composed of, for example, belt conveyors, and the merging transporting section 63 is connected to the two pre-merging transporting sections 61 connected to each filling machines 80A and 80B.

Each pre-merging transporting section 61 has a first transporting section 61a and a second transporting section 61b that are connected from upstream to downstream. The second transporting section 61b is connected to the first transporting section 61a, and the directions thereof are changed at a substantially right angle. The second transporting section 61b of each pre-merging transporting sections 61 is connected to each of the end portions of the merging transporting section 63 so as to be substantially in line.

Steps are formed in the connecting portion between the first transporting section 61a and the second transporting section 61b and in the connecting portion between the second transporting section 61b and the merging transporting section 63. Hereinafter, the step of the connecting portion between the second transporting section 61b and the merging transporting section 63 will be described in detail. Since the same applies to the step of the connecting portion between the first transporting section 61a and the second transporting section 61b, detailed description thereof will be omitted. More specifically, as shown in FIG. 67, the second transporting section 61b and the merging transporting section 63 are connected so that the transport surface of the merging transporting section 63 is lower in step than the transport surface of the second transporting section 61b. More specifically, the plate P, which is for example in the shape of a bent stainless steel flat plate and is fixed to the second transporting section 61b, is arranged so that a part of the plate P is above the transport surface of the merging transporting section 63 between the second transporting section 61b and the merging transporting section 63. On the bottom surface of the bagged culture medium block 14, there is a protruding portion 14a in which the joint portion of the bag protrudes like a tongue. In a case where the protruding portion 14a of the bag is bent toward the traveling direction, the protruding portion 14a may be caught by the first transporting section 61a, the second transporting section 61b, the connecting portion between the first transporting section 61a and the second transporting section 61b, and particularly the end portions thereof. If the protruding portion 14a is caught, the extent of the direction change of the bagged culture medium block 14 may be deviated, and the bagged culture medium blocks 14 may not be transported in a uniform direction. By providing the plate P, two steps are formed so that the heights of the transport surface of the second transporting section 61b, the upper surface of the plate P, and the transport surface of the merging transporting section 63 become lower in step in the order of the transport surface of the second transporting section 61b, the upper surface of the plate P, and the transport surface of the merging transporting section 63 in the transport direction from the transport surface of the second transporting section 61b to the transport surface of the merging transporting section 63. There are formed two steps in which the height becomes lower in step in the order of the transport surface of the second transporting section 61b, the upper surface of the plate P, and the transport surface of the merging transporting section 63. That is, there are formed the first step between the transport surface of the second transporting section 61b and the upper surface of the plate P, and the second step between the upper surface of the plate P and the transport surface of the merging transporting section 63. In the present embodiment, even if there is the protruding portion 14a on the bottom surface of the bagged culture medium block 14 in which the joint portion of the bag protrudes like a tongue, when the bagged culture medium block 14 goes over the first step, the protruding portion 14a is not caught since the protruding portion 14a can move between the end portion of the second transporting section 61b and the end portion of the plate P at a distance from the second transporting section 61b and the plate P. Further, when the bagged culture medium block 14 goes over the second step, the protruding portion 14a is not caught since the protruding portion 14a can move between the end portion of the plate P and the end portion of the merging transporting section 63 at a distance from the plate P and the merging transporting section 63. As a result, the protruding portion 14a is not caught by the second transporting section 61b or the merging transporting section 63, so that, when the bagged culture medium block 14 is transferred from the second transporting section 61b to the merging transporting section 63, the extent of the direction change is stable, and the transport posture of the bagged culture medium block 14 can be uniformly adjusted. Similarly, when transferred from the first transporting section 61a to the second transporting section 61b, the extent of the direction change is stable, and the transport posture of the bagged culture medium block 14 can be uniformly adjusted.

The culture medium temporary standby section 64 is provided around the end of the pre-merging transporting section 61 on the side connected to the merging transporting section 63, and has a stopper mechanism, which is provided with a pair of contact plates 64a with which the bagged culture medium block 14 moved in the transport direction is brought in to contact, and a culture medium clamping mechanism provided with a pair of clamping plates 64b with which the bagged culture medium block 14 is clamped from the sides thereof.

The pair of the contact plates 64a of the stopper mechanism are provided so as to be movable between a culture medium stop position, at which the bagged culture medium block 14 is brought into contact with the pair of the contact plates 64a in the transport direction to be stopped, and a culture medium pass position at which the pair of the contact plates 64a are retracted from the transport line so that the bagged culture medium block 14 passes through the pair of the contact plates 64a.

The pair of the clamping plates 64b of the culture medium clamping mechanism are provided to be movable between the culture medium clamping position at which the pair of the clamping plates 64b are brought into contact with both sides of the bagged culture medium block 14 on the pre-merging transporting section 61 to clamp the bagged culture medium block 14 and the culture medium release position at which the pair of the clamping plates 64b is moved away from and release the both sides of the bagged culture medium block 14. The pair of the clamping plates 64b are provided on the upstream side with respect to the stopper mechanism, and in the present embodiment, the length thereof is set such that two bagged culture medium blocks 14 arranged close to each other in the transport direction can be held from the sides. The pair of the clamping plates 64b is only needed to have a length that can hold at least one bagged culture medium block 14 from the sides. That is, the pair of the clamping plates 64b may have a length that allows one bagged culture medium block 14 to be held from the sides, or three bagged culture medium blocks 14 to be held from the sides.

In the culture medium temporary standby section 64 of the present embodiment, the pair of the clamping plates 64b of the culture medium clamping mechanism is arranged at a position at which the pair of the clamping plates 64b can clamp two bagged culture medium blocks 14, which are lined up behind one bagged culture medium blocks 14 that is brought into contact with the pair of the contact plates 64a of the stopper mechanism to be stopped.

The culture medium direction changing section 65 changes the direction of the bagged culture medium block 14 at a position where the transport direction of the transporting means 60 changes. In the embodiment 12, each of the culture medium direction changing sections 65 is arranged at a position, at which the transport direction changes from the first transporting section 61a to the second transporting section 61b of the pre-merging transporting section 61 at a substantially right angle, and at a position, at which the transport direction changes from the second transporting section 61b of the pre-merging transporting section 61 to the merging transporting section 63 at a substantially right angle, respectively. More specifically, the culture medium direction changing section 65 is arranged around the side portions of the pre-merging transporting section 61 and the merging transporting section 63 so that the side portions of the bagged culture medium block 14 moved onto the pre-merging transporting section 61 or the merging transporting section 63 are slidably contacted with the culture medium direction changing section 65.

The culture medium direction changing section 65 has small-diameter guide rollers 65a and large-diameter guide rollers 65b having a larger diameter than that of the small-diameter guide roller 65a (see FIG. 66). The small-diameter and large-diameter guide rollers 65a and 65b are fixed in a non-rotatable state by support shafts arranged at different positions.

The small-diameter guide rollers 65a are arranged on the upstream side in the transport direction as compared with the large-diameter guide rollers 65b. A plurality of the small-diameter and large-diameter guide rollers 65a and 65b are provided so as to be stacked in the height direction so that the rollers are to be widely in contact with the region filled with the culture medium 12 in the bagged culture medium block 14. The number of the small-diameter and large-diameter guide rollers 65a and 65b is not limited as long as the widths in the height direction are ensured, and the number may be one, two or more. Further, although the shapes thereof are substantially cylindrical in FIG. 66, the present embodiment is not limited to this configuration, and various shapes such as an elliptical shape and a trochoidal shape can be adopted.

Next, the transport flow of the bagged culture medium block 14 from the two filling machines 80A and 80B to the folding device 31 by the transporting means 60 according to the embodiment 12 will be described. Since the transport flows until the bagged culture medium blocks 14 sent out from each of the two filling machines 80A and 80B are merged in the merging transporting section 63 are the same, only the transport flow of the bagged culture medium block 14 sent out from the filling machine 80A will be described.

First, when the bagged culture medium block 14 sent out from the filling machine 80A is transported by the first transporting section 61a to the periphery of the connecting portion with the second transporting section 61b, one side portion thereof is slidably come into contact with the culture medium direction changing section 65, and the direction is changed substantially at right angles toward the transport direction of the second transporting section 61b. Here, in the bagged culture medium block 14, the side portion is first slidably come into contact with the small-diameter guide rollers 65a of the culture medium direction changing section 65, so that the side that is slidably contacted with the small-diameter guide rollers 65a has a large resistance. Therefore, the amount of movement in this side is more limited than that in the other side, and the direction changes diagonally toward the small-diameter guide rollers 65a side. Thus, the direction changes greatly by being applied with the rotation force in this state due to the movement in the transport direction from the first transporting section 61a to the second transporting section 61b. Here, the amount of rotation of the bagged culture medium block 14 is adjusted by slidably coming into contact with the large-diameter guide rollers 65b, and is directed in the transport direction of the second transporting section 61b. With the culture medium direction changing section 65 having such a simple structure, the transport posture of the bagged culture medium block 14 can be uniformly aligned and stabilized. Further, in order to make the transport posture at the time of the direction change more stable, it is desirable to provide two steps between the first transporting section 61a and the second transporting section 61b. This amount of rotation is determined according to the arrangements, shapes, sizes of the small-diameter guide rollers 65a and the large-diameter guide rollers 65b, the transport speed of the first transporting section 61a and the second transporting section 61b, the frictional resistance of each transport surface, and the like. Therefore, in the present embodiment, the arrangements of the small-diameter guide rollers 65a and the large-diameter guide rollers 65b can be adjusted.

Since the above-described steps are provided in the connecting portion between the first transporting section 61a and the second transporting section 61b, when the bagged culture medium block 14 is transported from the first transporting section 61a to the second transporting section 61b, the protruding portion 14a in which the joint portion of the bag protrudes like a tongue on the bottom surface of the bagged culture medium block 14 is not caught in the first transporting section 61a or the second transporting section 61b. Therefore, the bagged culture medium block 14 is transported from the first transporting section 61a to the second transporting section 61b while changing the direction thereof in a desired direction.

The bagged culture medium block 14 transported from the first transporting section 61a to the second transporting section 61b in this way is transported on the second transporting section 61b toward the merging transporting section 63. On the second transporting section 61b, the culture medium temporary standby section 64 performs a temporary standby operation of the bagged culture medium block 14. The culture medium temporary standby section 64 provided on each second transporting section 61b alternately transfers the bagged culture medium blocks 14 transported from each of the filling machines 80A and 80B to the merging transporting section 63 at predetermined intervals. Here, the bagged culture medium block 14 is moved to the merging transporting section 63 by the stopper mechanism of the culture medium temporary standby section 64 at timings at which a predetermined transport interval is maintained with respect to the bagged culture medium block 14 that is moved from the other first transporting section 61a to the merging transporting section 63. The predetermined transport interval herein is an interval in the transport direction between the bagged culture medium blocks 14 that are separated from each other in the range within the processing capacity of the folding device 31. In a case where the predetermined transport interval cannot be maintained, the bagged culture medium block 14 is brought into contact with the contact plate 64a at the culture medium stop position and stopped. On the other hand, in a case where the predetermined transfer interval can be maintained, the contact plate 64a is moved to the culture medium passing position, and the bagged culture medium block 14 is started to move in the transfer direction. The transport direction of the bagged culture medium block 14 that was started to move is changed in the transport direction toward the merging transporting section 63 by the culture medium direction changing section 65 that is similar to that of described above, and the bagged culture medium block 14 passes through the same steps as those of described above and is moved from the second transporting section 61b to the merging transporting section 63 to reach the folding device 31.

Therefore, even in a case where a plurality of bagged culture medium blocks 14 are congested on the second transporting section 61b, each culture medium temporary standby section 64 interlocks the operation of the pair of the contact plates 64a of the stopper mechanism and the operation of the pair of the clamping plates 64b of the clamping mechanism so that the bagged culture medium block 14 can be alternately transported toward the merging transporting section 63 at a predetermined interval. More specifically, the temporary standby operation of the bagged culture medium block 14 is as follows.

(1) When the pair of the contact plates 64a of the stopper mechanism is moved to the culture medium stop position and the pair of the clamping plates 64b of the culture medium clamping mechanism is moved to the culture medium release position, the leading first bagged culture medium block 14 comes into contact with the upstream side of the pair of the contact plates 64a, and following this leading first leading bagged culture medium block 14, the second and third culture medium blocks 14 are arranged at the clamping position of the pair of the clamping plates 64b of the culture medium clamping mechanism. Further, in the upstream thereof, the subsequent bagged culture medium blocks 14 in contact with each other is stopped.
(2) From this state, when the pair of the clamping plates 64b of the culture medium clamping mechanism is moved to the culture medium clamping position, the second and third culture medium blocks 14 are clamped by the clamping plates 64b, and the movements thereof are stopped.
(3) At the timing of moving the bagged culture medium block 14 from the second transporting section 61b to the merging transporting section 63, the pair of the contact plates 64a of the stopper mechanism is moved to the culture medium passing position. Then, only the first bagged culture medium block 14 passes through the pair of the contact plates 64a and is moved from the second transporting section 61b to the merging transporting section 63. Here, since the second and subsequent bagged culture medium blocks 14 are clamped by the clamping plates 64b and the movements thereof are stopped, they are not transported together.
(4) When the pair of the contact plates 64a of the stopper mechanism is moved to the culture medium stop position and the pair of the clamping plates 64b of the culture medium clamping mechanism is moved to the culture medium release position, the state of above (1) is restored. Then, these operations are repeated.

Here, a case where three or more bagged culture medium blocks 14 are congested in the second transporting section 61b is described, but even in a case where only two bagged culture medium blocks 14 are congested, it is similarly possible to alternately transfer the bagged culture medium blocks 14 to the merging transporting section 63 one by one. Further, since each culture medium temporary standby section 64 is provided with a sensor for detecting the bagged culture medium block 14, in a case where the bagged culture medium block 14 is supplied only from one of the second transporting sections 61b, or in a case where the bagged culture medium block 14 is congested only in one of the second transporting sections 61b, the bagged culture medium blocks 14 are appropriately sent out from the second transporting section 61b to the merging transporting section 63 one by one at predetermined intervals.

When the bagged culture medium block 14 is moved from the second transporting section 61b to the merging transporting section 63, due to the above-described culture medium direction changing section 65 and the two steps, the extent of the direction change of the bagged culture medium block 14 is stabilized, and the bagged culture medium block 14 is transported toward the folding device 31 in a uniform posture.

The folding device 31 is designed to stably fold the bag mouth of the filling medium block 14, but the folding device 31 is assumed to be stopped emergently in a case where stable folding is not possible due to some factor, or from the viewpoint of safe operation. In this case, the transport of the bagged culture medium block 14 is stopped by the stopper mechanism on the second transporting section 61b, and the transport of the bagged culture medium block 14 to the merging transporting section 63 is stopped. In this case, since the operations of the filling machines 80A and 80B are not suddenly stopped, the plurality of bagged culture medium blocks 14 may be in a densely congested state due to the stopper mechanism on the second transporting section 61b. Even in such a congested state, when the operation of the folding device 31 is resumed, it is possible to alternately transport the bagged culture medium blocks 14 from the filling machines 80A and 80B to the merging transporting section 63 at predetermined intervals by interlocking and controlling the stopper mechanism and the culture medium clamping mechanism on each second transporting section 61b.

Even in the case of the congestion in which a plurality of the bagged culture medium blocks 14 are lined up on the second transporting section 61b, the culture medium temporary standby section 64 performs the temporarily standby operation for the bagged culture medium block 14 on each second transporting section 61b. Therefore, the culture medium temporary standby section 64 provided on each second transporting section 61b allows the bagged culture medium blocks 14 transported from the filling machines 80A and 80B to be alternately transferred to the merging transporting section 63 at predetermined intervals. In the culture medium temporary standby section 64, since one or two subsequent bagged culture medium blocks 14 are clamped by the pair of the clamping plates 64b of the culture medium clamping mechanism and held at that position, in a case where the pair of the contact plates 64a of the stopper mechanisms is moved to the culture medium passing position, only the leading first bagged culture medium block 14 can be moved from the second transporting section 61b to the merging transporting section 63. In a case where the bagged culture medium block 14 is transported from the upstream side with respect to the bagged culture medium block 14 clamped by the pair of the clamping plates 64b, these subsequent bagged culture medium blocks 14 comes into contact with the bagged culture medium blocks 14 that is clamped by the pair of the clamping plates 64b and is stopped.

When one bagged culture medium block 14 passes through the pair of the contact plates 64a, as described above, the pair of the contact plates 64a of the stopper mechanism are moved to the culture medium stop position again, and the pair of the clamping plates 64b of the culture medium clamping mechanisms are moved to the culture medium release position, and the series of temporary standby operations described above are repeated.

According to the transporting means 60 of the embodiment 12, there are provided the two pre-merging transporting sections 61 to which each of the bagged culture medium blocks 14 sent out from the two filling machines 80A and 80B is transported, the merging transporting sections 63 at which each of the bagged culture medium blocks 14 transported from the two pre-merging transporting sections 61 merges and from which the bagged culture medium blocks 14 are transported to the folding device 31, and the culture medium temporary standby sections 64 at which one or more bagged medium blocks 14 on the two pre-merging transporting sections 61 temporarily stand by at predetermined positions and at which the bagged culture medium blocks 14 are moved one by one from the pre-merging transporting sections 61 to the merging transporting section 63. Thus, the bagged culture medium blocks 14 are moved from the two pre-merging transporting sections 61 to the merging transporting section 63 at timings at which a predetermined transport interval is maintained. Therefore, even if congestion occurs on the two pre-merging transporting sections 61, since the bagged culture medium blocks 14 can be sent out from each pre-merging transporting section 61 to the merging transporting section 63 one by one, the bagged culture medium blocks 14 can be smoothly transported between the two filling machines 80A and 80B and the folding device 31, and as a result, the productivity can be improved.

The transporting means 60 according to the embodiment 12 exemplifies the transport of the bagged culture medium block 14 from the two filling machines 80A and 80B to the folding device 31, but the present invention is not limited to this configuration, and the bagged culture medium block 14 may be transported from three or more filling machines to the folding device 31. That is, the transporting means 60 may have three or more pre-merging transporting sections 61 connected to the merging transporting section 63.

Further, the transporting means 60 according to the embodiment 12 takes out each of a plurality of bagged culture medium blocks 14 at the predetermined interval by providing a clamping mechanism on the upstream side of the stopper mechanism, but instead of the configuration in which the clamping mechanism is provided on the upstream side of the stopper mechanism, for example, a configuration in which conveyors having different transfer speeds are combined may be adopted. For example, a switching point for conveyors having different transport speeds may be provided on the downstream side of a predetermined distance from the stopper mechanism, the conveyor on the upstream side of the switching point may be a conveyor having a slow transport speed, and the conveyor on the downstream side of the switching point may be a conveyor having a faster transfer speed than the conveyer having the slow transport speed. In a case where conveyors with different transport speeds are used in this way, if the stopper mechanism is opened when congestion occurs, a plurality of congested bagged culture medium blocks 14 are in line in contact with each other on the conveyor having the slow transport speed, but when the bagged culture medium block 14 is transferred to the conveyor having the faster transport speed, the bagged culture medium block 14 transferred to the conveyor having the faster transport speed has a faster transport speed than the subsequent bagged culture medium block 14 on the conveyor having the slow transport speed, so that the distance between the bagged culture medium blocks 14 are increased. Therefore, a predetermined interval can be provided between the plurality of congesting bagged culture medium blocks 14 because of the difference in the transport speeds of both conveyors.

Further, in the present embodiment, in the culture medium direction changing section 65, the small-diameter guide rollers 65a and the large-diameter guide rollers 65b are fixed, but the present embodiment is not limited to this configuration. Various configuration in which each roller is rotatably fixed with a rotary support shaft, the third or more guide rollers are arranged in addition to the small-diameter guide rollers 65a and large-diameter guide rollers 65b, guide rollers are arranged at one position, or the like, may be adopted.

The folding device and the containerization device provided with the folding device according to the embodiments of the present invention have been described above with reference to the drawings, but each embodiment described herein is only for exemplifying a folding device and a containerization device provided with the folding device in order to embody the technical concept of the present invention. Thus, the present invention is not limited to these embodiments, and the present invention can be equally applied to other embodiments, such as those in which appropriate additions or modifications are made to each embodiment, or combinations of each embodiment.

### REFERENCE SIGNS LIST

11, 11F: bag body
11a, 11Fa: bottom surface
11b, 11c: wide side surface
11d, 11e: narrow side surface
11Fb: side surface
11f, 11Ff: bag mouth
11g, 11Fg: filled portion
11h, 11Fh: unfilled portion
11i: neck portion
12: culture medium
14, 14F: bagged culture medium block
14a: protruding portion
15: container
15a: bottom portion
15b: gap
21: block forming device
31, 31B, 31F, 31G: folding device
32: opening mechanism
32a: blower
33: first feeding means
33a: feeding member
34, 34G: folding means
35: supporting mechanism
35a: supporting member
35b: beam member
36, 36A: pushing mechanism
36a: pushing member
36Aa: blower
37, 37A, 37G: pressing mechanism
37a: pressing member
37Aa: blower
37Ga: downstream side pressing member
37Gb: downstream side rotation means
37Gc: upstream side pressing member
37Gd: upstream side rotation means
38, 38′: tilting mechanism
38a: blower
38a′: tilting member
39: opening assist member
40: second feeding means
40a: feeding member
41, 41F, 41H: folding-in means
41a, 41Fa, 41Ha: folding-in member
41b (41b1, 41b2, 41b3), 41Hb (41Hb1, 41Hb2, 41Hb3): side wall
41c, 41Hc: folding-in side wall
41Fc: plate body
41d, 41Fd: bottom portion
41He: movable claw member
42, 42H, 42I: container carrying device
46, 46F, 46H, 46I: containerization device
47: rotating mechanism
48: rod-shaped body
51: elevating mechanism
54: regulating member
56, 56H: underlay member
56Ha: notch portion
58: opening
60, 60B, 60G: transporting means
62: other opening means
61: pre-merging transporting section
61a: first transporting section
61b: second transporting section
63: merging transporting section
64: culture medium temporary standby section
64a: contact plate
64b: clamping plate
65: culture medium direction changing section
65a: small-diameter guide roller
65b: large-diameter guide roller
70F: alignment section
72F: alignment member
74F: separating means
80, 80A, 80B: filling machine
81, 81A, 81B, 81C, 81D, 81E: conveyor
82: container supply section
83: shelf insertion device
83a: elevating device
83b: transfer device
83c: fixed conveyor
83d: movable conveyor
83e: conveyor moving means
83f: sterilization trolley moving means
84: container storage area
85: sterilization trolley
85c: shelf insertion position
85d: carry-out position
86: shelf insertion device
86a: elevating device
86b: transfer device
86b1: fixed claw
86b2: movable claw
86c: fixed conveyor
86d: elevating conveyor
86e: position sensor
86f: sterilization trolley moving means
91: culture medium clamping means
91a: clamping main body
91b: culture medium longitudinal side clamping plate
91c: culture medium short side clamping plate
91d: clamping plate driving portion
92: culture medium feeding means
92a: sending-out extending plate portion
92b: protruding plate portion
92c: culture medium receiving portion
93: elevating means
93a: arm portion
94: container transfer mechanism

1. A folding device for folding an unfilled portion of a bagged culture medium block having a bag body, which has at least a bottom portion and a bag mouth, and having a filled portion in the bag body, in which a predetermined amount of culture medium is filled, and the unfilled portion, which is from an upper surface of the filled portion to the bag mouth, wherein the folding device comprises:
an opening mechanism for blowing air from a side of the bag mouth into the bag body to keep the bag mouth open;
a folding mechanism having one or more folding jigs for pushing the unfilled portion of the bag body from inside or outside; and
a tilting mechanism for tilting the unfilled portion toward the direction approaching to the filled portion.

2. The folding device according to claim 1, wherein at least one of the opening mechanism and the tilting mechanism generates wind pressure.

3. The folding device according to claim 2, wherein the folding device comprises a bag mouth expansion range adjusting mechanism for adjusting an expansion range of the bag mouth by being into contact with the unfilled portion from outside of the bag body when the opening mechanism applies wind pressure.

4. The folding device according to claim 1, wherein the folding jig is composed of a plurality of jigs for pushing the unfilled portion of the bag body from inside or outside, and each of at least two of the plurality of the jigs pushes opposing side walls of the unfilled portion of the bag body from inside or outside.

5. The folding device according to claim 1, wherein the folding device has transporting means for transporting the bagged culture medium block, and the transporting means is provided with at least one of a temporary standby mechanism for making the transport of the bagged culture medium block stand by, a direction changing mechanism for changing a transport direction of the bagged culture medium block, and a merging mechanism for merging the bagged culture medium blocks transported from a plurality of culture medium filling devices into one transport path at predetermined intervals.

6. The folding device according to claim 1, wherein when the unfilled portion of the bagged culture medium block is folded, a string member is inserted into the bag body from the bag mouth.

7. A containerization device including the folding device according to claim 1, wherein the containerization device transports a plurality of the bagged culture medium blocks folded by the folding device and stores the bagged culture medium blocks in a container.

8. The containerization device according to claim 7, wherein the containerization device includes a holding mechanism for holding the bagged culture medium block by clumping the bagged culture medium block from both sides thereof.

9. The containerization device according to claim 7, wherein the containerization device includes a holding mechanism for holding the bagged culture medium block with side walls, which are brought into contact with at least a part of a periphery of the bagged culture medium block, and a bottom plate, which is brought into contact with at least a part of the bottom portion of the bagged culture medium block.

10. A storage trolley device including the containerization device according to claim 7, wherein the storage trolley device includes an elevating mechanism, which is for raising and lowering a container in which the bagged culture medium block is stored, and a storage mechanism, which is for storing the container in a trolley having a plurality of container storage portions.

11. A storage trolley device according to claim 10, wherein the elevating mechanism raises and lowers the container one by one.
